(19) United States
(12) Patent Application Publication
(10) Pub. No.: US 2019/0204511 A1
(43) Pub. Date: Jul. 4, 2019

(54) PLASMONIC AND PHOTONIC WAVELENGTH SEPARATION FILTERS

(71) Applicant: Infineon Technologies Austria AG, Villach (AT)

(72) Inventors: Thomas GRILLE, Villach (AT); Ursula HEDENIG, Villach (AT); Bernhard JAKOBY, Linz (AT); Ventsislav M. LAVCHIEV, Gallneukirchen (BG)

(73) Assignee: Infineon Technologies Austria AG, Villach (AT)

(21) Appl. No.: 16/296,670

(22) Filed: Mar. 8, 2019

Related U.S. Application Data
(63) Continuation of application No. 15/135,275, filed on Apr. 21, 2016.

(30) Foreign Application Priority Data
Apr. 21, 2015 (DE) 102015207251.7
May 28, 2015 (DE) 102015209842.7

(51) Int. Cl. G02B 6/293; B82Y 20/00; G02B 6/122; G02B 6/12; H01L 31/00

(52) U.S. Cl. CPC G02B 6/29389; B82Y 20/00; G02B 6/1226; G02B 6/34; H01L 31/00; G02B 2006/12164; G02B 6/12007

(57) ABSTRACT

Plasmonic and photonic wavelength separation structures are provided for guiding plasmonic wave signals and electromagnetic signals, respectively. A separation structure includes an input waveguide configured to guide a first wave signal, an output waveguide configured to guide a second wave signal; and a resonator structure that includes a closed loop pathway and is configured to receive a portion of the first wave signal from the input waveguide by coupling and to provide the second wave signal to the output waveguide based on the portion of the first wave signal by coupling. The input waveguide, the resonator structure and the output waveguide each comprise a wave guiding material for guiding the first wave signal and the second wave signal. The wave guiding material for the plasmonic wavelength separation structure may be a plasmonic wave guiding material. The wave guiding material for the photonic wavelength separation structure may be a semiconductor material.

### CROSS-REFERENCE TO RELATED APPLICATIONS

This application is a continuation of U.S. patent application Ser. No. 15/135,275, filed Apr. 21, 2016, which claims the benefit of German Patent Application No. 10 2015 207 251.7 filed Apr. 21, 2015, and German Patent Application No. 10 2015 209 842.7 filed on May 28, 2015, which are incorporated by reference as if fully set forth.

### FIELD

The present disclosure generally relates to separating wavelengths of a plasmonic wave signal and to separating wavelengths of an electromagnetic signal. The present disclosure further relates to photonic chip-based wavelength separation filters with curvy linear structures.

### BACKGROUND

Signals may comprise a broadband characteristic, i.e., may comprise a plurality of wavelengths or a plurality of carriers. A wavelength and/or a wavelength range may be extracted or separated from the broadband signal with a wavelength separation structure.

### SUMMARY

Embodiments provide a plasmonic wavelength separation structure comprising an input waveguide to guide a first plasmonic wave signal, an output waveguide to guide a second plasmonic wave signal and a resonator structure to receive a portion of the first plasmonic wave signal from the input waveguide by coupling and to provide the second plasmonic wave signal to the output waveguide based on the portion of the first plasmonic wave signal by coupling. The resonator structure comprises a closed loop pathway. The input waveguide, the resonator structure and the output waveguide each comprise a plasmonic wave guiding material for guiding the first and the second plasmonic wave signal.

Further embodiments provide a microlab system comprising a plasmonic wavelength separation structure. The resonator structure is configured to be connectable with an ambient material and to influence the wavelength of the second plasmonic wave signal based on an interaction between the portion of the first plasmonic wave and the ambient material based on a changed resonance frequency of the resonator structure. The microlab system comprises a signal source to provide the first plasmonic wave signal, a detector to receive the second plasmonic wave signal and to detect a wavelength of the second plasmonic wave signal or a wavelength derived thereof. The microlab system comprises a processor to determine a characteristic of the ambient material based on the wavelength of the second plasmonic wave signal or based on the wavelength derived thereof.

Further embodiments provide an optical receiver comprising a plasmonic wavelength separation structure, an electromagnetic signal source and a receiver element. The electromagnetic signal source is configured to emit a first electromagnetic signal based on a received optical communication signal. The electromagnetic signal source is coupled to the input waveguide and configured to excite the first plasmonic wave signal in the input waveguide based on the first electromagnetic signal. The receiver element is configured to receive the second plasmonic wave signal from the output waveguide and to provide a second electromagnetic signal based on the second plasmonic wave signal.

Further embodiments provide a method for manufacturing a plasmonic wavelength separation structure. The method comprises providing an input waveguide to guide a first plasmonic wave signal, providing an output waveguide to guide a second plasmonic wave signal and providing a closed loop pathway forming a resonator structure such that a portion of the first plasmonic wave signal of the input waveguide is receivable by the resonator structure by coupling and such that the second plasmonic wave signal is receivable by the output waveguide from the resonator structure by coupling. The input waveguide, the resonator structure and the output waveguide each is provided by arranging a plasmonic wave guiding material configured for guiding the first and the second plasmonic wave signal.

Further embodiments provide a photonic wavelength separation structure comprising an input waveguide to guide a first electromagnetic signal, an output waveguide to guide a second electromagnetic signal and a resonator structure to receive a portion of the first electromagnetic signal from the input waveguide by coupling and to provide the second electromagnetic signal to the output waveguide based on the portion of the first electromagnetic signal by coupling. The resonator structure comprises a closed loop pathway. The input waveguide, the resonator structure and the output waveguide each comprise a semiconductor material for guiding the first and the second electromagnetic signal.

Further embodiments provide a microlab system comprising a photonic wavelength separation structure, a signal source to provide the first electromagnetic signal, a detector to receive the second electromagnetic signal and to detect a wavelength of the second electromagnetic signal or a wavelength derived thereof. The resonator structure is configured to be connectable with an ambient material and to influence the wavelength of the second electromagnetic signal based on an interaction between the portion of the first electromagnetic signal and the ambient material based on a changed resonance frequency of the resonator structure. The microlab system comprises a processor to determine a characteristic of the ambient material based on the wavelength of the second electromagnetic signal or the wavelength derived thereof.

Further embodiments provide an optical receiver comprising a photonic wavelength separation structure, wherein the input waveguide is connected to an input of the optical receiver. The input is configured to receive an optical communication signal and to provide the first electromagnetic signal based on the optical communication signal.

Further embodiments provide a method for manufacturing a photonic wavelength separation structure. The method comprises providing an input waveguide to guide a first electromagnetic signal, providing an output waveguide to guide a second electromagnetic signal and providing a closed loop pathway forming a resonator structure such that a portion of the first electromagnetic signal of the input waveguide is receivable by the resonator structure by coupling and such that the second electromagnetic signal is receivable by the output waveguide from the resonator structure by coupling. The input waveguide, the resonator structure and the output waveguide each is provided by arranging a semiconductor material configured for guiding the first and the second electromagnetic signal.

Further embodiments provide a photonic wavelength separation structure comprising a first output waveguide to guide a first electromagnetic output signal comprising a first wavelength associated with the first output waveguide. The photonic wavelength separation structure comprises a second output waveguide to guide a second electromagnetic output signal comprising a second wavelength associated with the second output waveguide and a third output waveguide to guide a third electromagnetic output signal comprising a third wavelength associated with the third output waveguide. The photonic wavelength separation structure comprises a circulatory pathway to receive an electromagnetic input signal comprising the first, the second and the third wavelength. The first output waveguide, the second output waveguide and the third output waveguide are formed as a photonic crystal structure and interconnected to each other by the circulatory pathway and configured to receive a portion of the electromagnetic input signal, the portion comprising the associated wavelength.

Further embodiments provide an optical receiver comprising a photonic wavelength separation structure, wherein the electromagnetic input signal is an optical communication signal received from an optical transmitter.

Further embodiments provide a method for manufacturing a photonic wavelength separation structure. The method comprises providing a first output waveguide at a substrate, the first output waveguide configured to guide a first electromagnetic output signal comprising a first wavelength associated with the first output waveguide. The method comprises providing a second output waveguide at the substrate, the second output waveguide configured to guide a second electromagnetic output signal comprising a second wavelength associated with the second output waveguide and providing a third output waveguide at the substrate, the third output waveguide configured to guide a third electromagnetic output signal comprising a third wavelength associated with the third output waveguide. The method comprises providing a circulatory pathway at the recess such that the first output waveguide, the second output waveguide and the third output waveguide are interconnected to each other by the circulatory pathway and such that a portion of the electromagnetic input signal is receivable by the first output waveguide, the second output waveguide and the third output waveguide from the circulatory pathway.

### BRIEF DESCRIPTION OF THE DRAWINGS

Embodiments are described herein making reference to the appended drawings.

FIG. 1A shows a schematic block diagram of a plasmonic wavelength separation structure according to an embodiment;

FIG. 1B shows a schematic block diagram of a plasmonic wavelength separation structure comprising a resonator structure which may be formed as a disc, according to an embodiment;

FIG. 2 shows a schematic block diagram of a plasmonic wavelength separation structure comprising a plurality of output waveguides, according to an embodiment;

FIG. 3 shows a schematic block diagram of a plasmonic wavelength separation structure comprising an electromagnetic signal source, according to an embodiment;

FIG. 4 shows a schematic block diagram of a microlab system comprising a plasmonic wavelength separation structure, according to an embodiment;

FIG. 5 shows a schematic block diagram of an optical receiver comprising a plasmonic wavelength separation structure, according to an embodiment;

FIG. 6 illustrates a schematic flowchart of a method for manufacturing a plasmonic wavelength separation structure, according to an embodiment;

FIG. 7A shows a schematic block diagram of a photonic wavelength separation structure, according to an embodiment;

FIG. 7B shows a schematic block diagram of a photonic wavelength separation structure comprising a resonator structure which may be formed as a disc, according to an embodiment;

FIG. 8 shows a schematic block diagram of a photonic wavelength separation structure comprising a plurality of output waveguides, according to an embodiment;

FIG. 9 shows a schematic block diagram of a photonic wavelength separation structure comprising an electromagnetic signal source, according to an embodiment;

FIG. 10A shows a schematic cross sectional view of an input waveguide according to an embodiment and of an output waveguide according to an embodiment;

FIG. 10B shows a schematic cross sectional view of the input waveguide and of the output waveguide illustrated in FIG. 10A, wherein a position of a thermal emitter and of a thermal detector is modified, according to an embodiment;

FIG. 11 shows a schematic block diagram of a microlab system comprising a photonic wavelength separation structure, according to an embodiment;

FIG. 12 shows a schematic block diagram of an optical receiver comprising the photonic wavelength separation structure shown in FIG. 7A, according to an embodiment;

FIG. 13 illustrates a schematic flowchart of a method for manufacturing a photonic wavelength separation structure, according to an embodiment;

FIG. 14 shows a schematic top view of a photonic wavelength separation structure, according to an embodiment;

FIG. 15 shows a schematic side view of the photonic wavelength separation structure of FIG. 14;

FIG. 16 shows a schematic side view of a intermediate product for a photonic wavelength separation structure according to an embodiment;

FIG. 17 shows a schematic top view of the photonic wavelength separation structure of FIG. 14 after processing the intermediate product of FIG. 15;

FIG. 18 shows a schematic side view of a photonic wavelength separation structure comprising three semiconductor waveguides, according to an embodiment;

FIG. 19 shows a schematic top view of a photonic wavelength separation structure comprising wavelength selection elements, according to an embodiment;

FIG. 20 illustrates an embodiment of semiconductor waveguide and a wavelength separation element being implemented as a grating resonator;

FIG. 21A illustrates a schematic top view of the semiconductor waveguide comprising a wavelength selection element formed as wavelength filter, according to an embodiment;

FIGS. 21B-21C illustrate filter characteristics of the wavelength filter of FIG. 21A, being implemented as a high-pass filter, as a band-pass filter respectively, according to an embodiment;

FIG. 22 shows a schematic block diagram of a further microlab system according to an embodiment;

FIG. 23 shows a schematic block diagram of a further optical receiver according to an embodiment;

FIG. 24 illustrates a schematic flowchart of a method for manufacturing a photonic wavelength separation structure, according to an embodiment;

FIG. 25 shows a schematic top view of a photonic wavelength separation structure comprising a photonic crystal structure, according to an embodiment;

FIG. 26 shows a schematic top view of a photonic wavelength separation structure comprising output waveguides formed curvy linear, according to an embodiment;

FIG. 27 shows a schematic top view of a photonic wavelength separation structure comprising an electromagnetic signal source, according to an embodiment;

FIG. 28 shows a schematic block diagram of an optical receiver comprising the photonic wavelength separation structure comprising a photonic crystal structure, according to an embodiment;

FIG. 29 illustrates a schematic flowchart of a method for manufacturing a photonic wavelength separation structure comprising a photonic crystal structure, according to an embodiment;

FIG. 30A shows a schematic perspective view of a substrate on which pillar structures are formed, according to an embodiment;

FIG. 30B shows a schematic perspective view of the substrate into which recesses are formed, according to an embodiment;

FIG. 31 shows a schematic top view of a further photonic wavelength separation structure comprising a photonic crystal structure, according to an embodiment;

FIG. 32A shows a schematic top view on a part of the photonic wavelength separation structure of FIG. 31a;

FIGS. 32B-32D illustrate functionality of photonic crystal structures according to embodiments described herein;

FIGS. 32E-32F illustrates a schematic top view of an arrangement of defect structures of a photonic crystal structure;

FIG. 33 shows a schematic block diagram of a microlab system comprising the photonic wavelength separation structure of FIG. 31 and a signal source, according to an embodiment;

FIG. 34 shows a schematic block diagram of an optical receiver comprising the photonic wavelength separation structure of FIG. 31, according to an embodiment; and

FIG. 35 shows a schematic flowchart of a method for manufacturing a photonic wavelength separation structure according to FIG. 31, according to an embodiment.

### DETAILED DESCRIPTION

Equal or equivalent elements or elements with equal or equivalent functionality are denoted in the following description by equal or equivalent reference numerals even if occurring in different figures.

In the following description, details are set forth to provide a more thorough explanation of embodiments provided herein. However, it will be apparent to those skilled in the art that the embodiments may be practiced without these specific details. In other instances, well-known structures and devices are shown in block diagram form rather than in detail in order to avoid obscuring the embodiments. In addition, features of the different embodiments described hereinafter may be combined with each other, unless specifically noted otherwise.

In the following, reference will be made to plasmonic waves, to waveguides for guiding plasmonic waves and to structures for coupling plasmonic waves.

Plasmons may be described as an oscillation of one or more free electrons with respect to the positive ions in a plasmonic wave guiding material, for example, a metal material or a doped semiconductor material. Moving electrons may be considered as to uncover positive ions by their movement. Their movement may extend until the electrons cancel the field inside the material. If the electric field is removed, the electrons may move back, e.g., repelled by each other and attracted to the positive ions. An oscillation back and forth at a plasma frequency of the material may be performed until an energy of the movement is lost, for example, by a resistance or a damping. Plasmons may be referred to as a quantization of such kinds of oscillation. Surface plasmons may be plasmons that are confined to surfaces and may interact strongly with a polarization. Plasmonic wave signals comprising surface plasmons may occur at an interface of a waveguide and may be excited, for example, by light. Simplified, surface plasmons may be understood as coherent delocalized electron oscillations that may exist at an interface between any two materials.

A real part of a (complex valued) dielectric function may change its algebraic sign across the interface and may allow for excitation at the surface plasmons. Surface plasmons may be excited by electrons and/or photons. For example, light may be used to excite surface plasmons and/or a plasmonic wave signal. The light may be used or coupled according to an otto-arrangement, a kretschmann-arrangement and/or according to other arrangements allowing for a match or an accordance of wave vectors of the photons and of the material configured to guide the plasmonic wave signal.

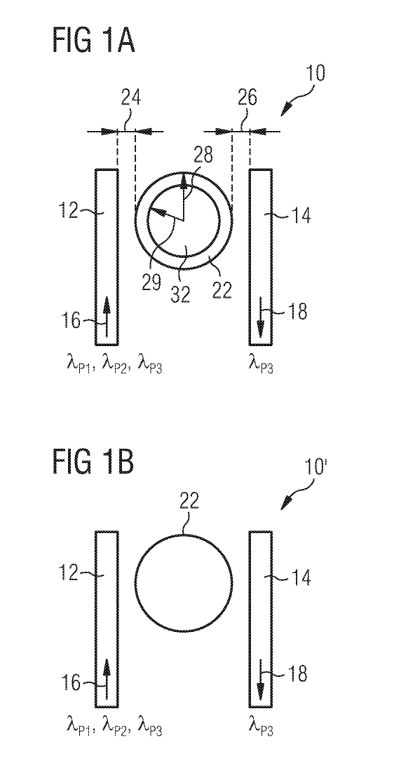

FIG. 1A shows a schematic block diagram of a plasmonic wavelength separation structure 10. The plasmonic wavelength separation structure 10 comprises an input waveguide 12 and an output waveguide 14. The input waveguide 12 may be configured to guide a first plasmonic wave signal 16. The output waveguide 14 may be configured to guide a second plasmonic wave signal 18.

The input waveguide 12, the output waveguide 14 and the resonator structure 22 may comprise a plasmonic wave guiding material for guiding the first and the second plasmonic wave signal 16 and 18. The plasmonic wave guiding material may comprise, for example, a metal material such as a gold material, a silver material, a copper material, an aluminum material, a platinum material and/or a tungsten material. Alternatively or in addition, the plasmonic wave guiding material may comprise a doped semiconductor material such as a doped silicon material and/or a doped gallium arsenide material. A degree of doping may be considered as high, i.e., the semiconductor material may be a highly doped semiconductor material. The degree of the doping may, for example, in a range of at least 0.01% and at most 50%, of at least 0.05% and at most 20% or of at least 1% and at most 10%. The doping may allow for obtaining a high number of free electrons for guiding the plasmonic waves. An amount of free electrons in a metal material at room temperature may be, for example, in a range between 10²² per cm³ and 10²³ per cm³. An amount of free electrons in a semiconductor material may be in a range of approximately 10⁹ when referring to a silicon material or may be in a range of app. 10¹³ when referring to a Germanium material. The doping may allow for an increase of the number of free electrons.

The first plasmonic wave signal 16 may comprise a first bandwidth and/or a plurality of wavelengths λ_{P1}, λ_{P2} and/or λ_{P3} and/or wavelength ranges comprising the wavelengths λ_{P1}, λ_{P2} and/or λ_{P3}. In the following, the wavelengths λ_{P1}, λ_{P2} and/or λ_{P3} may refer to a carrier of wavelength range comprising the respective wavelength λ_{P1}, λ_{P2} or λ_{P3}. The wavelength range associated with a wavelength λ_{P1}, λ_{P2}, λ_{P3} respectively may include the respective wavelength and a wavelength region within a tolerance of, for example, 20%, 10% or 5% of the respective wavelength or of a total bandwidth of the first plasmonic wave signal 16. Simplified, the first plasmonic wave signal 16 may be a broadband signal comprising a plurality of wavelengths or wavelength ranges.

The output waveguide 14 may be configured to guide the first plasmonic wave signal and may be formed equal to the input waveguide 12. Alternatively, the output waveguide 14 may comprise a different shape such as a different length, a different cross-sectional area and/or different extensions along other directions when compared to the input waveguide 12.

The plasmonic wavelength separation structure 10 may comprise a resonator structure 22. The resonator structure 22 is configured to receive a portion of the first plasmonic wave signal 16 from the input waveguide 12 by coupling and to provide the second plasmonic wave signal 18 to the output waveguide 14 based on the portion of the first plasmonic wave signal 16 by coupling. The resonator structure 22 comprises a closed loop pathway. For example, the resonator structure 22 may be formed as a ring and may comprise a circumferential (closed loop) pathway. For example, the resonator structure 22 may comprise a circular shape, an elliptical shape, a polygonal shape and/or a combination thereof. Coupling may occur between the resonator structure 22 and the input waveguide 12 and between the resonator structure 22 and the output waveguide 14. The resonator structure 22 and the waveguides 12 and 14 may be arranged such that adjacent portions of the elements allow for the coupling.

The portion of the first plasmonic wave signal 16 that may be coupled to the resonator structure 22 may comprise, for example, a wavelength or a wavelength range of the first plasmonic wave signal 16. For example, a wavelength range comprising the wavelength λ_{P3} may be coupled to the resonator structure 22 and a signal derived thereof may be coupled from the resonator structure 22 to the output waveguide 14. Thus, the second plasmonic wave signal 18 may be obtained based on the portion of the first plasmonic wave signal 16 coupled to the resonator structure 22. Simplified, the resonator structure 22 may be configured to extract a portion (wavelength range) of the first plasmonic wave signal 16 and to couple the signal derived from the extracted portion to the output waveguide 14 to obtain the second plasmonic wave signal 18.

A characteristic such as an amplitude or a wavelength of the portion coupled out of the input waveguide 12 may be influenced by a distance 24 between the input waveguide 12 and the resonator structure 24. A coupling between the resonator structure 22 and the output waveguide 14 may be influenced at least partially by a distance 26 between the resonator structure 22 and the output waveguide 14. For example, the distance 24 and/or the distance 26 may be at least 0.1 μm and at most 10 μm, at least 0.2 μm and at most 8 μm or at least 0.75 μm and at most 2 μm. The distances 24 and 26 may be equal to each other. The distances 24 and 26 may alternatively comprise a value different from each other. For example, the distance 24 and/or the distance 26 may essentially be equal to a wavelength of the portion or the signal to be coupled (e.g., λ_{P1}, λ_{P2} or λ_{P3}) or be essentially equal to a value derived thereof, for example λ/2 or λ/4.

A length of the closed loop pathway, for example, an outer circumference of a ring structure, may be influenced by an (outer) radius 28 of the resonator structure 22 and/or by an inner radius 29 of the resonator structure. A difference between the outer radius 28 and the inner radius 29 may be referred to as a width of the closed loop pathway or of a ring structure. The outer radius 28 may be larger than or equal to the inner radius 29. I.e., the resonator structure 22 may be formed as a round, elliptical or polygon shaped disc, wherein the term disc may be used interchangeably with the term disk. The length of the closed loop pathway may be, for example, a multiple of the wavelength of the portion to be received from the first plasmonic wave signal 16, e.g., λ_{P3}.

A width (outer radius 28 minus inner radius 29) of the ring structure may be based on a single mode propagation of the plasmonic wave signal to be coupled. Alternatively, the width may comprise different values.

The coupling of the portion of the first plasmonic wave signal 16 to the resonator structure 22 and/or from the resonator structure 22 to the output waveguide 14 may be based on an electronic coupling between the resonator structure 22 and the input waveguide 12 and/or between the resonator structure 22 and the output waveguide 14. The electronic coupling may comprise a transfer of surface plasmons (plasmonic wave signals) from one structure to another.

A length of the circulatory pathway of the resonator structure 22 may be a multiple of the wavelength of the second plasmonic wave signal 18 within a tolerance range. The tolerance range may be less than or equal to 10%, 5% or 2%.

The length of the circulatory pathway may be, for example, shorter than or equal to 300 μm, 200 μm or 100 μm. The input waveguide 12, the output waveguide 14 and the resonator structure 22 may be arranged, for example, on a substrate. The substrate may be, for example, a semiconductor substrate or a substrate comprising a metal material. The resonator structure 22 may be arranged between the input waveguide 12 and the output waveguide 14. The input waveguide 12 and the output waveguide 14 may be arranged essentially parallel, but may also be arranged with an angle therebetween. For example, an angle between the input waveguide 12 and the output waveguide 14 may comprise a value between 0° and 180°, between 22.5° and 150.5° and/or between 45° and 135°.

The input waveguide 12 and the output waveguide 14 may comprise a straight axial extension. Alternatively, the input waveguide 12 and/or the output waveguide 14 may comprise a curved axial extension or may comprise an axial extension that is straight in sections.

The resonator structure 22 may be connectable with an ambient material. For example, the ambient material may be arranged at an inner surface area 32 of the substrate enclosed by the circulatory pathway of the resonator structure 22. A presence of the ambient material may allow for an interaction between the portion of the first plasmonic wave signal 16 coupled to the resonator structure 22 such that an amplitude, a wavelength and/or a bandwidth of the second plasmonic wave signal 18 may be influenced by the presence of the ambient material. The influence may be detected, for example when evaluating the amplitude, wavelength or bandwidth of the second plasmonic wave signal 18 and may allow for determining a characteristic of the ambient material and/or a presence of the ambient material.

FIG. 1B shows a schematic block diagram of a plasmonic wavelength separation structure 10′ being modified when compared to the plasmonic wavelength separation 10. The plasmonic wavelength separation structure 10′ comprises the resonator structure 22 which may be formed as a disc. Forming the resonator structure 22 as a disc may allow for a simple manufacturing process, when compared to the resonator structure 22. The resonator structure 22 may allow for a propagation of multiple modes of the plasmonic wave signal received. The propagation may be allowable, for example, by compensating effects with a read-out electronics.

Embodiments described below may refer to plasmonic wavelength separation structures comprising at least one resonator structure being formed as a ring structure. According to other embodiments the resonator structures may be formed as a disc structure.

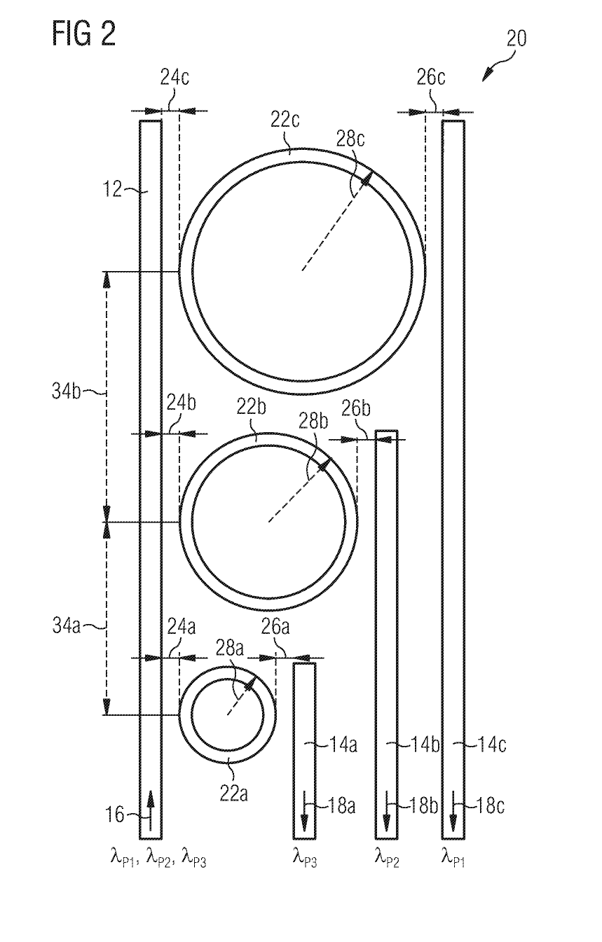

FIG. 2 shows a schematic block diagram of a plasmonic wavelength separation structure 20 comprising the input waveguide 12 and a plurality of output waveguides 14a-c. The plasmonic wavelength separation structure 20 may comprise a plurality of resonator structures 22a-c. Each of the plurality of resonator structures 22a-c may be associated with an output waveguide 14a-c and may be arranged between the input waveguide 12 and an associated output waveguide 14a-c. For example, the resonator structure 22a may be associated with the output waveguide 14a. The resonator structure 22b may be associated with the output waveguide 14b. The resonator structure 22c may be associated with the output waveguide 14c.

Each of the resonator structures 22a-c may be configured to receive a different portion, i.e., a different wavelength region from the input waveguide 12. The resonator structures 22a-c may comprise different lengths of the circumferential (closed loop) pathway. For example, the resonator structures 22a-c may comprise different radii 22a-c. Adjacent resonator structures 22a and 22b, 22b and 22c respectively may be arranged with distances 34a and/or 34b therebetween. The distance 34a between the resonator structures 22a and 22b or between centers thereof and the distance 34b between the resonator structures 22b and 22c or between centers thereof may reduce or prevent a crosstalk between the resonator structures, for example, an influence of a portion received from a resonator structure 22a-c to a portion received from another resonator structure may be low or almost zero.

The circumferential pathway of the resonator structures 22a-c may be different from each other in a way that a length of the circumferential pathway of one resonator structure is different from a whole-numbered (integer) multiple of a length of one, a multitude or all of the other resonator structures 22a-c. This may allow for wavelengths to be received from the resonator structures 22a-c that are not a whole-numbered integer from each other such that interference between the portions coupled out may be reduced or prevented.

For example, the resonator structure 22a may be configured to couple the wavelength region comprising the wavelength λ_{P3} to the output waveguide 14a to obtain the plasmonic wave signal 18a which may correspond to the plasmonic wave signal 18 described in FIG. 1. The resonator structure 22b may be configured to couple a wavelength region comprising the wavelength λ_{P2} to the output waveguide 14 to obtain a plasmonic wave signal 18b comprising the wavelength λ_{P2}. The resonator structure 22c may be configured to couple a wavelength region comprising the wavelength λ_{P1} to the output waveguide 14c to obtain a plasmonic wave signal 18c comprising the wavelength λ_{P1}. The resonator structures 22a, 22b and/or 22c may be configured to be connectable with same or different ambient materials such that an evaluation of the plasmonic wave signals 18a-c may allow for detection of a presence or a concentration of one or more ambient materials.

Distances 24a-c between a respective resonator structure 22a-c and the input waveguide 12 and/or distances 26a-c between the respective resonator structures 22a-c and the associated respective output waveguide 14a-c may be essentially equal to the respective wavelength λ_{P1}, λ_{P2} and λ_{P3} to be coupled or a value derived thereof, such as λ/2 or λ/4. Thus, the distances 24a, 24b and 24c may be different from each other. This may allow for coupling different wavelengths λ_{P1}, λ_{P2} and λ_{P3} to different resonator structures 22a, 22b and 22c. Alternatively or in addition, the distances 26a, 26b and 26c may be different from each other. This may allow for coupling different wavelengths λ_{P1}, λ_{P2} and λ_{P3} to the output waveguides 14a, 14b and 14c. Distances 24a and 26a, 24b and 26b and/or 24c and 26c may be essentially equal. A value of each distance 24a-c and/or 26a-c may be equal as described with respect to the distances 24 and 26 illustrated in FIG. 1.

The input waveguide 12, the resonator structures 22a-c and the output waveguides 14a-c may form a ring resonator arrangement, for example, comprising resonator structures 22a-c formed as a ring structure. Alternatively or in addition, the input waveguide 12, the resonator structures 22a-c and the output waveguides 14a-c may form a disc resonator arrangement, for example, comprising resonator structures 22a-c formed as a disc structure. Simplified, the plasmonic wavelength separation structure 20 allows for separating wavelength regions comprising different wavelengths λ_{P1}, λ_{P2} and λ_{P3}. For example, a broadband signal comprising different signals transmitted at different wavelength regions may be separated into single signals which may also referred to as monochromatic signals even when comprising more than one wavelength.

The plasmonic wavelength separation structure may be at least a part of a wavelength separation filter which may also be referred to as a demultiplexer. For example, the plasmonic wave signal 16 may be excited based on a broadband light, e.g., a broadband optical communication signal. The signal may be divided into single components by separating the plasmonic wave signals 18a-c and may be transferred or converted to an optical or electrical signal for further processing.

Plasmonic wavelength separation structures 10 and/or 20 allow for implementation of small wavelength separation filters, optical receivers and/or microlabs (laboratories with small sizes) for detecting an ambient material. Small wavelengths of the plasmonic wave signals allow for small extensions of the components, i.e., waveguides and resonator structures.

In other words, a wavelength separation filter (WSF) device may be constructed from an input waveguide, parallel rings (resonator structures) and output waveguides, wherein one output waveguide may be associated with each ring. One or more, probably all, of the components, the waveguides and the rings may comprise a plasmonic wave guiding material, which allows excitation and propagation of surface plasmons. Characteristics of surface plasmons (i.e., development below the diffraction limit of light and relatively small propagation distances) may allow for very short waveguides and resonator structures with short circumferential pathways, for example, a couple of micrometers and/or a sub-micrometer-range. This may allow for ring resonators comprising a large free spectral range (FSR). A big separation between the resonance wavelengths (frequencies) in the ring may be achieved. For sufficiently small lengths of the circumferential pathway a wavelength range comprising essentially one frequency may be coupled out of a broadband signal, for example, as essentially only one frequency fulfills the resonant condition of the resonator structures. Thus, each resonator structure may deliver essentially only one wavelength at the output. The propagating electromagnetic field in the waveguides and in the resonator structure may be essentially or purely plasmonic in nature.

Although the plasmonic wavelength separation structure 20 is described as comprising three resonator structures 22a-c and three output waveguides 14a-c, other examples provide plasmonic wavelength separation structures comprising two, four or more than four resonator structures and output waveguides. Further embodiments provide a plasmonic wavelength separation structure configured for separating two, four or more than four wavelengths. For example, a plasmonic wavelength separation structure may comprise at least 1 and at most 1000 (or more) resonator structures and/or associated output waveguides, at least 2 and at most 500 resonator structures and/or associated output waveguides or may comprise at least 10 and at most 100 resonator structures and/or associated output waveguides. For example, a number of wavelengths to be separated (i.e., a number of separation structures and/or a number of output waveguides) may be influenced by a resolution of a manufacturing process for manufacturing the plasmonic wavelength separation structure. For example, a bandwidth of the first plasmonic wave signal 16 may be separated (split) into a number of wavelengths, the number being influenced by a tolerance range of the manufacturing process. A decreasing tolerance range of the manufacturing process (e.g., 50 nm, 20 nm or 5 nm) may allow for an increasing number of wavelengths to be separated. The (structural) tolerance range may be considered by a secureness-bandwidth which may decrease for decreasing tolerance ranges. Currently, typically dimensions±tolerance ranges of a crystal structure obtained by a lithographic manufacturing processes may be, for example, approximately 450 nm±50 nm (i.e., a tolerance range of 50 nm) when using a G-line equipment of a lithography process, approximately 350 nm±30 nm (i.e., a tolerance range of 30 nm) when using a Mine equipment of a lithography process, approximately 150 nm±15 nm (i.e., a tolerance range of 15 nm) when using a deep ultra violet (DUV) equipment of a lithography process or approximately 100 nm±10 nm (i.e., a tolerance range of 10 nm) when using an electron beam (e-beam) lithography equipment.

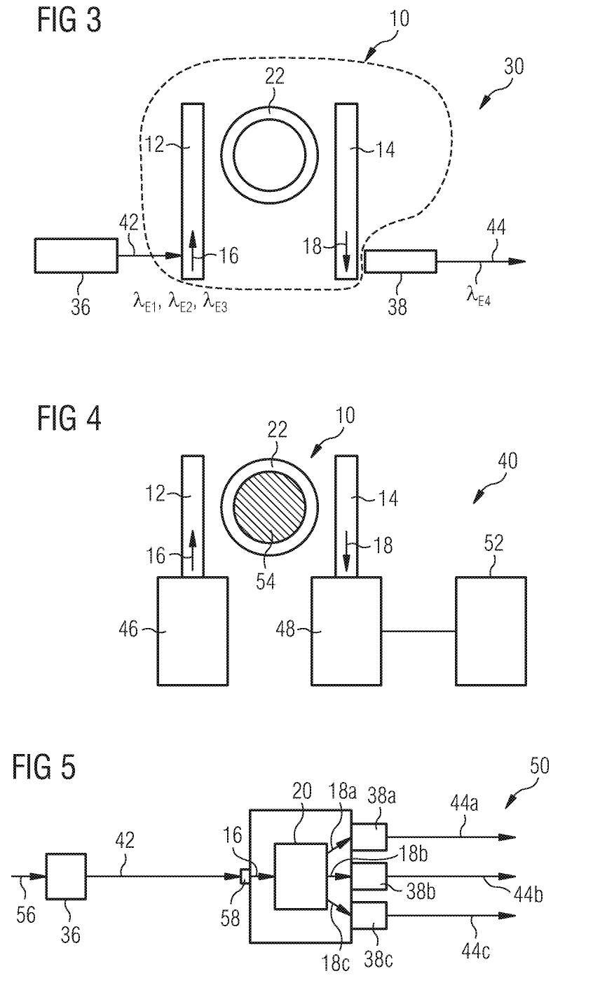

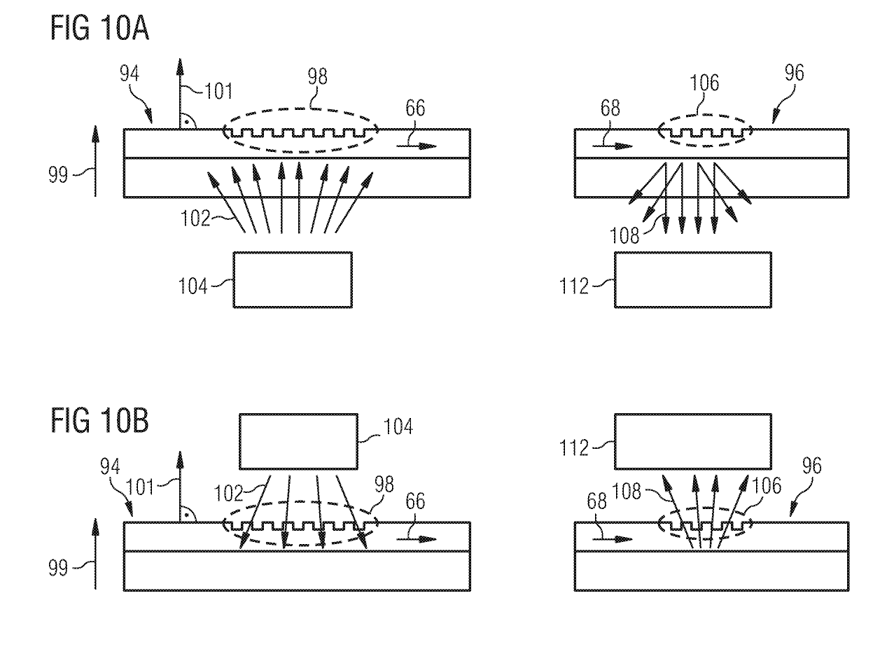

FIG. 3 shows a schematic block diagram of a plasmonic wavelength separation structure 30. The plasmonic wavelength separation structure 30 may comprise the plasmonic wavelength separation structure 10, an electromagnetic signal source 36 and a receiver element 38. The electromagnetic signal source 36 may be configured to emit an electromagnetic signal 42 comprising a plurality of wavelengths or wavelength ranges λ_{E1}, λ_{E2} and/or λ_{E3}. The electromagnetic signal source may comprise, for example, a light emitting diode (LED), a laser-LED, a photonic crystal and/or a thermal radiation source as described with respect to FIG. 10A and FIG. 10B. The thermal radiation source may be configured for emitting a thermal radiation. For example, the thermal radiation may be coupled to the input waveguide 12 and/or from the output waveguide 14 by a rib structure or a grating structure.

The electromagnetic signal source 36 may be coupled to the input waveguide 12 and may be configured to excite the first plasmonic wave signal 16 in the input waveguide 12 based on the electromagnetic signal 42. The electromagnetic signal source may be coupled to a communication system and may receive an optical or an electrical communication signal comprising a plurality of carrier signals (wavelength ranges) such that the electromagnetic signal 42 may be obtained based on the broadband signal.

Wavelengths of the plasmonic wave signal 16 may be equal or different to the wavelength of the electromagnetic signal 42. A coupling may be obtained, for example, by a coupling element such as a prism. The receiver element 38 may be configured to receive the second plasmonic wave signal 18 from the output waveguide 14. The receiver element 38 may be configured to provide an electromagnetic signal 44 based on the plasmonic wave signal 18. A wavelength or wavelength range λ_{E4} of the electromagnetic signal 44 may be based on a wavelength or wavelength range or an amplitude of the plasmonic wave signal 18. The wavelength λ_{E4} may be equal or different from a frequency of the electromagnetic signal 42. For example, the wavelength λ_{E4} may be influenced by a varying resonance frequency of the resonator structure 22, e.g., based on a contact with an ambient material. Alternatively or in addition, the wavelength λ_{E4} may be obtained by a conversion of a wavelength of the plasmonic wave signal 18 by the receiver element 38. The wavelength λ_{E4} may be based on a wavelength of the electromagnetic signal 42 and at least partially influenced by the resonator structure 22.

Alternatively or in addition, a different plasmonic wavelength separation structure may be arranged, for example, the plasmonic wavelength separation structure 20.

The plasmonic wavelength separation structure 30 may allow for separating one or more wavelengths λ_{E1}, λ_{E2} and/or λ_{E3} by conversion to a plasmonic wave signal and by extracting or separating one or more of the obtained wavelengths of the plasmonic signal.

FIG. 4 shows a schematic block diagram of a microlab system 40 comprising the plasmonic wavelength separation structure 10, a signal source 46, a detector 48 and a processor (read out electronics) 52.

The resonator structure 22 may be configured to be connectable with an ambient material 54, e.g., the ambient material 38. A wavelength of the plasmonic wave signal 18 may be influenced based on an interaction between the portion of the plasmonic wave signal 16 coupled to the resonator structure 22 and the ambient material 54. The ambient material 54 may be connectable to the resonator structure at an inner region thereof, such as a region surrounded (enclosed) by the inner radius of the resonator structure 22. Alternatively or in addition, the ambient material 54 may be connectable to the resonator structure 22 at the outer radius, for example, when the resonator structure 22 is formed as a disc.

For example, a resonance frequency of the resonator structure 22 may be influenced based on the interaction such that a wavelength. Alternatively or in addition an amplitude or a wavelength range of the plasmonic wave signal 18 may be influenced (increased or decreased) by the contact between the resonator structure 22 and the ambient material 48. The signal source 46 may be configured to provide the plasmonic wave signal 16, for example, by coupling an electromagnetic signal, e.g., the electromagnetic signal 42, to the input waveguide 12.

The detector 48 may be configured to detect a wavelength of the plasmonic wave signal 18 or a modification thereof when receiving the plasmonic wave signal 18. For example, the detector 48 may be coupled to the output waveguide 14 to receive the plasmonic wave signal 18.

The processor 52 may be connected to the detector 48 and may be configured to determine a characteristic of the ambient material 54 based on the modified wavelength, wavelength range or amplitude of the plasmonic wave signal 18 or a wavelength derived thereof. A wavelength derived thereof may refer to a wavelength of a signal derived from the plasmonic wave signal 18, for example, an electrical or optical signal into which the plasmonic wave signal 18 is converted.

The microlab system 40 may be, for example, part of a mobile device such as a mobile scanner, a mobile phone or a vehicle. This may allow for detecting a characteristic (such as a presence, a concentration or the like) of the ambient material 54 with the mobile device. Although the microlab system 40 is described as comprising the plasmonic wavelength separation structure 10, alternatively or in addition further and/or a different plasmonic wavelength separation structure may be arranged, for example, the plasmonic wavelength separation structure 10′ 20 or 30.

The ambient material 38 and/or 54 may be a fluid such as a liquid or a gas or a material of the fluid. For example, the ambient material 38 and/or 54 may be a substance of the air such as ozone, oxygen or carbon dioxide. Alternatively or in addition, the ambient material 54 may be a solid material that may be dispersed in the fluid such as fine dust or the like. The resonator structure may comprise a coating, for example, a hydrophobic coating which may allow for a fast removal of the ambient material 54 from the resonator structure 22 with a low amount of residues.

FIG. 5 shows a schematic block diagram of an optical receiver 50 comprising the plasmonic wavelength separation structure 20. The optical receiver 50 further comprises the electromagnetic signal source 36 configured to emit the electromagnetic signal 42 based on a received optical communication signal 54. The electromagnetic signal source may be, for example, an input interface of the optical receiver 50 configured for forwarding and/or converting the optical communication signal 56 into the electromagnetic signal 42. For example, the electromagnetic signal 42 may be the optical communication signal 56. The optical receiver comprises a coupling element 58, for example a prism or the like such that the plasmonic wave signal 16 may be obtained based on the electromagnetic signal 42.

The optical receiver 50 comprises a plurality of receiver elements 38a-c configured to receive one of the plasmonic wave signals 18a-c from the output waveguide of the plasmonic wavelength separation structure 20 and to provide electromagnetic signals 44a-c based on the received plasmonic wave signals 18a-c.

For example, the electromagnetic signals 44a-c may each comprise a wavelength region of the optical communication signal 56.

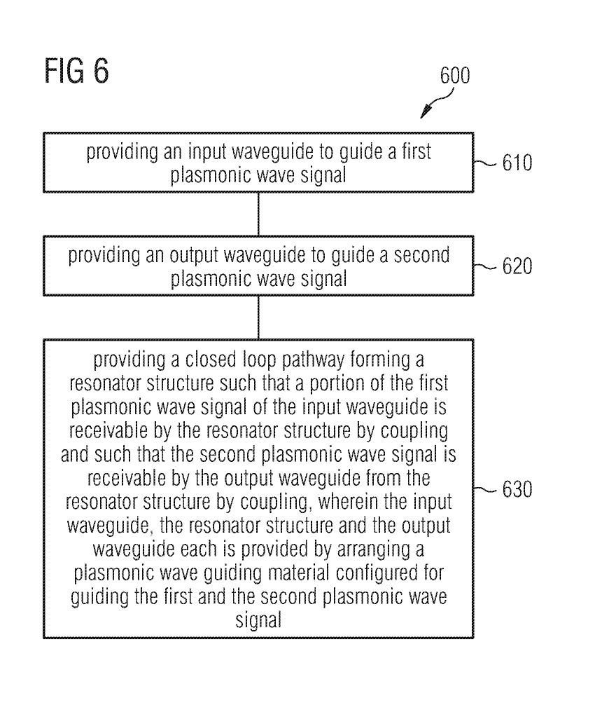

FIG. 6 illustrates a schematic flowchart of a method 600 for manufacturing a plasmonic wavelength separation structure. The method 600 may be used, for example, for manufacturing the plasmonic wavelength separation structure 10, 20 and/or 30.

The method 600 comprises a step 610 in which an input waveguide configured to guide a first plasmonic wave signal is provided.

In a step 620 of method 600 an output waveguide configured to guide a second plasmonic wave signal is provided.

In a step 630 of method 600 a closed loop pathway forming a resonator structure is provided such that a portion of the first plasmonic wave signal of the input waveguide is receivable by the resonator structure by coupling and such that the second plasmonic wave signal is receivable by the output waveguide from the resonator structure by coupling.

The input waveguide, the resonator structure and the output waveguide each is provided in step 610, 620, 630 respectively by arranging a plasmonic wave guiding material configured for guiding the first and the second plasmonic wave signal.

Embodiments described in the following refer to photonic wavelength separation structures, a microlab system comprising a photonic wavelength separation structure and to an optical receiver comprising a photonic wavelength separation structure. Photonic wavelength separation structures described hereinafter may refer to guiding and/or coupling an electromagnetic signal, e.g., a photonic signal which may be described simplified as comprising a visible and/or invisible light. For example, electromagnetic signals may comprise wavelengths in the infrared range and/or may generated by thermal radiation. Waveguides and/or resonator structures for guiding and/or coupling electromagnetic signals described hereinafter may comprise a semiconductor material such as a silicon material or a Gallium Arsenide material. The semiconductor material may comprise a doping material such as phosphorus or boron to adjust a conductivity of the waveguides or resonator structures. A substrate on which the waveguides and/or the resonator structure is arranged may be an insulating material or a material comprising a low thermal conductivity when compared to a material of the waveguides and/or of the resonator structure. For example, the waveguides and/or the resonator structure may be formed essentially of the semiconductor material wherein the substrate may comprise a silicon nitrite material.

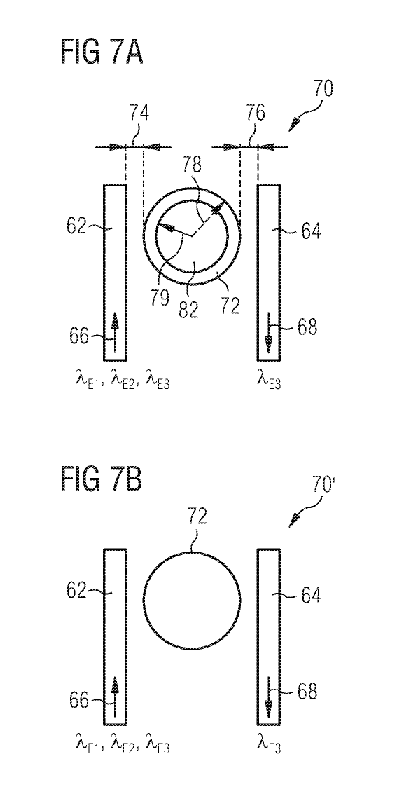

FIG. 7A shows a schematic block diagram of a photonic wavelength separation structure 70. The photonic wavelength separation structure 70 comprises an input waveguide 62 and an output waveguide 64. The input waveguide 62 may be configured to guide a first electromagnetic signal 66. The output waveguide 64 may be configured to guide a second electromagnetic signal 68.

The input waveguide 62, the output waveguide 64 and/or the resonator structure 72 may comprise a metal material for guiding the first and/or the second electromagnetic signal 66 and 68. Alternatively, the input waveguide 62, the output waveguide 64 and/or the resonator structure 72 may comprise a semiconductor material for guiding the first and/or the second electromagnetic signal 66 and/or 68. A semiconductor material such as silicon or gallium arsenide may be advantageous, for example, for guiding electromagnetic signals in an (infrared) wavelength range such as between 1 μm and 10 μm. The metal material may comprise, for example, a gold material, a silver material, a copper material, an aluminum material, a platinum material and/or a tungsten material.

The first electromagnetic signal 66 may comprise a first bandwidth and/or a plurality of wavelengths comprising the wavelengths λ_{E1}, λ_{E2} and/or λ_{E3}, wavelength ranges comprising the wavelengths λ_{E1}, λ_{E2} and/or λ_{E3}, respectively. In the following, the wavelengths λ_{E1}, λ_{E2} and/or λ_{E3} may refer to a carrier of wavelength range comprising the respective wavelength λ_{E1}, λ_{E2} or λ_{E3}. The wavelength range associated with a wavelength λ_{E1}, λ_{E2}, λ_{E3} respectively may include the respective wavelength and a wavelength region within a tolerance of, for example, 20%, 10% or 5% of the respective wavelength or of a total bandwidth of the first electromagnetic signal 66. Simplified, the first electromagnetic signal 66 may be a broadband signal comprising a plurality of wavelengths or wavelength ranges.

The output waveguide 64 may be configured to guide the first electromagnetic signal 66 and may be formed equal to the input waveguide 62. Alternatively, the output waveguide 64 may comprise a different shape such as a different length, a different cross-sectional area and/or different extensions along other directions when compared to the input waveguide 62.

The photonic wavelength separation structure 70 may comprise a resonator structure 72. The resonator structure 72 is configured to receive a portion of the first electromagnetic signal 66 from the input waveguide 62 by coupling and to provide the second electromagnetic signal 68 to the output waveguide 64 based on the portion of the first electromagnetic signal 66 by coupling. The resonator structure 72 comprises a closed loop pathway. For example, the resonator structure 72 may be formed as a ring and may comprise a circumferential (closed loop) pathway. For example, the resonator structure 72 may comprise a circular shape, an elliptical shape, a polygonal shape and/or a combination thereof. Coupling may occur between the resonator structure 72 and the input waveguide 62 and between the resonator structure 72 and the output waveguide 64. The resonator structure 72 and the waveguides 62 and 64 may be arranged such that adjacent portions of the elements allow for the coupling.

The portion of the first electromagnetic signal 66 that may be coupled to the resonator structure 72 may comprise, for example, a wavelength or a wavelength range of the first electromagnetic signal 66. For example, a wavelength range comprising the wavelength λ_{E3} may be coupled to the resonator structure 72 and a signal derived thereof may be coupled from the resonator structure 72 to the output waveguide 64. Thus, the second electromagnetic signal 68 may be obtained based on the portion of the first electromagnetic signal 66 coupled to the resonator structure 72. Simplified, the resonator structure 72 may be configured to extract a portion (wavelength range) of the first electromagnetic signal 66 and to couple the signal derived from the extracted portion to the output waveguide 64 to obtain the second electromagnetic signal 68.

A characteristic such as an amplitude or a wavelength of the portion coupled out of the input waveguide 62 may be influenced by a distance 74 between the input waveguide 62 and the resonator structure 74. A coupling between the resonator structure 72 and the output waveguide 64 may be influenced at least partially by a distance 76 between the resonator structure 72 and the output waveguide 64. For example, the distance 74 and/or the distance 76 may be at least 0.1 μm and at most 10 μm, at least 0.2 μm and at most 8 μm or at least 0.75 μm and at most 2 μm. The distances 24 and 26 may be equal to each other. The distances 24 and 26 may alternatively comprise a value different from each other. For example, the distance 74 and/or the distance 76 may essentially be equal to a wavelength of the portion or the signal to be coupled or be essentially equal to a value derived thereof, for example λ/2 or λ/4.

A length of the closed loop pathway, for example, an outer circumference of a ring structure, may be influenced by an (outer) radius 78 of the resonator structure 72 and/or by an inner radius 79 of the resonator structure. A difference between the outer radius 78 and the inner radius 79 may be referred to as a width of the closed loop pathway or of a ring structure. The outer radius 78 may be larger than or equal to the inner radius 79. I.e., the resonator structure 72 may be formed as a round, elliptical or polygon shaped disc, wherein the term disc may be used interchangeably with the term disk. The length of the closed loop pathway may be, for example, a multiple of the wavelength of the portion to be received from the first electromagnetic signal 66, e.g., λ_{E3}.

A width (outer radius 78 minus inner radius 79) of the ring structure may be based on a single mode propagation of the electromagnetic signal to be coupled. Alternatively, the width may comprise different values.

The coupling of the portion of the first electromagnetic signal 66 to the resonator structure 72 and/or from the resonator structure 72 to the output waveguide 64 may be based on an electronic coupling between the resonator structure 72 and the input waveguide 62 and/or between the resonator structure 72 and the output waveguide 64. The electromagnetic coupling may comprise a transfer of electromagnetic radiation (photonic signals) from one structure to another.

A length of the circulatory pathway of the resonator structure 72 may be a multiple of the wavelength of the second electromagnetic signal 68 within a tolerance range. The tolerance range may be less than or equal to 10%, 5% or 2%.

The length of the circulatory pathway may be, for example, shorter than or equal to 300 μm, 200 μm or 100 μm. The input waveguide 62, the output waveguide 64 and the resonator structure 72 may be arranged, for example, on a substrate. The substrate may be, for example, a semiconductor substrate or a substrate comprising a metal material. The resonator structure 72 may be arranged between the input waveguide 62 and the output waveguide 64. The input waveguide 62 and the output waveguide 64 may be arranged essentially parallel, but may also be arranged with an angle therebetween. For example, an angle between the input waveguide 62 and the output waveguide 64 may comprise a value between 0° and 180°, between 22.5° and 150.5° and/or between 45° and 135°.

The input waveguide 62 and the output waveguide 64 may comprise a straight axial extension. Alternatively, the input waveguide 62 and/or the output waveguide 64 may comprise a curved axial extension or may comprise an axial extension that is straight in sections.

The resonator structure 72 may be connectable with an ambient material. For example, the ambient material may be arranged at an inner surface area 82 of the substrate enclosed by the circulatory pathway of the resonator structure 72. A presence of the ambient material may allow for an interaction between the portion of the first photonic signal 66 coupled to the resonator structure 72 such that an amplitude, a wavelength and/or a bandwidth of the second electromagnetic signal 68 may be influenced by the presence of the ambient material. The influence may be detected, for example when evaluating the amplitude, wavelength or bandwidth of the second electromagnetic signal 68 and may allow for determining a characteristic of the ambient material and/or a presence of the ambient material.

The resonator structure 72 and/or one or more waveguides 62 and/or 64 may be formed as a rib structure (solid structure) or as a photonic crystal structure.

In other words, a photonic wavelength separation filter may be made at least partially from a silicon (Si) and based on parallel ring resonators. The free spectral range, thus, the number of resonant wavelengths may be controlled by the radius of the rings and a distance between the rings.

FIG. 7B shows a schematic block diagram of a photonic wavelength separation structure 70′ being modified when compared to the photonic wavelength separation 70. The photonic wavelength separation structure 70′ comprises the resonator structure 72 which may be formed as a disc. Forming the resonator structure 72 as a disc may allow for a simple manufacturing process, when compared to the resonator structure 72. The resonator structure 72 may allow for a propagation of multiple modes of the photonic (electromagnetic) wave signal received. The propagation may be allowable, for example, by compensating effects with a read-out electronics.

Embodiments described below may refer to photonic wavelength separation structures comprising at least one resonator structure being formed as a ring structure. According to other embodiments the resonator structures may be formed as a disc structure.

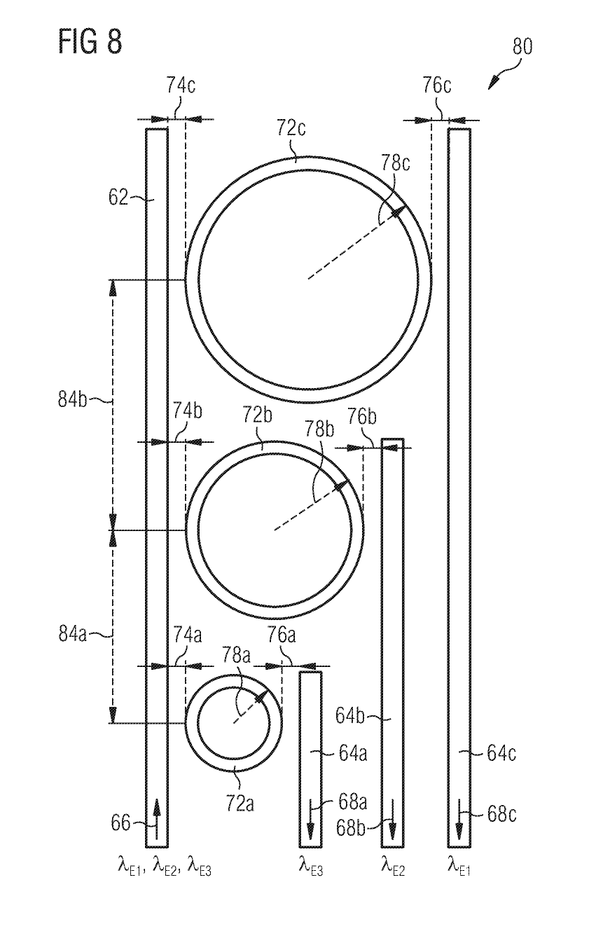

FIG. 8 shows a schematic block diagram of a photonic wavelength separation structure 80 comprising the input waveguide 62 and a plurality of output waveguides 64a-c. The photonic wavelength separation structure 80 may comprise a plurality of resonator structures 72a-c. Each of the plurality of resonator structures 72a-c may be associated with an output waveguide 64a-c and may be arranged between the input waveguide 62 and an associated output waveguide 64a-c. For example, the resonator structure 72a may be associated with the output waveguide 64a. The resonator structure 72b may be associated with the output waveguide 64b. The resonator structure 72c may be associated with the output waveguide 64c.

Each of the resonator structures 72a-c may be configured to receive a different portion, i.e., a different wavelength region from the input waveguide 62. The resonator structures 72a-c may comprise different lengths of the circumferential (closed loop) pathway. For example, the resonator structures 72a-c may comprise different radii 72a-c. Adjacent resonator structures 72a and 72b, 72b and 72c respectively may be arranged with distances 34a and/or 34b therebetween. The distance 34a between the resonator structures 72a and 72b or between centers thereof and the distance 34b between the resonator structures 72b and 72c or between centers thereof may reduce or prevent a crosstalk between the resonator structures, for example, an influence of a portion received from a resonator structure 72a-c to a portion received from another resonator structure may be low or almost zero.

Distances 74a-c between a respective resonator structure 72a-c and the input waveguide 62 and/or distances 76a-c between the respective resonator structures 72a-c and the associated respective output waveguide 64a-c may be essentially equal to the respective wavelength λ_{P1}, λ_{P2} and λ_{P3} to be coupled or a value derived thereof, such as λ/2 or λ/4. Thus, the distances 74a, 74b and 74c may be different from each other. This may allow for coupling different wavelengths λ_{E1}, λ_{E2} and λ_{E3} to different resonator structures 72a, 72b and 72c. Alternatively or in addition, the distances 76a, 76b and 76c may be different from each other. This may allow for coupling different wavelengths λ_{E1}, λ_{E2} and λ_{E3} to the output waveguides 64a, 64b and 64c. Distances 74a and 76a, 74b and 76b and/or 74c and 76c may be essentially equal. A value of each distance 74a-c and/or 76a-c may be equal as described with respect to the distances 74 and 76 illustrated in FIG. 7.

The circumferential pathway of the resonator structures 72a-c may be different from each other in a way that a length of the circumferential pathway of one resonator structure is different from a whole-numbered (integer) multiple of a length of one, a multitude or all of the other resonator structures 72a-c. This may allow for wavelengths to be received from the resonator structures 72a-c that are not a whole-numbered integer from each other such that interference between the portions coupled out may be reduced or prevented.

For example, the resonator structure 72a may be configured to couple the wavelength region comprising the wavelength λ_{E3} to the output waveguide 64a to obtain the electromagnetic signal 68a which may correspond to the electromagnetic signal 68 described in FIG. 7. The resonator structure 72b may be configured to couple a wavelength region comprising the wavelength λ_{E2} to the output waveguide 64 to obtain an electromagnetic signal 68b comprising the wavelength λ_{E2}. The resonator structure 72c may be configured to couple a wavelength region comprising the wavelength λ_{E1} to the output waveguide 64c to obtain an electromagnetic signal 68c comprising the wavelength λ_{E1}. The resonator structures 72a, 72b and/or 72c may be configured to be connectable with same or different ambient materials such that an evaluation of the electromagnetic signals 68a-c may allow for detection of a presence or a concentration of one or more ambient materials.

The input waveguide 62, the resonator structures 72a-c and the output waveguides 64a-c may form a ring resonator arrangement, for example, comprising resonator structures 72a-c formed as a ring structure. Alternatively or in addition, the input waveguide 62, the resonator structures 72a-c and the output waveguides 64a-c may form a disc resonator arrangement, for example, comprising resonator structures 72a-c formed as a disc structure. Simplified, the photonic wavelength separation structure 80 allows for separating wavelength regions comprising different wavelengths λ_{E1}, λ_{E2} and λ_{E3}. For example, a broadband signal comprising different signals transmitted at different wavelength regions may be separated into single signals which may also referred to as monochromatic signals even when comprising more than one wavelength.

The photonic wavelength separation structure may be at least a part of a wavelength separation filter which may also be referred to as a demultiplexer. For example, the electromagnetic signal 66 may be excited based on a broadband light, e.g., a broadband optical communication signal. The signal may be divided into single components by separating the electromagnetic signals 68a-c and may be transferred or converted to an optical or electrical signal for further processing.

Photonic wavelength separation structures 70 and/or 80 allow for implementation of small wavelength separation filters, optical receivers and/or microlabs for detecting an ambient material. Small wavelengths of the electromagnetic signals allow for small extensions of the components, i.e., waveguides and resonator structures.

In other words, a wavelength separation filter (WSF) device may be constructed from an input waveguide, parallel rings (resonator structures) and output waveguides, wherein one output waveguide may be associated with each ring. One or more, probably all, of the components, the waveguides and the rings may comprise the semiconductor material, which allows excitation and propagation of electromagnetic radiation. Characteristics of electromagnetic radiation may allow for very short waveguides and resonator structures with short circumferential pathways, for example, a couple of micrometers and/or a sub-micrometer-range. This may allow for ring resonators comprising a large free spectral range (FSR). A big separation between the resonance wavelengths (frequencies) in the ring may be achieved. For sufficiently small lengths of the circumferential pathway a wavelength range comprising essentially one frequency may be coupled out of a broadband signal, for example, as essentially only one frequency fulfills the resonant condition of the resonator structures. Thus, each resonator structure may deliver essentially only one wavelength at the output. The propagating electromagnetic field in the waveguides and in the resonator structure may be essentially or purely photonic in nature.

Although the photonic wavelength separation structure 80 is described as comprising three resonator structures 72a-c and three output waveguides 64a-c, other examples provide photonic wavelength separation structures comprising two, four or more than four resonator structures and output waveguides. Further embodiments provide a photonic wavelength separation structure configured for separating two, four or more than four wavelengths. For example, a photonic wavelength separation structure may comprise at least 1 and at most 1000 (or more) resonator structures and/or associated output waveguides, at least 2 and at most 500 resonator structures and/or associated output waveguides or may comprise at least 10 and at most 100 resonator structures and/or associated output waveguides. For example, a number of wavelengths to be separated (i.e., a number of separation structures and/or a number of output waveguides) may be influenced by a resolution of a manufacturing process for manufacturing the photonic wavelength separation structure. For example, a bandwidth of the first electromagnetic signal 66 may be separated (split) into a number of wavelengths, the number being influenced by a tolerance range of the manufacturing process. A decreasing tolerance range of the manufacturing process (e.g., 50 nm, 20 nm or 5 nm) may allow for an increasing number of wavelengths to be separated. The (structural) tolerance range may be considered by a secureness-bandwidth which may decrease for decreasing tolerance ranges. Currently, typically dimensions±tolerance ranges of a crystal structure obtained by a lithographic manufacturing processes may be, for example, approximately 450 nm±50 nm (i.e., a tolerance range of 50 nm) when using a G-line equipment of a lithography process, approximately 350 nm±30 nm (i.e., a tolerance range of 30 nm) when using a Mine equipment of a lithography process, approximately 150 nm±15 nm (i.e., a tolerance range of 15 nm) when using a deep ultra violet (DUV) equipment of a lithography process or approximately 100 nm±10 nm (i.e., a tolerance range of 10 nm) when using an electron beam (e-beam) lithography equipment.

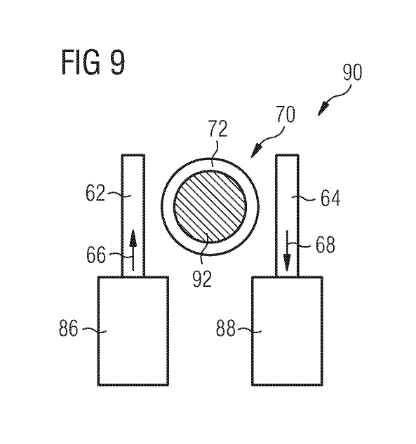

FIG. 9 shows a schematic block diagram of a photonic wavelength separation structure 90. The photonic wavelength separation structure 90 may comprise the photonic wavelength separation structure 70 and an electromagnetic signal source 86 configured to emit the first electromagnetic signal 66. The electromagnetic signal source 86 may comprise, for example, a light emitting diode (LED), a laser-LED, a photonic crystal and/or a thermal emitter as described with respect to FIGS. 10A and 10B. The electromagnetic signal source 86 may be coupled to the input waveguide 62.

The photonic wavelength separation structure 90 may comprise a receiver element 88. The receiver element 88 may be coupled to the output waveguide 64 and may be configured to receive the electromagnetic signal 68 from the output waveguide 64.

The electromagnetic signal source may be, for example, a light source configured to emit visible or invisible light. Invisible light may be, for example, an electromagnetic radiation in the ultraviolet and/or in the infrared spectrum.

The receiver element 88 may be configured to provide data or a signal based on the received electromagnetic signal 68. For example, the receiver element may comprise a photodiode or a thermal sensor such as a bolometer or a pyroelectric detector.

The silicon material of the input waveguide 62, the output waveguide 64 and the resonator structure 72 may be at least partially transparent for electromagnetic radiation in the infrared spectrum. Thus, emitting, coupling and receiving thermal (infrared) radiation may allow for handling electromagnetic signals with low losses and with high precision.

The ambient material 92 may be a fluid such as a liquid or a gas or a material of the fluid. For example, the ambient material 92 may be a substance of the air such as ozone, oxygen or carbon dioxide. Alternatively or in addition, the ambient material 92 may be a solid material that may be dispersed in the fluid such as fine dust or the like. The resonator structure may comprise a coating, for example, a hydrophobic coating which may allow for a fast removal of the ambient material 92 from the resonator structure 72 with a low amount of residues.

FIG. 10A shows a schematic cross sectional view of an input waveguide 94 and of an output waveguide 96. The input waveguide 94 may be, for example, the input waveguide 62. The output waveguide 96 may be, for example, the output waveguide 64. The input waveguide 94 may comprise a grating 98, for example, a rib or trench structure. The rib structure may be described as a varying thickness or a plurality of trenches along a first and/or second lateral direction perpendicular to a thickness direction 99 parallel to a surface normal 101 of a waveguide 94 or 96.

The electromagnetic signal 66 may be obtained, for example, by conversion of a thermal radiation 102 emitted by a thermal radiation source 104, for example, the electromagnetic signal source 86. I.e., the electromagnetic signal source 86 may comprise the thermal emitter 104. The grating structure 98 may allow for a conversion of the thermal radiation 102 into the electromagnetic signal 66.

The output waveguide 96 may comprise a grating structure 106 which is configured to convert the electromagnetic signal 68 into a thermal radiation 108 which may be received by a thermal receiver 112. The thermal receiver 112 may be, for example, a bolometer and/or a pyroelectric sensor. The grating structures 98 and 106 may also be referred to as a trench structure and may be obtained, for example, by generating a plurality of trenches into the input waveguide 94 or the output waveguide 96.

The thermal emitter 104 may be a separate element when compared to the input waveguide 94. Alternatively, the thermal emitter 104 may also be a part of the input waveguide 94. For example, the input waveguide 94 may comprise the semiconductor material such as a silicon material or a gallium arsenide material. The semiconductor material may comprise a doping at least at an (emitter) region of the input waveguide 94 such that the thermal radiation 102 may be generated when applying an electrical current to the doped region of the input waveguide 94. The doped silicon material may comprise a doping concentration of at least 5%, at least 10% or at least 15%. The doping concentration may be at most 50%, at most 40% or at most 30%.

Increasing the doping concentration may allow for a higher conductivity and/or for a more efficient generation of the thermal radiation.

The receiver element 88 may comprise the thermal detector 112. The output waveguide 64 may comprise the grating structure 106 (trench structure) configured for decoupling the electromagnetic signal 68 from the output waveguide 96 to obtain the second thermal radiation 108 which may be detected by the thermal detector 112.

Alternatively, the input waveguide 62 and/or the output waveguide 64 may be formed as a photonic crystal structure. For example, the photonic crystal structure may be formed as a multitude of pillar structures, e.g., obtained by an anisotropic etching process of a semiconductor substrate. The photonic crystal structure may be configured to guide the electromagnetic signals 66 and/or 68.

Photonic crystal structures may comprise a plurality of pillar structures which may be arranged at a substrate. The pillar structures may also be referred to as rods in empty space. Alternatively or in addition, a photonic crystal structure may comprise recesses formed into a substrate which may also be referred to as holes (recesses) in a slab (substrate).

The recesses or the pillars may comprise an extension parallel to a surface normal of the substrate which may be referred to as height or depth of the structure. Additionally the recesses or pillars may comprise a cross-sectional area perpendicular to the surface normal, the cross-sectional area comprising a first extension along a first lateral extension and a second extension along a second lateral direction. For example, the recesses or pillars may comprise a circular, elliptical or polygon-shaped cross-sectional area. An optical characteristic of a photonic crystal structure may be influenced by the cross-sectional area and/or by a distance between pillars or recesses.

FIG. 10B shows a schematic cross sectional view of the input waveguide 94 and of the output waveguide 96. When compared to FIG. 10A, the thermal emitter 104 and the thermal detector 112 may be arranged on a different side of the input waveguide 94 and of the output waveguide 96. By non-limiting example only, a configuration according to FIG. 10A may be referred to as the thermal emitter 104 and the thermal detector 112 being arranged on a (same) first side, e.g., a bottom side, a top side, or a lateral side. A configuration according to FIG. 10B may be referred to as the thermal emitter 104 and the thermal detector 112 being arranged at a (same) second side, e.g., the top side, the bottom side or a lateral side opposing the lateral side illustrated in FIG. 10A. According to further embodiments the thermal emitter 104 and the thermal detector 112 may be arranged on different sides such as a bottom side and a top side, a top side and a lateral side, a bottom side and a lateral side and/or at two different lateral sides.

FIG. 11 shows a schematic block diagram of a microlab system 110 comprising the photonic wavelength separation structure 90, a detector element 114 configured to detect a wavelength of the second electromagnetic signal 68. Alternatively, the detector may be configured to detect a wavelength derived from the electromagnetic signal 68, for example, when the receiving element 88 is configured to convert a wavelength of the electromagnetic signal 68 to a further wavelength. Alternatively, the receiving element 88 may comprise the detector 114, i.e., the receiving element 88 may be configured to receive the electromagnetic signal 68 and to detect the wavelength of the electromagnetic signal 68 or the wavelength derived thereof.

The microlab system 110 comprises a processor (read out electronics) 116 configured to determine a (physical) characteristic of the ambient material 92 based on the wavelength of the electromagnetic signal 68 or the wavelength derived thereof.

The resonator structure 72 may be configured to be connectable with the ambient material 92. The ambient material 92 may be connectable to the resonator structure at an inner region thereof, such as a region surrounded (enclosed) by the inner radius of the resonator structure 72. Alternatively or in addition, the ambient material 92 may be connectable to the resonator structure at the outer radius, for example, when the resonator structure 72 is formed as a disc. A wavelength of the electromagnetic signal 68 may be influenced based on an interaction between the portion of the electromagnetic signal 66 coupled to the resonator structure 72 and the ambient material 92. For example, a resonance frequency of the resonator structure 72 may be influenced (increased or decreased) based on the interaction such that a wavelength. Alternatively, an amplitude or a wavelength range of the electromagnetic signal 68 may be influenced (increased or decreased) by the contact between the resonator structure 72 and the ambient material 92. The signal source 86 may be configured to provide the electromagnetic signal 66 to the input waveguide 62.

The detector 114 may be configured to detect a wavelength of the electromagnetic signal 68 or a modification thereof when receiving the electromagnetic signal 68. For example, the detector 114 may be coupled to the output waveguide 64 and/or to the detector element 88 to receive the electromagnetic signal 68 or an information derived thereof.

The processor 116 may be connected to the detector 114 and may be configured to determine a characteristic of the ambient material 92 based on the modified wavelength, wavelength range or amplitude of the electromagnetic signal 68 or a wavelength derived thereof. A wavelength derived thereof may refer to a wavelength of a signal derived from the electromagnetic signal 68, for example, an electrical or optical signal into which the electromagnetic signal 68 is converted.

The microlab system 110 may be, for example, part of a mobile device such as a mobile scanner, a mobile phone or a vehicle. This may allow for detecting a characteristic (such as a presence, a concentration or the like) of the ambient material 92 with the mobile device.

Although the microlab system 110 is described as comprising the photonic wavelength separation structure 90, alternatively the photonic wavelength separation structure 70, 70′ or 80 may be arranged.

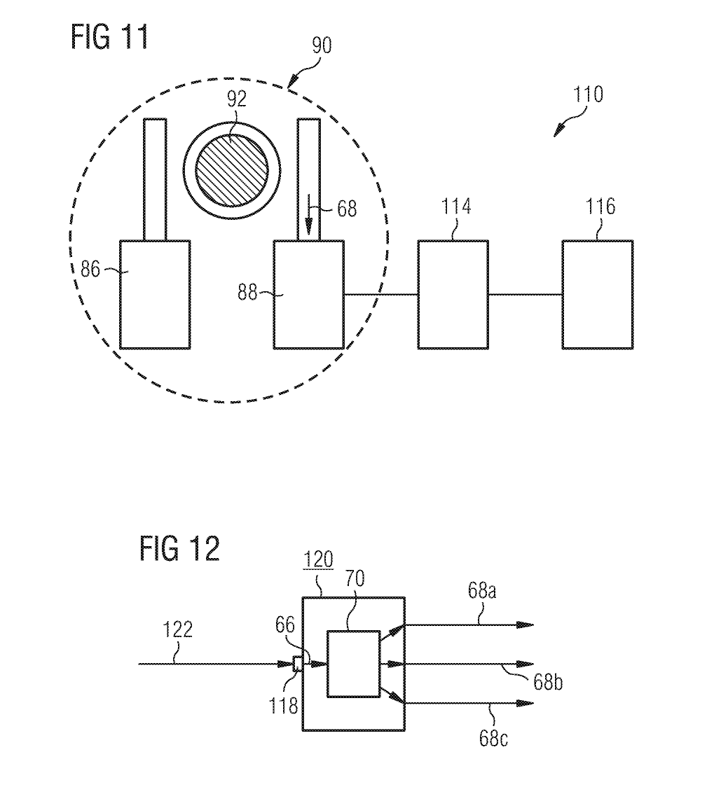

FIG. 12 shows a schematic block diagram of an optical receiver 120 comprising the photonic wavelength separation structure 70. The input waveguide of the photonic wavelength separation structure 70 is connected to an input 118 of the optical receiver 120. The input is configured to receive an optical communication signal 122. The optical communication signal 122 may be, for example, a broadband communication signal comprising a plurality of carrier signals, each carrier signal comprising a wavelength or wavelength region to be separated for further processing.

The input 118 may be configured to provide the electromagnetic signal 66 based on the optical communication signal 122. For example, the electromagnetic signal 66 may be the optical communication signal 122 or may be derived thereof, e.g., by a thermal emitter operated based on the optical communication signal 122. The optical receiver 120 is configured to provide the electromagnetic signals 68a-c. Alternatively, the optical receiver may be configured to provide an optical or electrical signal derived from the electromagnetic signals 68a-c.

Although the optical receiver 120 is described as comprising the photonic wavelength separation structure 80, alternatively the photonic wavelength separation structure 70, 70′ or 90 may be arranged.

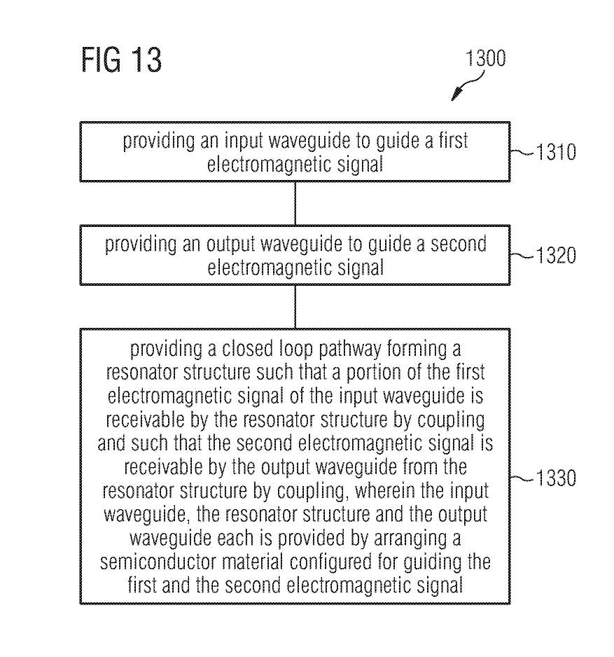

FIG. 13 illustrates a schematic flowchart of a method 1300 for manufacturing a photonic wavelength separation structure, for example, the photonic wavelength separation structure 70, 80 or 90.

The method 1300 comprises a step 1310 in which an input waveguide configured to guide a first electromagnetic signal.

A step 1320 of method 1300 comprises providing an output waveguide to guide a second electromagnetic signal.

A step 1330 of method 1300 comprises providing a closed loop pathway forming a resonator structure such that a portion of the first electromagnetic signal of the input waveguide is receivable by the resonator structure by coupling and such that the second electromagnetic signal is receivable by the output waveguide from the resonator structure by coupling. The input waveguide, the resonator structure and the output waveguide each is provided by arranging a semiconductor material configured for guiding the first and the second electromagnetic signal.

Providing the input waveguide, the output waveguide and/or the closed loop pathway may comprise forming the respective structure out of a semiconductor substrate or arranging the respective structure on the substrate.

In other words, a wavelength separation filter (WSF), i.e., a wavelength separation structure, may comprise components that are fabricated from silicon on a substrate and whose dielectric constants are lower than that of the silicon material. This may be, for example, a silicon waveguide on a silicon nitride substrate. The device may comprise an input waveguide, at least one ring or a plurality of parallel rings and output waveguides, one for each ring. All the components, the waveguides and the rings may be made of silicon. The propagating electromagnetic field in the waveguides and in the rings may be essentially all purely photonic in nature. Thus, the limitations related to the photonic nature of the propagating waves may allow for small radii or short circulatory pathways, for example, in a micrometer range.

Examples described hereinafter may refer to photonic wavelength separation structures comprising waveguides formed as photonic crystal structures. Photonic crystal structures may comprise a plurality of pillar structures which may be arranged at a substrate. The pillar structures may also be referred to as rods in empty space. Alternatively or in addition, a photonic crystal structure may comprise recesses formed into a substrate which may also be referred to as holes (recesses) in a slab (substrate).

The recesses or the pillars may comprise an extension parallel to a surface normal of the substrate which may be referred to as height or depth of the structure. Additionally the recesses or pillars may comprise a cross-sectional area perpendicular to the surface normal, the cross-sectional area comprising a first extension along a first lateral extension and a second extension along a second lateral direction. For example, the recesses or pillars may comprise a circular, elliptical or polygon-shaped cross-sectional area. An optical characteristic of a photonic crystal structure may be influenced by the cross-sectional area and/or by a distance between pillars or recesses.

Examples described hereinafter refer to pillars and/or recesses comprising a round shape and having a diameter. Other examples shall not be limited to round pillar structures or recesses as the explanations given hereinafter may be transferred without any limitation to according structures having elliptical or polygon-shaped cross-sectional areas. In addition, details set forth below referring to a pillar structure may be transferred without relevant limitations to a recess structure and vice versa.

The substrate may comprise, for example, a metal material and/or a semiconductor material such as a silicon material or a gallium arsenide material. Pillar structures or recesses may be obtained by anisotropic etching of the substrate such that a material of the substrate is removed between the pillar structures or such that recesses are formed into a surface of the substrate. Thus, the pillar structures may comprise a semiconductor material which may be equal to the semiconductor material of the substrate.

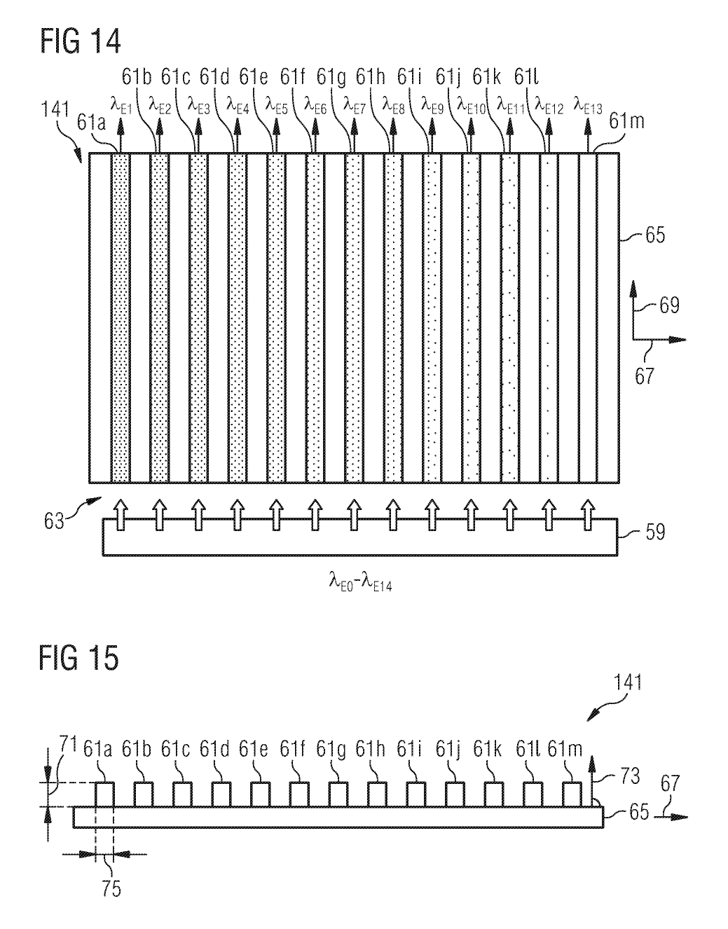

FIG. 14 shows a schematic top view of a photonic wavelength separation structure 141. The photonic wavelength separation structure 141 may comprise a plurality of semiconductor waveguides 61a to 61m. The semiconductor waveguides 61a to 61m may comprise a semiconductor material comprising a doping characteristic. The semiconductor waveguides 61a to 61m may comprise a doping characteristic differing from each other. The semiconductor waveguides 61a to 61m may comprise different refractive indices ηᵢ based on the different doping characteristics.

Thus, based on a different doping characteristic, the semiconductor waveguides 61a to 61m may comprise a different refractive index which may allow for guiding different wavelengths of a received broadband electromagnetic signal 63, for example, a broadband light signal generated by a source 59. Based on guiding different wavelengths or wavelength regions a filter characteristic may be obtained by the semiconductor waveguides 61a to 61m by damping or suppressing wavelength regions not guided or supported by the respective semiconductor waveguide 61a to 61m. The semiconductor waveguides 61a to 61m may thus allow for filtering the broadband electromagnetic signal 63 with different filter characteristics. For example, the different refractive indices may allow for different upper wavelengths of wavelength regions guided by the semiconductor waveguides 61a to 61m. In the following, wavelengths λ_{E0} to λ_{E14} are described as comprising an increasing wavelength, the wavelength increasing corresponding to the increasing indices. Thus, a wavelength λ_{E2} may be larger than a wavelength λ_{E1} and may be smaller than a wavelength λ_{E3}. The wavelength regions may be arranged, for example, in the infrared range, i.e., in a region between 0.01 μm and 10 μm, between 0.1 μm and 8 μm or between 0.5 μm and 6 μm, but may also be arranged in other wavelength regions.

The wavelengths λ_{E1} to λ_{E13} may be understood as upper frequencies of frequency ranges guided by the respective waveguide 61a to 61m. Thus, for example, the semiconductor waveguide 61a may guide a wavelength range being between λ_{E0} and λ_{E1}. The semiconductor waveguide 61m may guide, for example, a wavelength range being between λ_{E0} and λ_{E13}. Although relating to wavelengths λ_{E0} to λ_{E14}, the descriptions provided herein are not limited to a respective specific wavelength. Each of the wavelengths may be understood as comprising a wavelength region or a plurality of wavelengths, for example, in a range between ±15%, ±10% or ±5% of the respective wavelength λ_{E0} to λ_{E13}.

The doping characteristic of a waveguide 61a to 61m may be based on at least one of a different semiconductor material for the semiconductor waveguides, different doping materials for doping the semiconductor material of these semiconductor waveguides and a different doping concentration of the doping material for the semiconductor waveguides. For example, a semiconductor material of a first semiconductor waveguide 61a to 61m may comprise a silicon material, wherein a different semiconductor waveguide may comprise a different semiconductor material such as gallium arsenide (GaAs), germanium or hybrid materials such as lithium-barium-hybrid. An implemented doping concentration may comprise any value. According to an example, the doping concentration may be in a range between 10¹³ and 20²² cm⁻³, between 10¹⁴ and 20²¹ cm⁻³ or between 10¹⁵ and 20²⁰ cm⁻³.

According to another example, a first semiconductor waveguide of the plurality of semiconductor waveguides 61a to 61m may comprise a first doping material such as boron, wherein a second semiconductor waveguide 61a to 61m may comprise a different doping material such as phosphorous or the like. According to other examples, different semiconductor waveguides may comprise different doping materials for doping the semiconductor material of the semiconductor waveguide, for example, indium, aluminum, gallium, arsenic or the like and/or a combination thereof. According to another example, the different semiconductor waveguides 61a to 61m may comprise different doping concentrations of a common doping material, i.e., the dopant. For example, the doping concentration may vary between each of the semiconductor waveguides 61a to 61m, for example, monotonically.

According to an example, the semiconductor waveguides 61a to 61m may be arranged adjacent to each other on a substrate 65. The semiconductor waveguides 61a to 61m may be arranged adjacent to each other along a disposal direction 67 which may be perpendicular to an axial extension of the semiconductor waveguides 61a to 61m along a guiding direction 69 along which the semiconductor waveguides 61a to 61m are configured to guide a portion of the broadband electromagnetic signal 63. A refractive index of the substrate 65 may be less than a refractive index of one of the semiconductor waveguides 61a to 61m, of a plurality thereof, or of each of the semiconductor waveguides 61a to 61m. For example, silicon (semiconductor waveguides 61a to 61m) on a Se₃N₄ substrate, silicon on a SiOₓ substrate or germanium on a silicon substrate or the like may allow for such a characteristic.

The examples of differing with respect to the semiconductor materials, to the doping materials and/or to the doping concentrations may be realized individually to obtain different refractive indices between the semiconductor waveguide 61a to 61m. According to other examples, at least two of the principles may be realized together, i.e., in combination with each other. According to another example, all of the three principles may be realized in combination with each other.

In the following, the semiconductor waveguides 61a to 61m are described as comprising a different doping concentration. For example, the doping concentration may increase along a direction opposite to the disposal direction 67. Thus, the semiconductor waveguide 61a may comprise a higher doping concentration when compared to the semiconductor waveguides 61b to 61m. The semiconductor waveguide 61b may accordingly comprise a doping concentration being higher when compared to a doping concentration of the semiconductor waveguides 61c to 61m and so on.

The semiconductor waveguides 61a to 61m may receive the broadband electromagnetic signal 63 comprising wavelengths of a range between a lowest wavelength region λ_{E0} and a highest wavelength region λ_{E14}. Based on the filtering, each of the semiconductor waveguides 61a to 61m may be configured to guide a different wavelength range when compared to each other, wherein the wavelength ranges may overlap partially, e.g., when comprising a common lowest wavelength. Based on the different refractive indices, for example, the semiconductor waveguide 61a may be configured to guide a wavelength range between the wavelength λ_{E0} and the wavelength λ_{E1}.

The semiconductor waveguide 61b may be configured to guide a wavelength range of the electromagnetic broadband signal 63, being between the wavelength λ_{E0} and the wavelength λ_{E2}. Thus, the different doping concentration and the different refractive indices obtained thereby may be used as filters with an upper wavelength λ_{E1} to λ_{E13} decreasing with an increase of the doping concentration. Based on the correlation λ_{E}=c/f between a wavelength λ_{E} and a corresponding frequency f with c being the speed of light in the material, the decrease in the upper wavelength λ_{E1} to λ_{E13} may also be understood as a high-pass filter comprising a varying and increasing cut-off frequency of the filter characteristic, a varying lower frequency limit respectively. By non-limiting example, a doping concentration for doping of silicon (Si) by n-type or p-type dopants (B, Sb, P etc.) may vary in the range from 10¹³ to 20²² cm⁻³, in the range from 10¹⁴ to 20²¹ cm⁻³ or in the range from 10¹⁵ to 20²⁰ cm⁻³. In this case, Si may be the waveguiding layer, into which the waveguide structures are formed or etched. The refractive index η of Si for such dopings may change in the range approximately from η=2.7 to η=3.7, from η=2.6 to η=3.6 or from η=2.5 to η=3.5. The waveguiding layer can be also Ge, silicon nitride, Al₂O₃ etc. and may be selected based on the spectral range of application.

Alternatively to the doping, an alloying may be used. That is, the waveguiding layer may be fabricated as an alloy. One example is Si₁₋ₓGeₓ. Here, x may vary as 0<x<1. For example, in the following situation: If x=0, then the alloy may be simply Si and the refractive index may be on the order of η˜3.4, i.e., η=3.4±0.2, η=3.4±0.1 or η=3.4±0.05 for intrinsic Si at wavelength λ_{E}=5.5 λm within a tolerance range of less than 10%, less than 5% or less than 1%. If x=1, then the alloy may be simply Ge and the refractive index may be on the order of η˜4.2 i.e., η=4.2±0.2, η=4.2±0.1 or η=4.2±0.05 for intrinsic Ge at wavelength λ_{E}=5.5 μm within the tolerance range. The variable x may be varied between 0 and 1 (e.g. implantation of Ge into Si layer or vice versa) allowing for a change in the refractive index of the waveguiding layer in the range 3.6≤η≤4.4, in the range 3.5≤η≤4.3 or in the range 3.4≤η≤4.2 at λ_{E}=5.5 μm with the tolerance range. Other alloys can be also used as waveguiding layers, for example, probably Ge₁₋ₓSbₓ, Si₁₋ₓCₓ, Si₁₋ₓAlₓ or the like.

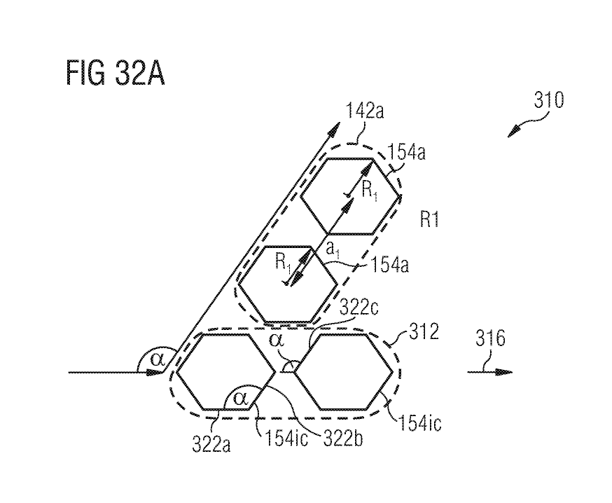

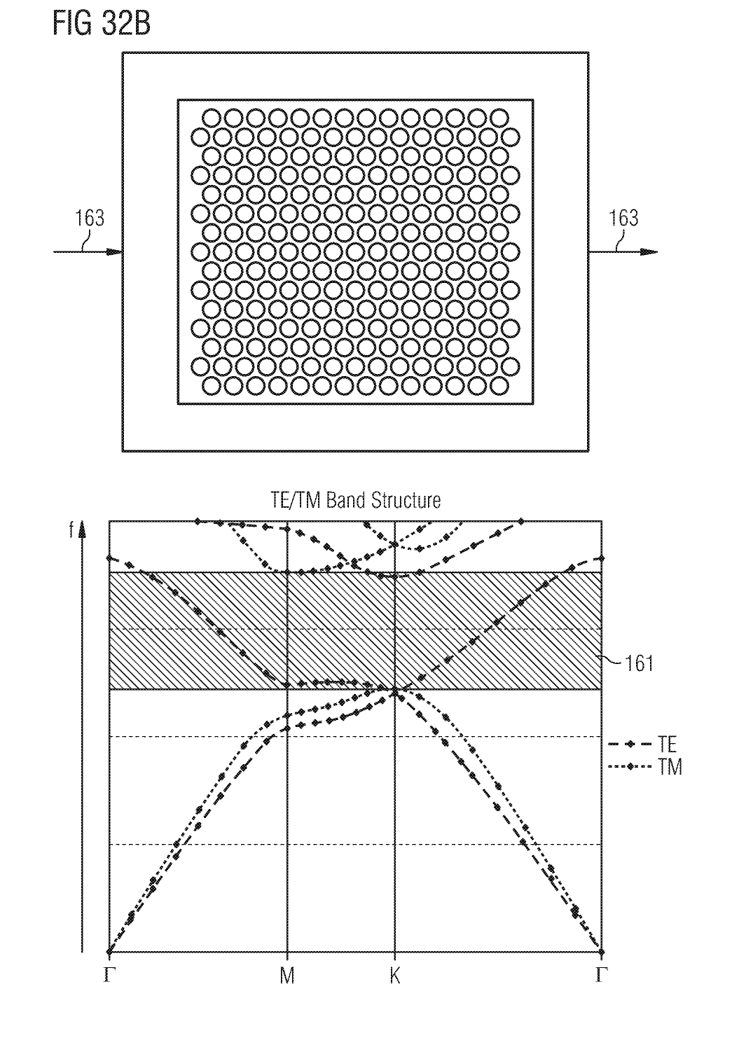

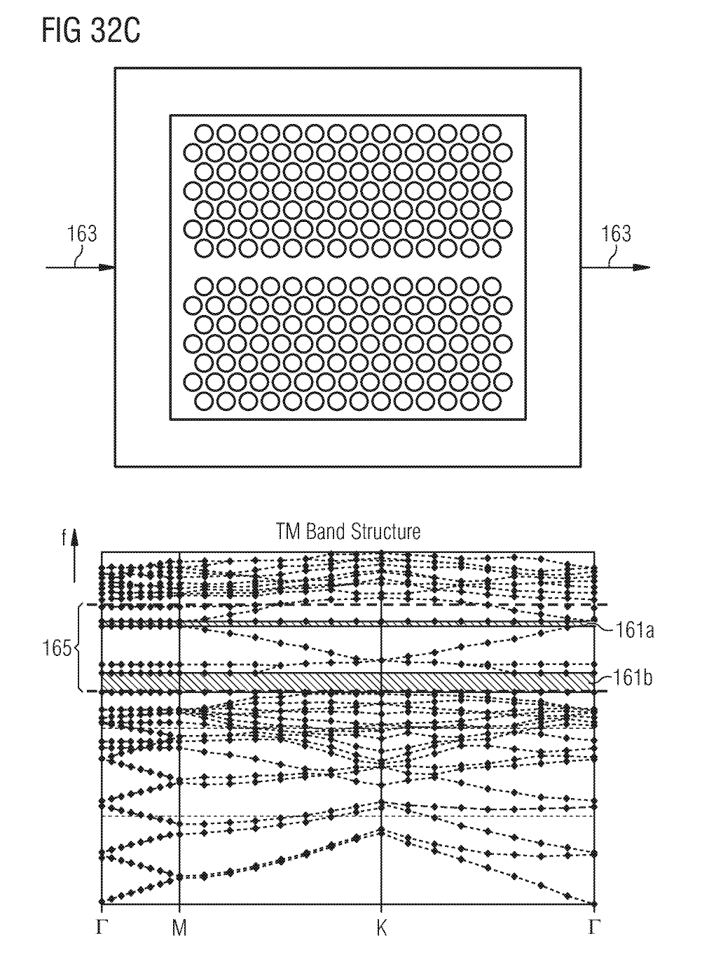

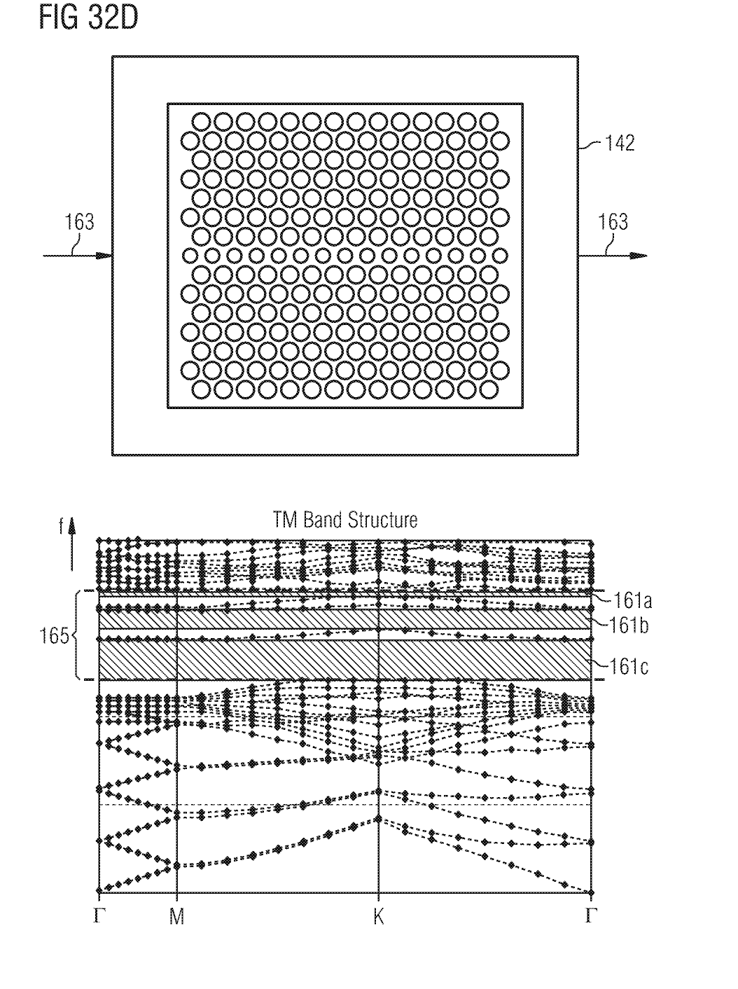

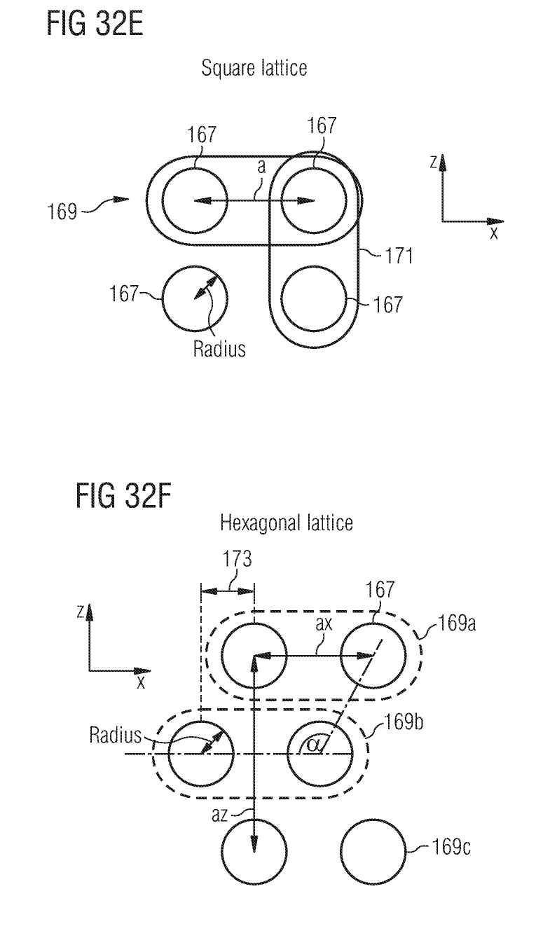

Thus, the increase in the doping concentration may allow for an increase in the refractive index and may thus allow for a varying filter property of the semiconductor waveguides 61a to 61m. Explanations referring to a relationship between the refractive index and the guided wavelengths are provided with reference to FIGS. 32B to 32D.

Although being described as comprising a high-pass characteristic, the different doping may be to obtain a different characteristic, such as a low-pass characteristic or a band-pass characteristic. The photonic wavelength separations structure may be used, for example, as a filter arrangement for filtering different wavelength ranges.

FIG. 15 shows a schematic side view of the photonic wavelength separation structure 141. At least one of the semiconductor waveguides 61a to 61m may be formed as an elevation on the substrate 65. An extension 71 of the elevation along a direction parallel to a surface normal 73 of the substrate 65 may be, for example, at least 100 nm and at most 100 μm, at least 200 nm and at most 800 nm or at least 500 nm and at most 700 nm, for example, 600 nm. The extension 71 may be referred as a “height” of the semiconductor waveguide, wherein the term height shall not comprise any limiting effect, but may be used for a better understanding. An extension 75 along a direction perpendicular to the surface normal 73 and parallel to the disposal direction 67 may be referred to as a width of the semiconductor waveguide, without a limiting effect of the word “width”. The width may be, for example, at least 50 nm and at most 20 μm, at least 500 nm and at most 10 μm or at least 70 nm and at most 2 μm, for example 100 nm. In particular, the width may be adapted to be in accordance with requirements for guiding signals in an infrared wavelength range.

An extension of the waveguides 61a to 61m along an axial extension, simply referred to as a “length”, may be, for example, perpendicular to the surface normal 73 and perpendicular to the disposal direction 67, e.g., parallel to the guiding direction 69. The length may be at least 5 μm and at most 10 cm, at least 50 μm and at most 1 cm or at least 100 μm and at most 1 cm, for example 200 μm.

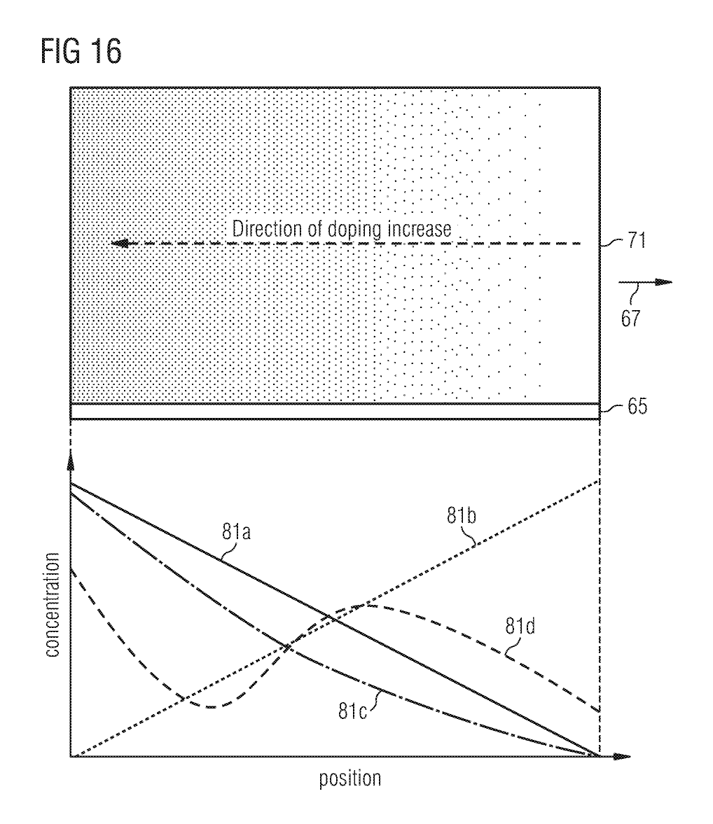

FIG. 16 shows a schematic side view of a doped semiconductor material 77 arranged on the substrate 65. The substrate 65 may comprise, for example, a dielectric or an insulating material such as silicon oxide or silicon nitride.

The semiconductor material 77 may comprise a doping concentration which increases along a direction being opposite to the disposal direction 67. As indicated by a graph 81a, the doping concentration may increase linearly and monotonically along the direction opposite to the disposal direction. According to other examples and indicated by the graphs 81b to 81d, the doping concentration may increase linearly and monotonically along the disposal direction 67 as indicated by the graph 81b, may decrease nonlinearly and monotonically along the disposal direction 67 as indicated by the graph 81c and/or may vary, i.e. increase and/or decrease, non-monotonically along the disposal direction 67 as indicated by the graph 81d. The illustrated semiconductor material may be a starting or intermediate product for manufacturing the photonic wavelength separation structure 141. For example, by removing portions of the semiconductor material, the semiconductor waveguides 61a to 61m may be obtained.

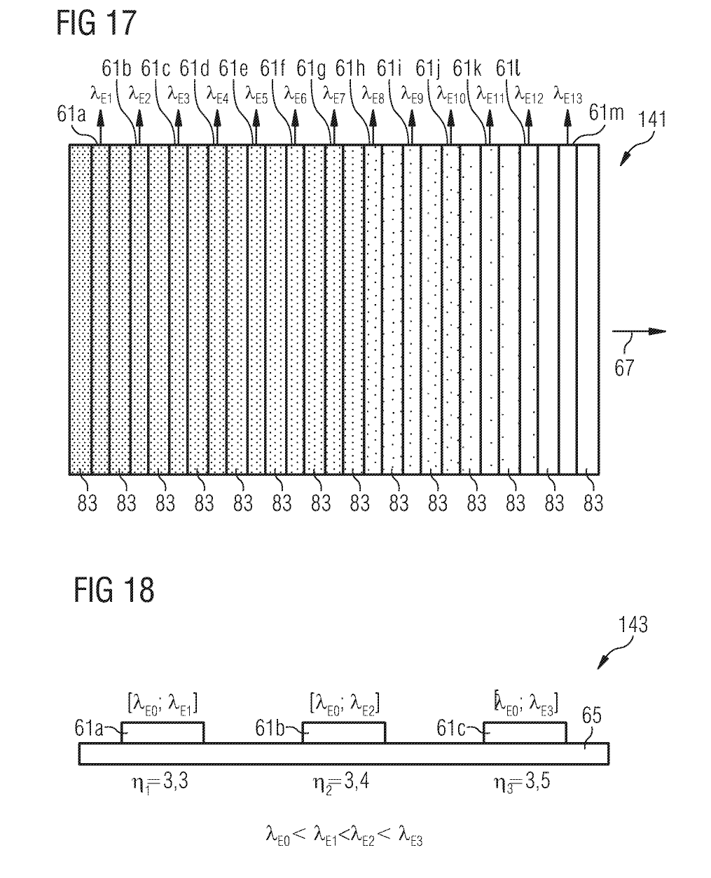

FIG. 17 shows a schematic top view of the photonic wavelength separation structure 141 which may be obtained, for example, when forming the semiconductor waveguides 61a to 61m out of the semiconductor material 77 by removing the semiconductor material 77 in intermediate regions 83 between the waveguides 61a to 61m. This may lead, for example, to the semiconductor waveguides 61a to 61m being formed as elevations as illustrated in connection with FIG. 15. Removal of the semiconductor material may be obtained, for example, by etching or photolithography or other concepts for removing the semiconductor material.

In other words, the wavelength separation structure, i.e. the wavelength separation filter, may be formed by developing semiconductor waveguides with different refractive indices on the same chip. This may be achieved with a semiconductor wafer comprising, for example, silicon or germanium device layers on a substrate with refractive indices less than that of the semiconductor material. The device layer may then be doped gradiently or gradually through the surface, for example, along a horizontal direction or the disposal direction 67. The doping may allow for changing the refractive index of the device layer, i.e. the semiconductor material. After that, a single-mode waveguide may be fabricated, for example, via photolithography. Thus, each waveguide may be made of a material with a different refractive index ηᵢ. Since each waveguide may comprise a different refractive index, each waveguide may support one individual mode of a received broadband light. Therefore, each semiconductor waveguide may support a different frequency, i.e. wavelength.

Although FIGS. 14 to 17 are described with respect to a plurality of semiconductor waveguides 61a to 61m, other photonic wavelength separation structures according to examples described herein may comprise a different number of semiconductor waveguides, for example, at least two, at least three, at least four or a number between 2 and 100, between 3 and 50 or between 4 and 30.

When referring again to FIGS. 16 and 17 in connection with FIG. 14, the varying doping concentration illustrated in FIGS. 16 and 17 may lead to a varying doping concentration within one single semiconductor waveguide 61a to 61m along the disposal direction 67. Based on the extensions of the semiconductor waveguide along the disposal direction 67, the different refractive indices may be referred to as effective refractive indices resulting from a variation of the doping concentration and/or the doping characteristic within the waveguide.

When compared to the variation of the doping characteristic between two different or two adjacent semiconductor waveguides 61a to 61m, a variation within the semiconductor waveguide may be lower and may therefore lead to minor variations in the refractive index. Thus, a first and a second semiconductor waveguide comprising a first and a second, different doping characteristic may comprise different resulting doping densities or doping concentrations, each resulting doping density leading to an effective doping of a semiconductor waveguide being different from an adjacent or different semiconductor waveguide. Thus, the semiconductor waveguide 61a to 61m may comprise a different doping characteristic each.

As described with respect to FIGS. 14 to 17, each of the semiconductor waveguides 61a to 61m may be configured to guide a wavelength range being different from other semiconductor waveguides 61a to 61m with respect to an upper or lower wavelength range. As described above, for example, the semiconductor waveguide 61a may be configured to guide an electromagnetic signal comprising a wavelength in a range between λ_{E0} and λ_{E1}, wherein the semiconductor waveguide 61m may be configured to guide an electromagnetic signal comprising wavelengths in a range between λ_{E0} and λ_{E13}, wherein λ_{E0}<λ_{E1}<λ_{E13}. The output signals of the semiconductor waveguides may be separated and/or distinguished from each other based on the different wavelength range.

FIG. 18 shows a schematic side view of a photonic wavelength separation structure 133 comprising by non-limiting example three semiconductor waveguides 61a to 61c arranged on the substrate 65. The semiconductor waveguide 61a may comprise a first refractive index η₁ being by non-limiting example 3.3. The waveguide 61b may comprise, by non-limiting example, a refractive index η₂ being 3.4, wherein the semiconductor waveguide 61c may comprise, by non-limiting example only, a refractive index η₃ being 3.5. According to other examples, the semiconductor waveguides 61a to 61c may comprise other refractive indices being different from each other. Thus, the refractive indices may increase or decrease along the disposal direction based on the doping characteristic.

Based on the different refractive indices η₁ to η₃ the semiconductor waveguide 61a may be configured to guide an electromagnetic signal comprising wavelengths in a range between λ_{E0} and λ_{E1}. The semiconductor waveguide 61b may be configured to guide an electromagnetic signal comprising wavelengths in a range between λ_{E0} and λ_{E2}. The semiconductor waveguide 61c may be configured to guide an electromagnetic signal comprising wavelengths in a range between λ_{E0} and λ_{E3}, wherein λ_{E0}<λ_{E1}<λ_{E2}<λ_{E3}.

To extract or filter a single wavelength or at least a reduced wavelength range from the semiconductor waveguides 61a to 61c, a wavelength selection element may be arranged so as to interact with at least one of the semiconductor waveguides. The wavelength selection element may be configured to change an amplitude of a wavelength portion of the electromagnetic signal at an output side of the semiconductor waveguide. Thus, between an input side of the waveguide and an output side of the waveguide the amplitude of the wavelength portion may be changed or modulated, such that a changed or modulated wavelength portion is obtained at the output side of the semiconductor waveguide.

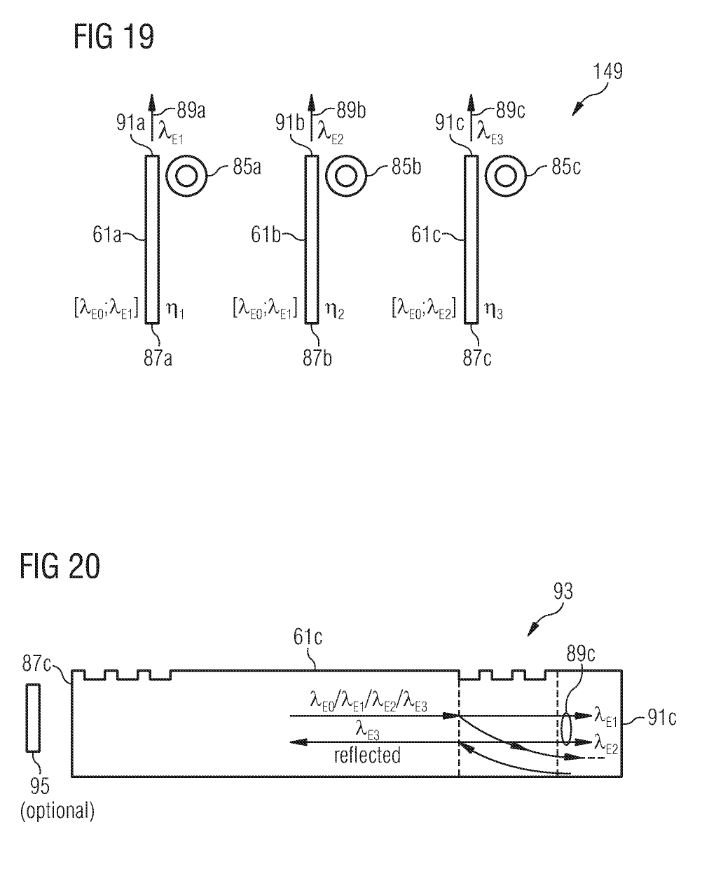

FIG. 19 shows a schematic top view of a photonic wavelength separation structure 149 comprising the semiconductor waveguides 61a to 61c as described with respect to FIG. 18. Adjacent to the semiconductor waveguide 61a a resonator structure 85a may be arranged. The resonator structure 85a may be a wavelength selection element as described above.

Adjacent to the semiconductor waveguide 61b a resonator structure 85b may be arranged. Adjacent to the semiconductor waveguide 61c a resonator structure 85c may be arranged. The resonator structures 85a-c may be formed each as a ring resonators, as disc resonators and/or as photonic crystal structure. The length of the circulatory pathway or outer circumference of the resonator structure may be, for example, shorter than or equal to 300 μm, 200 μm or 100 μm.

Each of the semiconductor waveguides 61a to 61c is configured to receive an electromagnetic signal at an input side 87a to 87c and to output a filtered electromagnetic signal 89a to 89c at an output side 91a to 91c of the semiconductor waveguides 61a to 61c. Although being illustrated as being arranged adjacent to the output side 91a, 91b, 91c, respectively, each of the resonator structures 85a to 85c may be arranged anywhere along an actual extension of the semiconductor waveguides 61a to 61c.

Each of the resonator structures 85a to 85c is configured to receive a wavelength portion from the respective semiconductor waveguide 61a to 61c. As described with respect to FIGS. 7A, 7B, 8 and 9, this may comprise an adaption with respect to a distance between the respective waveguide and the respective resonator structure and/or a variation in an outer circumference and/or a radius of the respective resonator structure.

When compared to FIGS. 7A, 7B, 8 and 9 the resonator structures 85a to 85c are each arranged adjacent to one waveguide, wherein previously described embodiments relate to a resonator structure being arranged between two waveguides. Although comprising a different arrangement, the functionality of the resonator structures 85a to 85c may be comparable. The resonator structure 85a may be configured, for example, to receive a wavelength portion comprising essentially one wavelength, for example, the wavelength λ_{E1}. The wavelength portion shall be understood as being narrow when compared to the wavelength range reaching from λ_{E0} to λ_{E1}. Although reference is made to the resonator structures and/or the wavelength separation element so as to provide or damp (eliminate) one wavelength, this can be also understood as relating to a narrow wavelength range. The wavelength portion may comprise, for example, an interval of less than or equal±15%, ±10% or ±5% around the respective wavelength to be separated λ_{E1}, λ_{E2} or λ_{E3}. In simple terms, it can be a single wavelength e.g. λ_{E1}, but it can be also a narrow interval around λ_{E1} e.g. [λ_{E1}−5%, λ_{E1}+5%].

The resonator structure 85a may be configured to receive the wavelength portion comprising the wavelength λ_{E1} by coupling and to provide a respective signal to the semiconductor waveguide 61a by coupling. This may be understood as parallel coupling. Thus, by coupling out of the semiconductor waveguide 61a and into the semiconductor waveguide 61a, the resonator structure 85a may be configured to modify an amplitude of the wavelength portion comprising the wavelength λ_{E1}. Modification of the amplitude of the wavelength portion may be obtained, for example, by using a constructive or a destructive resonance, interference or superposition by the coupling. This may also be understood as amplitude modulation of the wavelength portion in the output signal 91a. For example, the amplitude of the wavelength portion comprising the wavelength λ_{E1} may be increased which may allow for a filtering or an extraction of the respective wavelength range. Alternatively, the amplitude may be decreased such that a gap in the wavelengths may be detected.

Accordingly, the resonator structure 85b may be configured to receive a different wavelength portion, for example, comprising the wavelength λ_{E2} and the resonator structure 85c may be configured to receive a different wavelength portion, for example, comprising the wavelength λ_{E3}.

The resonator structure 85a, 85b and/or 85c may be connectable to an ambient material as described with respect to FIG. 9. Based on an interaction between the respective resonator structure 85a-c and the ambient material, a resonance frequency of the resonator structure 85a-c may change.

Although being illustrated as comprising one wavelength separation element for each waveguide, according to other examples, a lower number of wavelength separation elements may be arranged. According to other examples, also a higher number may be arranged, wherein a lower number of wavelength selection elements may allow for a low complexity and a low amount of cost when manufacturing the photonic wavelength separation structure 149. For separating a specific number of wavelengths, a corresponding number of wavelength selection elements reduced by one may be sufficient. For example, when the broadband electromagnetic light 63 provided by a source 59 comprises a respective wavelength range, for example, λ_{E1} to λ_{E14}, a lowest or highest wavelength range guided by the plurality of waveguides may be sufficiently separated or at least identified or processed from the other wavelengths without a wavelength selection element. For example, when the broadband electromagnetic light comprises a lower limit of wavelengths being in the region of λ_{E1}, then an extraction of λ_{E1} out of the respective signal guided by the waveguide 61a by use of a wavelength selection element may be unnecessary.

FIG. 20 illustrates an example comprising the semiconductor waveguide 61c and a wavelength separation element being implemented as a grating resonator 93. The grating resonator 93 may be arranged at the semiconductor waveguide 61c or may be integrated into the semiconductor waveguide 61c and is configured for reflecting the wavelength portion λ_{E3} such that the amplitude of the wavelength portion λ_{E3} is reduced at the output side 91a. A detector 95 may be arranged adjacent to the waveguide 61a, e.g., at the input side 87a and may be configured for receiving a reflected portion comprising the wavelength portion λ_{E3}. As illustrated in FIG. 20, the electromagnetic signal 89c may comprise the wavelength λE1 and the wavelength λ_{E2}. Additionally, the electromagnetic signal 89c may comprise the wavelength λ_{E3} but at least with a reduced amplitude when compared to an electromagnetic signal provided to the semiconductor waveguide 61c at the input side 87c. Thus, the reduced amplitude of the wavelength λ_{E3} may be detected at the output side 91c. The extracted wavelength λ₃ may be detected by the detector 95.

A wavelength to be reflected by the grating resonator 93 may be adjusted by the grating structure, i.e. a periodicity of trenches formed into the waveguide 61c. This may comprise a number of structures, a distance between structures, an extension of the structures and the like. An increased number of structures may allow for an increased reduction of the respective wavelength and therefore for an increased signal to noise ratio of the signal at the output side 91c. Thus, by adapting the structures of the grating resonator 93, an adaption to other wavelengths corresponding to other semiconductor waveguides and/or other wavelengths may be obtained.

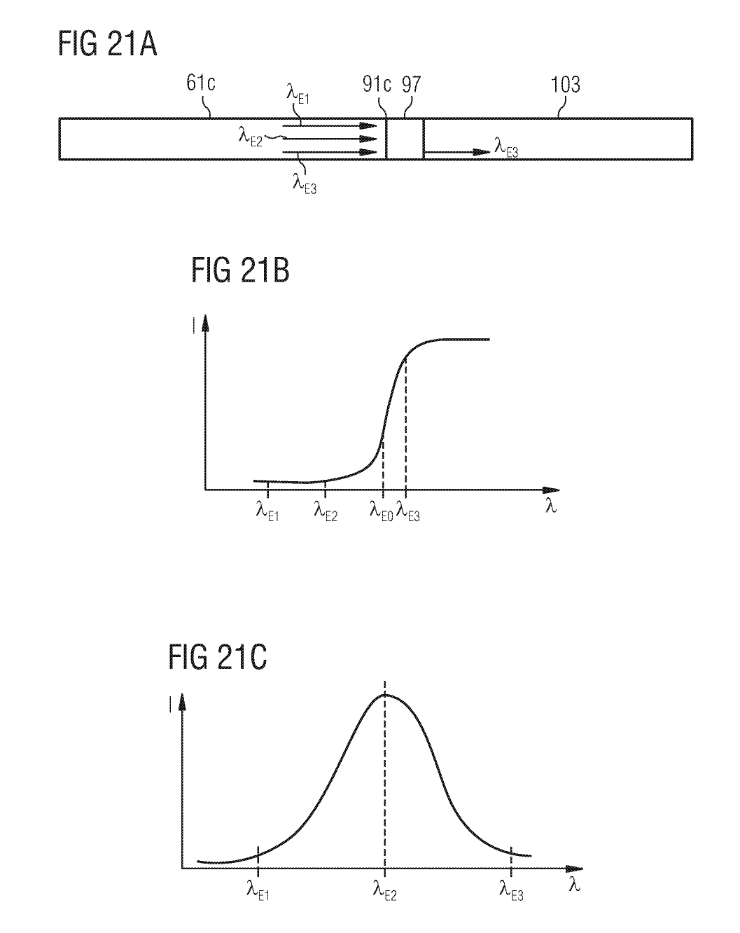

FIG. 21A illustrates a schematic top view of the semiconductor waveguide 61c comprising a wavelength selection element formed as wavelength filter 97. The wavelength filter 97 may be arranged at the output side 91c of the semiconductor waveguide 61c and between the semiconductor waveguide 61c and a further semiconductor waveguide 103. According to other examples, the semiconductor waveguide 103 is part of the semiconductor waveguide 61c, i.e. the wavelength filter 97 may be integrated into the semiconductor waveguide 61c. The wavelength filter 97 is configured to filter the wavelength portion, i.e. to reduce an amplitude of wavelength portions being different from the wavelength portion, such as the wavelength portion λ_{E3}.

The wavelength filter 97 may comprise, for example, a different refractive index when compared to the semiconductor material of the semiconductor waveguide 61c. This may allow for a first change of the refractive index between the semiconductor waveguide 61c and the wavelength filter 97. A second change may occur between the wavelength filter 97 and the semiconductor waveguide 103. That is, the wavelength filter 97 may be integrated into a course of the semiconductor waveguide 61c.

The first change of the refractive index may be obtained based on at least one of different materials of the second semiconductor waveguide and the wavelength filter, different doping materials for doping the semiconductor material of the second semiconductor waveguide and the wavelength filter, different doping concentrations of the doping material for doping the semiconductor waveguide and the wavelength filter and a structure of the wavelength filter being different from a structure of the semiconductor waveguide.

For example, the wavelength filter 97 may comprise one of a silicon dioxide material, a silicon nitride material or a fluid, liquid or gas, so as to provide a material being different from a material of the semiconductor waveguide. When referring to the option of using different doping materials or different doping concentrations, similar effects may be obtained when compared to different doping materials or different doping concentrations or different materials when compared to the different doping concentrations outlined with respect to FIG. 14. The filter may be implemented as a portion comprising a recess configured to be connectable with an ambient material. This may allow for different ambient materials to be present at the recess so as to obtain different refractive indices and thereby different filter characteristics of the wavelength filter. This may allow for determining a characteristic or type of the ambient material by evaluating the received light as described with respect to microlab systems described herein.

The wavelength filter may be configured to operate as one of a high-pass filter, a band-pass filter and a band-elimination filter. Based on the changes in the refractive index between the semiconductor waveguide 61c, the wavelength filter 97 and the semiconductor waveguide 103 two edges of a filter characteristic may be adjustable.

FIG. 21B illustrates a filter characteristic of the wavelength filter 97 being implemented as a high-pass filter. Thus, a transfer function I is increased above a cut-off wavelength λ_{Eco}. This may allow for a guiding the wavelength λ_{E3} while suppressing other wavelengths such as the wavelength λ_{E1} and/or λ_{E2}. The cut-off wavelength λ_{Eco} may be any of the wavelengths and is not limited to be a range between the wavelengths λ_{E2} and λ_{E3}.

FIG. 21C illustrates the wavelength filter 93 being implemented as a band-pass filter. This may allow for guiding the wavelength λ_{E2} while suppressing other wavelengths λ_{E1} and/or λ_{E3}.

Other filters may comprise other filter characteristics such as a low-pass filter with respect to the wavelength. Although being described as only guiding one wavelength portion, other filters may be configured to guide more than one wavelength portion, for example, wavelengths λ_{E1} and λ_{E2}, or λ_{E2} and λ_{E3} or other wavelengths.

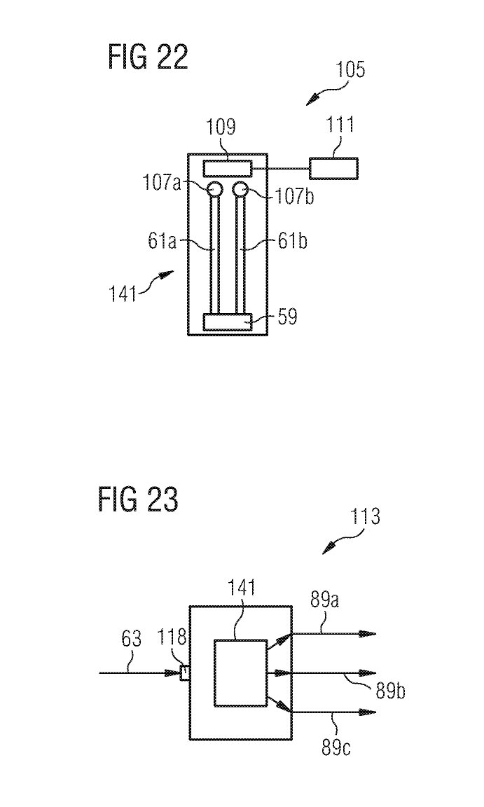

FIG. 22 shows a schematic block diagram of a microlab system 105 comprising the photonic wavelength separation structure 141, wherein adjacent to integrated into each of the waveguides 61a to 61e a wavelength separation element 107a to 107e is arranged. According to other examples, a wavelength selection element 107a, 107b, 107c, 107d or 107e is arranged adjacent to or integrated into at least one of the semiconductor waveguides 61a to 61e.

The wavelength selection elements 107a to 107e may be connectable to an ambient material as described with respect to FIG. 9 or 21a. The wavelength selection elements 107a to 107e may be implemented, for example, as resonator structures 85, grating structures 93 and/or wavelength filters 97. For example, the grating structure may be connectable to the ambient material so as to influence the wavelength portion being reflected. When implementing the wavelength selection element 107a, 107b, 107c, 107d or 107e as wavelength filter 97, for example, the ambient material may be arranged or positioned between the semiconductor waveguides 61c and the element 103.

A detector element 109 may be configured to detect a wavelength of the electromagnetic signals of the waveguide 61a and/or 61b and/or a waveguide portion comprising a reduced amplitude when compared to the corresponding amplitude at the input side. Alternatively, the detector 109 may be configured to detect a wavelength derived from the respective electromagnetic signal, as described with respect to FIG. 11. The microlab system 105 may comprise a processor 111 (readout electronics) configured to determine a (physical) characteristic of the ambient material based on the wavelength of the electromagnetic signals of the waveguides 61a and/or 61b or the wavelength derived thereof.

The signal source 59 may be configured to provide an electromagnetic signal to the semiconductor waveguide 61b and/or the semiconductor waveguide 61a, for example, the electromagnetic broadband signal 63. According to other examples, the microlab system 105 may comprise the photonic wavelength separation structure 141, 143 or 149.

FIG. 23 shows a schematic block diagram of an optical receiver 113 comprising the photonic wavelength separation structure 141. The broadband electromagnetic signal 63 may be received via the input 118 of the optical receiver 113. Alternatively, a broadband communication signal may be received, comprising a plurality of carrier signals, each carrier signal comprising a wavelength or wavelength region to be separated for further processing. The input 118 may be configured to provide the broadband electromagnetic signal 63 based on the signal provided by the source 59.

The optical receiver 113 may be configured to provide at least portions of the broadband electromagnetic signal (optical communication signal) to the semiconductor waveguides so as to obtain output signals 89a to 89c when wavelength separation elements are arranged as described with respect to FIGS. 19, 20 and 21. Alternatively, the unmodulated output signals may be obtained from the semiconductor waveguides.

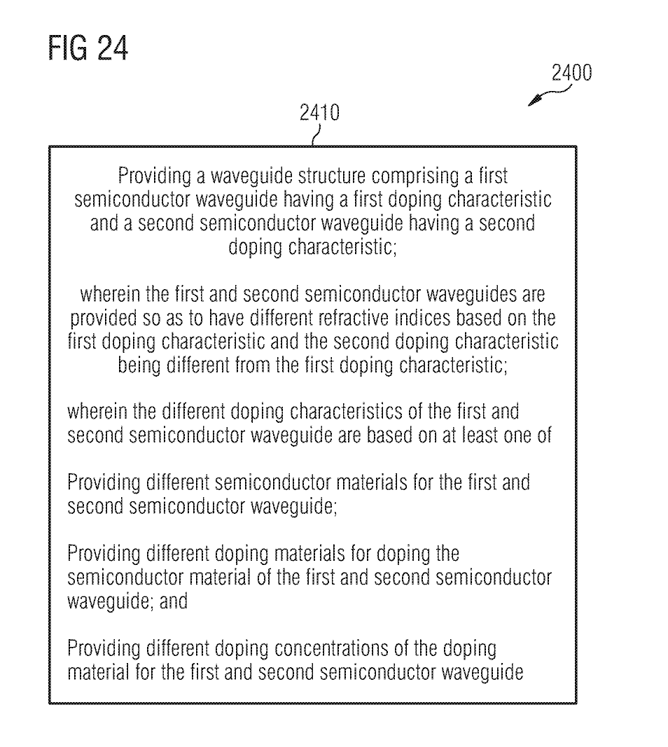

FIG. 24 illustrates a schematic flowchart of a method 2400 for manufacturing a photonic wavelength separation structure, for example the photonic wavelength separation structure 141, 143 or 149.

The method 2400 comprises a step 2410 in which a waveguide structure having a first doping characteristic and a second semiconductor waveguide having a second doping characteristic is provided. The first and second semiconductor waveguides are provided so as to have different refractive indices based on the first doping characteristic and the second doping characteristic being different from the first doping characteristic. The different doping characteristics of the first and second semiconductor waveguides are based on at least one of providing different semiconductor materials for the first and second semiconductor waveguide, providing different doping materials for doping the semiconductor material of the first and second semiconductor waveguide and providing different doping concentrations of the doping material for the first and second semiconductor waveguide.

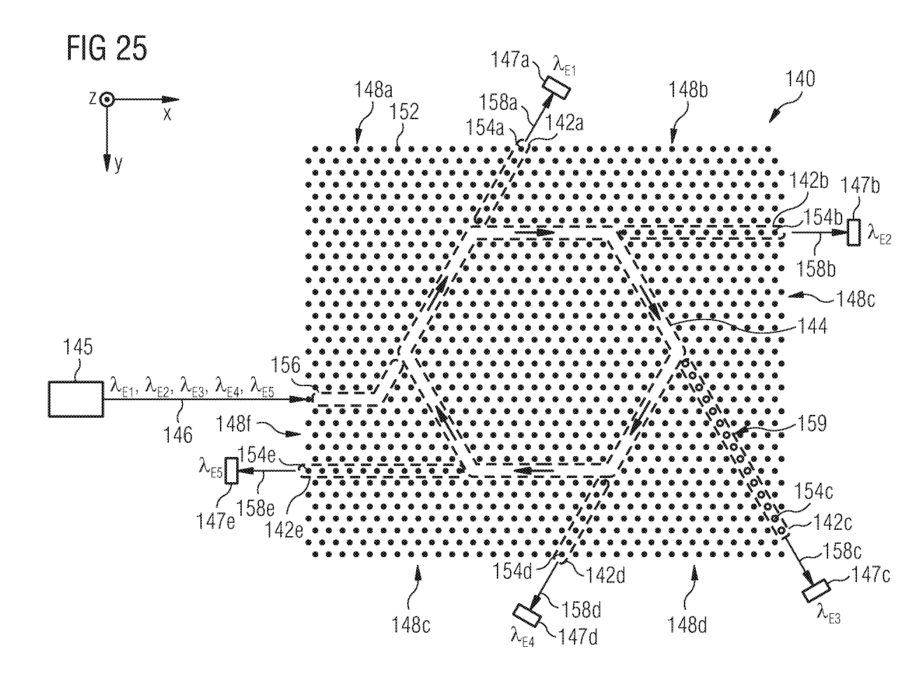

FIG. 25 shows a schematic top view of a photonic wavelength separation structure 140. The photonic wavelength separation structure 140 may comprise a plurality of output waveguides 142a-e. Each output waveguide 142a-e may be configured to guide an electromagnetic output signal comprising wavelengths λ_{E1}-λ_{E5}. The photonic wavelength separation structure 140 may comprise a circulatory pathway 144 configured to receive and to guide an electromagnetic input signal 146. The electromagnetic input signal may be, for example, a broadband signal and may comprise, for example, the wavelengths or wavelength ranges comprising the wavelengths λ_{E1}-λ_{E5}.

The output waveguides 142a-e are interconnected to each other by the circulatory pathway 144. Each of the output waveguides 142a-e is configured to receive a portion of the electromagnetic input signal 146, wherein the portion received or coupled out by the output waveguide 142a-e comprises the associated wavelengths λ_{E1}-λ_{E5}.

Regions 148a-f of the photonic wavelength separation structure 140 which are configured to be at least partially opaque for the electromagnetic input signal 146 may be formed by a solid material. For example, the solid material may be a substrate material. Alternatively, the regions 148a-f may be formed at least partially as photonic crystal structures 152 a photonic crystal structure, e.g., pillars or recesses with an appropriate cross-sectional area. With respect to those pillars 152 or recesses the output waveguides 142a-e may comprise pillars 154a-f or recesses comprising cross-sectional areas being different from those of the regions 148a-f and different from each other. Such pillars 154 a-e or recesses may be referred to as defect structures with respect to the pillars (or recesses) 152. For example, a diameter of pillars 154a may be essentially equal to the wavelength divided by an integer, e.g., λ_{E1}/1, λ_{E1}/2 or λ_{E1}/4. Pillars 154b of the output waveguide 142b may comprise a diameter which may correspond essentially to the wavelength λ_{E2}/divided by an integer. Accordingly, defect structures 154c-e may form the output waveguides 142c-e.

An association of the wavelength λ_{E1}-λ_{E5} to the respective output waveguide 142a-e may be obtained by forming the defect structures 154a-e. The photonic wavelength separation structure 140 may comprise an input waveguide 156 configured for guiding the electromagnetic input signal 146 to the circulatory pathway 144. Simplified, the electromagnetic output signals 158a-e may be coupled out of the light traveling through the circulatory pathway 144, wherein the light traveling through the circulatory pathway 144 may be supplied or provided by the electromagnetic input signal 146.

Although the photonic wavelength separation structure 140 is illustrated as comprising five output waveguides, other examples may provide a photonic wavelength separation structure comprising two, three or four output waveguides. Other examples provide photonic wavelength separation structures comprising more than five output waveguides, for example, more than seven, more than ten or more than 40, e.g., at least 50.

The input waveguide 156 and the circulatory pathway 144 may be formed so as to obtain a low damping of the electromagnetic input signal 146. For example, the input waveguide 156 and/or the circulatory pathway 144 may be formed at least partially or even completely transparent at least for the wavelengths to be coupled out by the output waveguides 142a-e. For example, the input waveguide 156 and/or the circulatory pathway 144 may be formed without recesses or pillars (e.g., an empty space or solid material) such that a free space is obtained in which the electromagnetic input signal 146 may propagate.

A length of the circulatory pathway may be a multiple of one or more wavelengths λ_{E1}-λ_{E5}. The circulatory pathway 144 may be configured for a resonance magnification of the electromagnetic signal traveling through the circulatory pathway with respect to the wavelengths λ_{E1}-λ_{E5} for which the length of the circulatory pathway 144 is a multitude. Some examples may provide a circulatory pathway comprising a length being a multiple of all of the wavelengths to be comprised by the output signals. The length of the circulatory pathway 144 may be a multiple of the wavelengths λ_{E1}-λ_{E5} within a tolerance range. The tolerance range may be less than or equal to 10%, 5% or 2%. Simplified, the circulatory pathway may allow for a functionality according to a resonator ring.

The photonic wavelength separation structure 140 may comprise an extension along a lateral extension x and along a lateral extension y, wherein the input waveguide 156, the output waveguides 142a-e and the circulatory pathway 144 may extend in the x/y-plane. A z-direction perpendicular to the x-direction and the y-direction may be referred to as a thickness direction of the photonic wavelength separation structure. An extension of the photonic wavelength separation structure including or excluding the substrate may be less than or equal to 2000 nm, less than or equal to 1500 nm or less than or equal to 1000 nm, for example in a range between 500 and 1000 nm such as 600 nm.

The photonic wavelength separation structure may comprise an electromagnetic signal source 145 configured to emit the electromagnetic input signal 146. The electromagnetic signal source 145 may comprise, for example, a light emitting diode (LED), a laser-LED, a photonic crystal and/or a thermal emitter as described with respect to FIGS. 10A and 10B. The electromagnetic signal source 145 may be positioned in the center of the circulatory pathway and/or the photonic wavelength separation structure 140. The electromagnetic signal source 145 may be, for example, a transmitter of an optical communication signal. Alternatively, the electromagnetic signal source 145 may be, for example, an interface for receiving a broadband electromagnetic signal comprising a plurality of wavelengths to be separated. The signal source 145 may alternatively comprise a heater such as a doped silicon and/or quantum dots for providing the input signal 146.

The photonic wavelength separation structure 140 may comprise a plurality of receiver elements configured to receive one of the electromagnetic output signals 158a-e from one of the output waveguides 142a-e. For example, the receiver elements 147a-e may be an interface for transmitting or forwarding the separated output signal 158a-e to another apparatus. Alternatively or in addition, the receiver element 147a-e may be, for example, an input interface of an apparatus for processing the electromagnetic output signal 158a-e.

The electromagnetic input signal 146 may be, for example, an optical communication signal received from an optical transmitter. The photonic wavelength separation structure 140 may be configured to separate different communication channels transmitted at different wavelengths comprising wavelengths λ_{E1}-λ_{E5}. The electromagnetic input signal may comprise one or more further wavelengths. Thus, the photonic wavelength separation structure 140 may be referred to as a wavelength separation filter.

One or more of the output waveguides 142a-e may comprise a resonance structure 159, for example, the output waveguide 142c. For example, one or more output waveguides 142a-e may comprise defect structures 154a-e formed as pillars. The resonance structure 159 may be, for example, an empty space or a missing (not arranged) pillar structure along a pathway of the respective output waveguide 142a-e. Alternatively, one or more output waveguides 142a-c may comprise defect structures 154a-e formed as recesses. The resonance structure 159 may be, for example, an empty space or a missing (not arranged) recess (arranged substrate) along the pathway of the respective output waveguide 142a-e. The resonance structure 159 may be understood as cavity in a substrate of the photonic wavelength separation structure 140.

The resonance structure 159 may allow for a resonance magnification or resonance rise of a wavelength or wavelength range associated to the respective output waveguide 142a-e. Alternatively or in addition, the resonance structure 159 may allow for a filtering of frequencies or wavelengths different from the wavelength or wavelength range associated to the respective output waveguide 142a-e. The filtering may allow for a high signal quality of the electromagnetic output signals 158a-e.

In other words, the wavelength separation effect may be achieved in photonic crystal structures of the type shown. For example, the input waveguide may deliver broadband light into the photonic crystal (PhC) ring resonator (circulatory pathway). The output waveguides may be designed so that each waveguide may pick up only one wavelength (range) of light circulating in the PhC ring. This may be achieved, for example, by placing linear defects with a radius and periodicity, differing in each waveguide. The linear defect may contain a cavity (recess) as well. The radius, i.e., the lateral extension, the periodicity and the cavity may determine, which frequency (wavelength) is supported in the waveguide and transmitted through it.

The PhC ring resonator may support frequencies according to a wavelength λ_{E1}-λ_{E5}. The input light from a broadband source may enter the PhC ring through the input waveguide. The output waveguides may deliver only the output frequency depending on the design of the linear defect inside the waveguide. For obtaining further frequencies of the broadband light, further photonic wavelength separation structures configured for extracting other wavelengths or other wavelength ranges may be arranged. Alternatively, further output waveguides may be arranged.

Further embodiments may provide photonic wavelength separation structures comprising a different number of output waveguides. The electromagnetic input signal 146 may comprise a plurality of wavelengths or wavelength regions. For example, the electromagnetic input signal 146 may comprise a (total) bandwidth according to an input wavelength range of the electromagnetic input signal 146. The input wavelength range may be, for example, between 10 nm and 200 μm, between 100 nm and 100 μm or between 1 μm and 10 μm, each interval including the described minimum and maximum values. The input wavelength range may comprise a plurality of wavelength ranges which may be separated from each other or may be arranged adjacent to each other. A wavelength range or a bandwidth of one or more electromagnetic output signals 158a-e may be influenced by a tolerance range of a manufacturing process for manufacturing the photonic wavelength separation structure 140. The tolerance range of the manufacturing process may refer to an accuracy of the structure, such as an extension of pillars and/or recesses, a distance between pillars and/or recesses or the like.

For example, a tolerance range of approximately 5 nm may allow for separating a wavelength range of the electromagnetic input signal 146 being between 1 μm and 10 μm into a number of output wavelengths being higher than 1000. The photonic wavelength separation structure may comprise more than 100, more than 500 or more than 1000 output waveguides and/or may be configured for separating more than 100, more than 500 or more than 1000 wavelengths or wavelength ranges. Simplified a high homogeneity of the manufactured structure may allow for a high number of output waveguides.

FIG. 15 shows a schematic top view of a photonic wavelength separation structure 150 which may comprise output waveguides 142a-f formed curvy linear. The curvy linear shapes of the output waveguides 142a-f may be obtained, for example, by arranging the structures (pillars or recesses) of the photonic crystal structure in circles which may be concentric. Adjacent circles may be rotated against each other by an angle α, i.e., by rotating the structures and therefore the defect structures of the output waveguides 142a-f. An increasing rotation of the defect structures with increasing distance (radius) from the center of the (concentric) circles may be obtained. The curvy linear shape may allow for a large length of the waveguides 142a-f and/or for increasing a number of wavelength 142a-f when compared to the number of waveguides of the separating structure 140.

The angle α may vary with increasing distance. The radius of the disc, i.e., the innermost part of the structure, the center, the circulatory pathway where the source is placed, may be chosen so that it supports certain wavelengths. This may be achieved by choosing the length of the circulatory pathway as described above.

The input waveguide 156 may comprise a corner or edge structure 162 to influence a direction of the electromagnetic input signal 146. The direction may be influenced or changed in in a manner such that a direction of propagation is modified by an angle between 0° and 180°, between 20° and 160° or between 40° and 120°. For example, and without limitation the direction may be changed from a counter-clockwise direction to a clockwise direction such that the light input may travel along a similar direction in the circulatory pathway 144 when compared to a direction along with the circles of the photonic crystal structure is shifted. The length of the circulatory pathway 144 may be, for example, equal to a circumference of an inner space of the photonic wavelength separation structure. The inner space may be transparent for the input waveguide 146.

The defect structures of the output waveguides 142a-f may comprise an extension (for example a diameter or a radius) associated with the wavelength λ_{E1}-λ_{E6} as indicated by R₁-R₆.

In other words, a PhC ring resonator may comprise a curvy linear PhC structure. The inner disc, where the source is positioned, may support a certain resonant frequencies. The output waveguides may allow for one frequency to exit through the corresponding waveguide depending on the design of the defect inside the waveguide. In one example, inside the waveguide, a defect of radius Rᵢ is placed, which may determine the transmitted frequency through the waveguide.

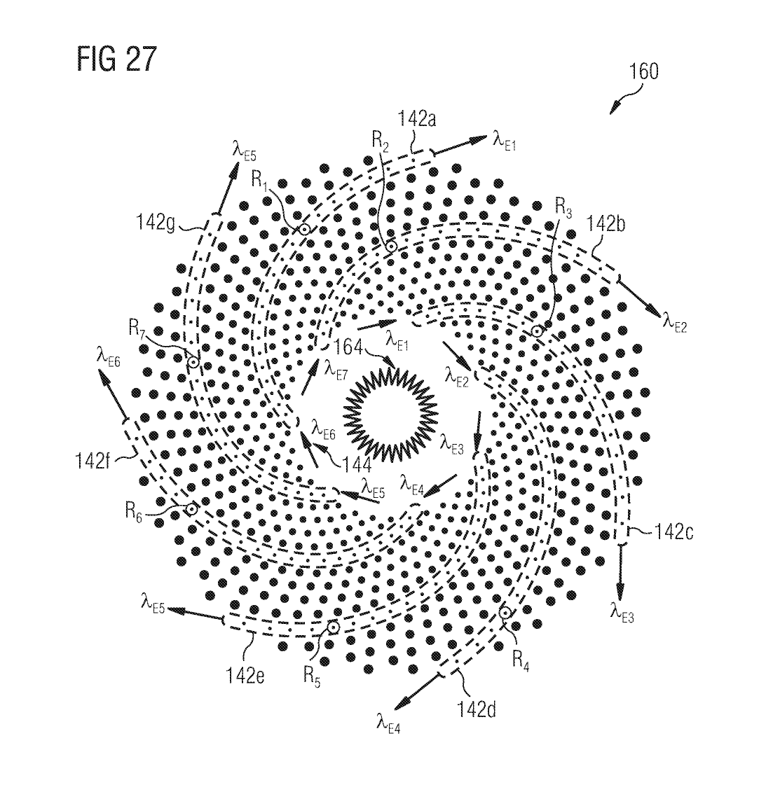

FIG. 27 shows a schematic top view of a photonic wavelength separation structure 160 comprising curvy linear shaped output waveguides 142a-g. When compared to the photonic wavelength separation structure 150, the photonic wavelength separation structure 160 may comprise an electromagnetic signal source 164. The electromagnetic signal source 164 may be configured to emit the electromagnetic input signal comprising the wavelength λ_{E1}-λ_{E7}. The electromagnetic signal source 164 may be surrounded by the circulatory pathway 144 such that the electromagnetic input signal is receivable by the circulatory pathway 144.

Space used for the input waveguide 156 for the photonic wavelength separation structure 150 may be used as a further output waveguide, i.e., a higher number of wavelengths λ_{E1}-λ_{E7} may be separated by the structure.

In other words, the PhC ring resonator may be designed as a curvy linear structure. The source of the electromagnetic signal may be placed inside the structure. Such a structure may be formed either as “hole in a slab” or “rods in empty space”. The structure may be fabricated by organizing the hose (rods) in concentric circles but shifting the odd and even circles to each other by a rotational law, i.e., by the angle α. The disc may act as resonator. The output waveguides may be designed with a curvy linear defect so that only one frequency (wavelength), arranged comprising the wavelengths respectively, may propagate through a waveguide and exits the disc resonator. Thus, each waveguide may appear as an output for one wavelength (range).

The number of outputs may be related to a number of waveguides. To increase the number of output frequencies (wavelengths) the number of waveguides may be increased while keeping a distance between waveguides to avoid crosstalk between the frequencies at different waveguides. This may be achieved by increasing the radius of the central disc and the number of holes (rods) per circle.

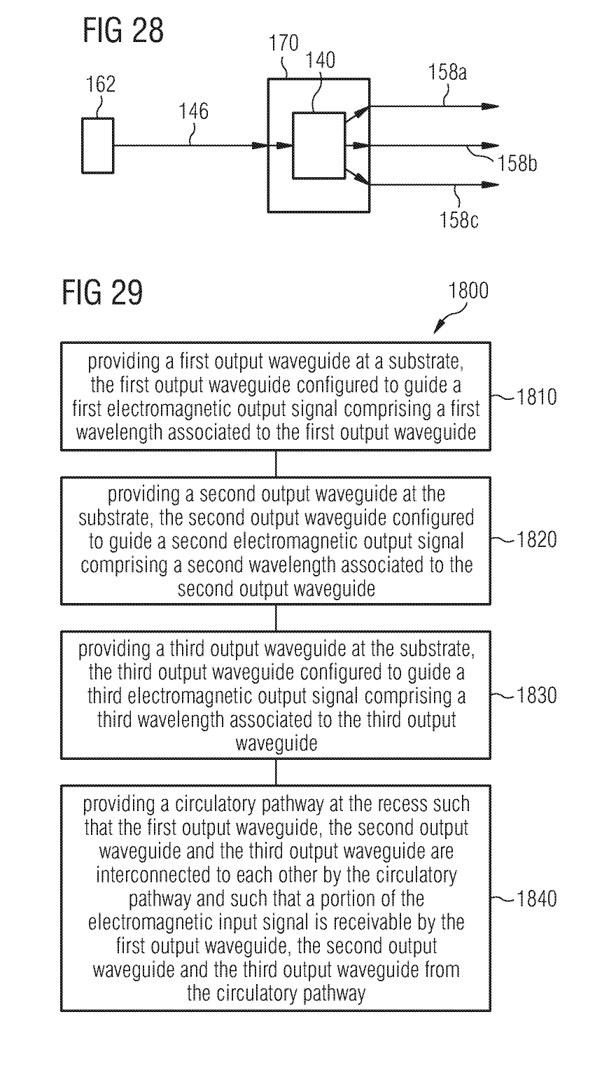

FIG. 28 shows a schematic block diagram of an optical receiver 170 comprising the photonic wavelength separation structure 140. The optical receiver 170 is configured to receive the electromagnetic input signal 146 which may be, for example, an optical communication signal. The optical communication signal 146 may be received, for example, from an optical transmitter 162.

Although the optical receiver 170 is described as comprising the photonic wavelength separation structure 140, alternatively or in addition the photonic wavelength separation structure 150 or 160 may be arranged.

FIG. 29 illustrates a schematic flowchart of a method 1800 for manufacturing a photonic wavelength separation structure, for example the photonic wavelength separation structure 140, 150 and/or 160.

The method 1800 comprises a step 1810 comprising providing a first output waveguide at a substrate, the first output waveguide configured to guide a first electromagnetic output signal comprising a first wavelength associated with the first output waveguide.

A step 1820 of method 1800 comprises providing a second output waveguide at the substrate, the second output waveguide configured to guide a second electromagnetic output signal comprising a second wavelength associated with the second output waveguide.

A step 1830 of method 1800 comprises providing a third output waveguide at the substrate, the third output waveguide configured to guide a third electromagnetic output signal comprising a third wavelength associated with the third output waveguide.

A step 1840 of method 1800 comprises providing a circulatory pathway at the recess such that the first output waveguide, the second output waveguide and the third output waveguide are interconnected to each other by the circulatory pathway and such that a portion of the electromagnetic input signal is receivable by the first output waveguide, the second output waveguide and the third output waveguide from the circulatory pathway.

Other examples provide a method comprising a step in which a substrate is provided. The substrate may be, for example, a semiconductor substrate. The semiconductor may comprise a silicon material and/or a gallium arsenide material.

Methods according to examples may comprise a step in which an anisotropic etching process is performed to generate a plurality of pillar structures as a remaining portion of the etching process. A first portion of the pillar structures comprises a first lateral extension, wherein a second portion of the pillar structures may comprise a second lateral extension. A third portion of the pillar structures may comprise a third lateral extension. A fourth portion of the pillar structures may comprise a fourth lateral extension. Simplified, pillar structures comprising four different kinds of lateral extensions such as a diameter or a cross-sectional area may be obtained.

Alternatively, the anisotropic etching process may be performed to generate a plurality of recesses into the substrate material. Thus, instead of forming pillar structures out of a surface of the substrate material, recesses may form into the surface of the substrate material such that four kinds of recesses comprising four different lateral extensions may be obtained.

The first portion of the pillar structures or of the recesses may form the first output waveguide. The second portion of the pillar structures or of the recesses may form the second output waveguide. The third portion of the pillar structures or of the recesses may form the third output waveguide. The fourth portion of the pillar structures or of the recesses may be generated between the output waveguides to form an opaque structure. Thus, the fourth portion of pillar structures or recesses may also be formed as a solid block, i.e., the pillar structures or recesses of the fourth kind may comprise a lateral extension such that they mash into each other.

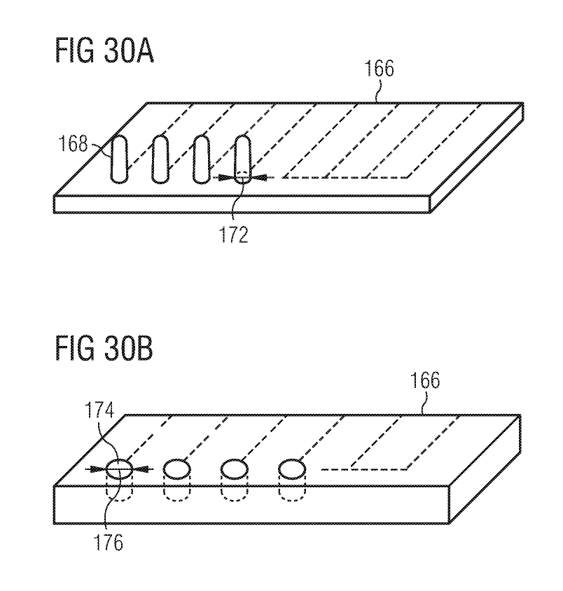

FIG. 30A shows a schematic perspective view of a substrate 166 on which pillar structures 168 are formed, for example, by performing the anisotropic etching process described above. A lateral extension 172 may correspond to a diameter or an extension of the pillar structures 168 parallel to a surface of the substrate 166 on which the pillar structures 168 are formed.

FIG. 30B shows a schematic perspective view of the substrate 166 into which recesses are formed, for example, by forming the above described anisotropic etching process. A lateral extension 176 of the recesses 174 may correspond to a diameter or another extension of the recesses 174 parallel to or in the surface of the substrate 106 into which the recesses 174 are formed.

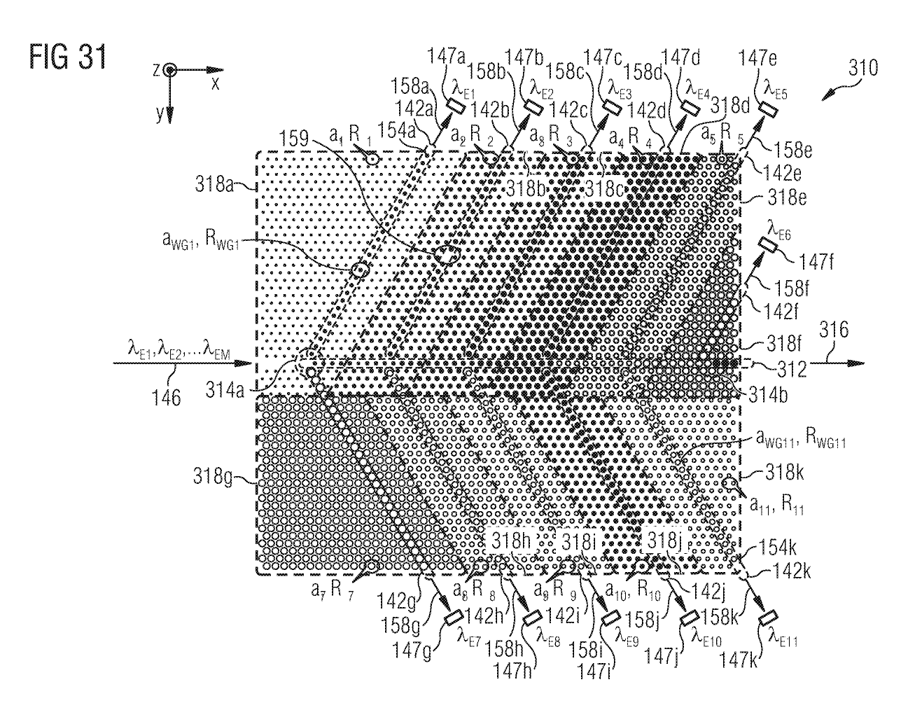

FIG. 31 shows a schematic top view of a photonic wavelength separation structure 310 comprising a photonic crystal structure. The photonic wavelength separation structure comprises an interconnecting waveguide 312 configured to define a main propagation path for a broadband electromagnetic signal, for example, the electromagnetic input signal 146. The photonic wavelength separation structure 310 may comprise a plurality of output waveguides 142a to 142k. Although being illustrated as comprising eleven output waveguides 142a-142k, the photonic wavelength separation structure 310 may comprise a different number of output waveguides, for example, at least two, at least five or at least seven.

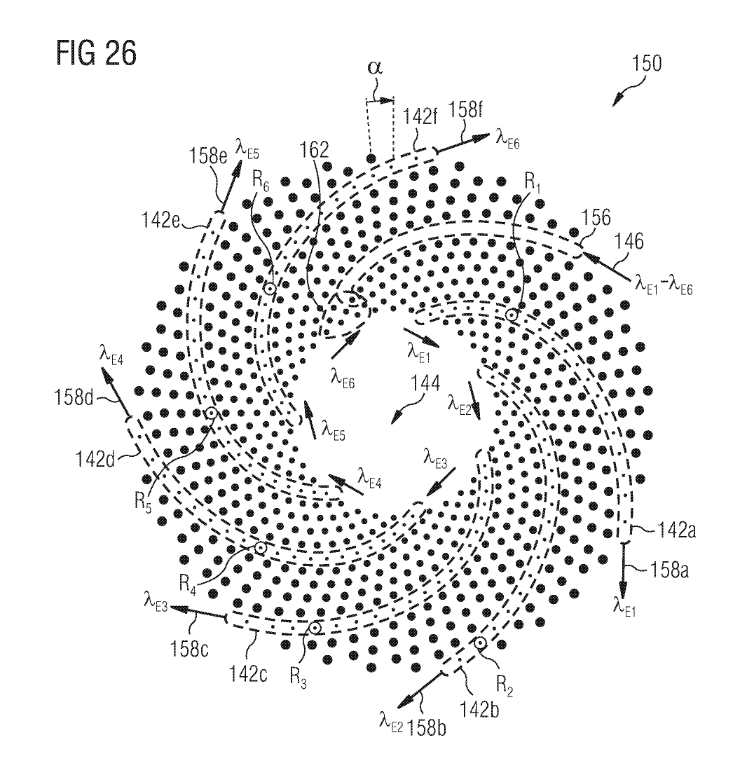

Each of the waveguides 142a to 142k may be formed as a photonic crystal structure as described with respect to FIGS. 25 to 27. The defect structures 154 may comprise extensions and/or distances between each other associated to the respective output waveguide 142a to 142k. Thus, for example, the output waveguide 154a may comprise defect structures 154a comprising a radius R_{WG1} being spaced apart from each other with a distance a_{WG1}. In contrast, the output waveguide 142k may comprise the defect structures 154k comprising an extension such as a diameter or radius R_{WG11} and being spaced apart from each other by a distance a_{WG11}.

Each of the output waveguides 142a to 142k may be connected to the interconnecting waveguide 312 at a contacting region 314. That is, the respective output waveguide 142a to 142k may be arranged adjacent to interconnecting waveguide 312 such that an electromagnetic signal may couple from the interconnecting waveguide 312 to the output waveguide 142. Thus, when compared to the photonic wavelength separation structures illustrated in FIGS. 25 to 27, a functionality of the circulatory pathway, i.e. to provide each of the output waveguides 142a to 142k with a portion of the input electromagnetic signal 146, may be obtained when arranging the interconnecting waveguide 312.

Each of the output waveguides 142a to 142k is configured to propagate a wavelength range λ_{E1} to λ_{E11}, wherein each wavelength range is associated to the respective photonic crystal structure of the respective output waveguide 142a to 142k. Association of a wavelength to a photonic crystal structure may be obtained, for example, by a respective diameter of a defect structure and/or by distance between the defect structures.

The interconnecting waveguide 312 may comprise a photonic crystal structure. The photonic crystal structure may comprise a variation in the defect structures of the interconnecting waveguide along a propagation direction 316 along which the interconnecting waveguide is configured to guide at least portions of the input signal 146. That is, the interconnecting waveguide 312 may comprise defect structures being adapted to the respective wavelengths λ_{E1} to λ_{E11} which are still present, i.e., not yet coupled out by the output waveguides 142a to 142k.

One or more of the output waveguides 142a to 142k may comprise at least one resonance structure 159, for example, a cavity instead of a defect structure 154. When compared to the photonic wavelength separation structure illustrated in FIGS. 25 to 27, two or more output waveguides 142a to 142k may be connected to the interconnecting waveguide 312 at a same or common connection region 314. For example, the output waveguides 142a and 142g may be arranged such that both of the output 142a and 142g connect to the interconnecting waveguide 312 at the contacting region 314a, wherein the output waveguide 142f may be arranged such that it connects to the interconnecting waveguide 312 at a contacting region 314b.

Output waveguides 142a to 142k arranged at a same contacting region 314a or 314b, may comprise a comparatively high difference with respect to the associated wavelength such that a cross-talk between adjacent waveguides sharing the same contacting region 314a may be low. At the same time, by sharing contact regions, a space or surface on a chip for implementing the photonic wavelength separation structure may be low.

The photonic crystal structure surrounding the waveguides 142a to 142k and 312 may comprise different photonic crystal structure regions 318a to 318k. Each of the photonic crystal structure regions 318a to 318k may be arranged to surround at least a portion of an associated output waveguide 142a to 142k. Surrounding an output waveguide 142a to 142k may be referred to as defect structures of the photonic crystal structure regions 318a to 318k being arranged at one or two lateral directions being perpendicular to a direction along which the respective output waveguide 142a to 142k is configured to guide the output signal guides 158a to 158k

As indicated by a₁ and R₁ to a₁₁ and R₁₁, each photonic crystal structure region 318a to 318k may comprise defect structures having different radii and/or different distances to each other so as to damp and/or guide wavelength ranges being different from each other. The damping may be understood as relating to wavelengths not associated to the defect structures. For example, the photonic crystal structure region 318a may be configured to damp the wavelength λ_{E7} by a higher amount when compared to a damping of the wavelength λ_{E1}. Vice versa, the photonic crystal structure 318g may be configured to damp the wavelength λ_{E1} by a higher degree when compared to the wavelength λ_{E7}. In addition, the photonic crystal structure region comprising defect structures having a radius R₇ and/or a distance between defect structures a₇ may damp the wavelength λ_{E8} associated to the output waveguide 142h by a higher amount when compared to the wavelength λ_{E7}. Vice versa, the photonic crystal structure region 318h may damp the wavelength λE₇ associated to the output waveguide 142g by a higher amount when compared to the wavelength λ_{E8}. This may allow for a low cross-talk between output waveguides 142a to 142k, in particular between adjacent waveguides. The concept of photonic crystal structure regions comprising different defect structures may also be applicable to the photonic wavelength separation structures 140, 150 and/or 160.

Alternatively, the photonic wavelength separation structure 310 may be implemented with photonic crystal structure regions 318a to 318k comprising a uniform radius and/or a uniform distance between defect structures.

Receiver elements 147a to 147k may be arranged and configured to receive a wavelength λ_{E1} to λ_{E11} associated to a respective waveguide, as described with respect to the photonic wavelength separation structure 140.

As described with respect to FIG. 25, an extension of the photonic wavelength separation structure, an extension of the photonic wavelength separation structure along the z-direction may be less than or equal to 2000 nm, less than or equal to 1500 nm or less than or equal to 1000 nm, for example in a range between 500 and 1000 nm, such as 600 nm.

In other words, the wavelength separation structure 310 demonstrates another wavelength separation filter device based on a 2D photonic crystal structure, holes in a slab such as air holes in a SI slab or rods in free space such as SI rods in air, the SI rods sitting on a substrate. For clarity, the device is illustrated as comprising different photonic crystal structure regions 318a to 318k which may also be absent or uniformly shaped. Each photonic crystal structure region may comprise a photonic crystal structure comprising a different periodicity aᵢ and a different radius Rᵢ. Thus, each photonic crystal structure region 318a to 318k may comprise a different photonic bandgap, abbreviated PhBG. Each structure may comprise a linear defect, which may form a waveguide. The linear defect may comprise a periodicity a_{WGi} and radius R_{WGi}, which may be different from that in the photonic crystal structure region, in which the waveguide is arranged. Each linear defect may comprise its own periodicity a_{WGi} and radius R_{WGi}. In addition, the linear defect may contain a resonance structure such as a cavity. Broadband light such as the electromagnetic signal 146, containing all the wavelengths λ₁ to λ₁₁ and/or the respective frequencies, is sent through the interconnecting waveguide, i.e. the input waveguide. The different periodicities and radii of the photonic crystal structure regions aᵢ and Rᵢ, along the different periodicities and radii of the waveguides a_{WGi} and R_{WGi} may ensure for a support of different frequencies, i.e. wavelengths, propagating in the waveguides, i.e. different waveguides may support different wavelengths.

FIG. 32A shows a schematic top view on a part of the photonic wavelength separation structure 310. With respect to FIG. 31, the output waveguides 142a to 142k may comprise an angle with respect to the propagation direction 316, i.e. a course of the interconnecting waveguide 312. The angle α may be based, influenced or dependent on a geometry of the defect structures 154ic of the interconnecting waveguide and/or of the geometry of the defect structures 154a of the output waveguide 154a comprising the angle α. Independent from a distance or a radius R₁ of a defect structure 154a or 154ic a pattern or grid of the defect structures may be comparable or the same.

For example, each defect structure 154ic or 154a may be formed as a hexagon-shaped pillar. Alternatively, the defect structures may comprise other shapes such as triangular, quadratic, a higher order polygon or even a circle. The angle α may essentially correspond to an angle of two adjacent surface regions 322a and 322b of a defect structure 154ic and/or correspond to an offset or pitch between adjacent lines or rows of the defect structures. The defect structures 154ic and 154a formed as pillar-structures or as holes may lead to an arrangement of the surface regions 322a and 322b essentially parallel to a surface normal of a substrate onto which or into which the defect structures 154ic and 154a are arranged.

As described with respect to FIGS. 25 to 27, the substrate may comprise a semiconductor material.

An extension of each of the defect structures 154a of the output waveguide 142a, for example, the radius R₁, may essentially correspond to the wavelength range of the first output waveguide 142a, i.e. the wavelength range λ_{E1} divided by 4. Although the extension R₁ is referred to as a radius, wherein the defect structures may be formed different from a circle, the term radius may refer to a distance between a geometric center of the cross-section of the defect structure 154a to an outer corner of the polygon shaped defect structure 154a.

Although the angle α was described as being arranged between the two surface regions 322a and 322b, based on symmetry effects, the angle α may also be an angle between a surface region 322c and the guiding direction 316.

FIGS. 32b to 32d illustrate functionality of photonic crystal structures according to embodiments described herein. Each of the figures illustrates a schematic top view on a photonic crystal structure. FIG. 32B illustrates a structure comprising uniformly shaped defect structures and an absence of a formed waveguide. FIG. 32C illustrates a waveguide formed by an absence of defect structures. FIG. 32D illustrates a photonic crystal structure comprising a waveguide comprising defect structures different from structures of surrounding structures, i.e., pillars or holes.

By non-limiting example only, a schematic diagram is illustrated adjacent to the structure. A photonic band gap (BG) 161 is illustrated as a shaded region. The vertical scale corresponds to the frequency of the wavelength, e.g., (ωa/2Πc)=aλ. The horizontal scale may correspond to a wavevector. In FIG. 32B, no or a low number of wavelengths (frequencies) from the range of the shaded region (vertical scale) are allowed to propagate through the PhC along a travelling direction 163.

In the diagram of FIG. 32B plots of TE—transverse electric field and plots of TM—transverse magnetic field are displayed, wherein in the diagrams of FIGS. 32C and 32D only plots of TM are displayed. TW may refer to a first polarization of the electromagnetic field, the so called TE-polarization. TM may refer to a second polarization of the electromagnetic field; the so called TM-polarization.

Displayed values F, M, K in the plots may refer to so-called “Γ-point of the Brillouin zone”, “M-point of the Brillouin zone”, “K-point of the Brillouin zone”. The three points may define a unit cell of the photonic crystal with a hexagonal lattice in the k-space (wavevector space). The terminology may be familiar to the fields of solid state physics, photonics, crystals etc.

In FIG. 32C, the waveguide is formed by applying a radius of ZERO to the defect structures, i.e., they are absent. Some frequencies may propagate through the waveguide along the direction 163. The dotted lines in the bandgap 165 have some “width” measured vertically along the frequency axis, i.e. between the minimum and the maximum of the line. Wavelengths of a frequency in the bandgap 165 except for the shaded regions 161a and 161b may travel through the structure.

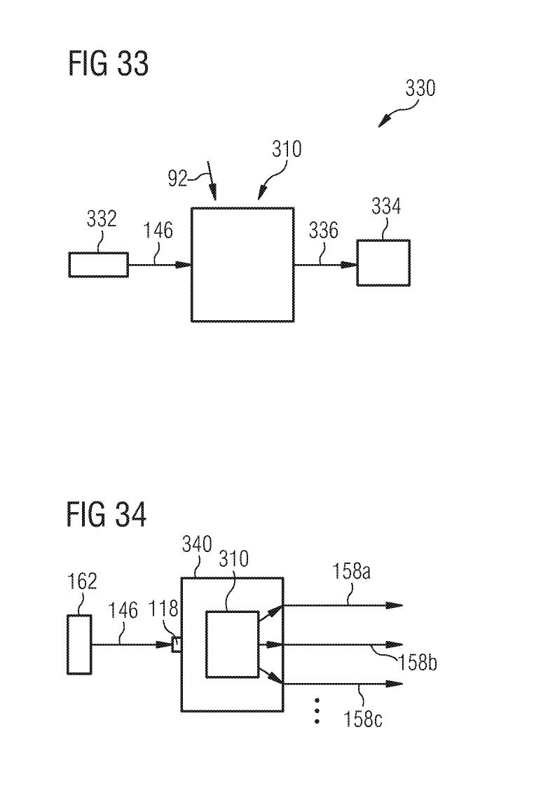

FIG. 33d shows a structure similar to FIG. 32C, comprising the waveguide 142. The defect structures of the waveguide may comprise an elliptic or hexagonal shape comprising an extension along the direction 163 being 0.75 times the radius of the defect structures of the surrounding crystal and being 0.7 times the radius along a direction perpendicular thereto. By introducing an additional line of defects inside the PhC waveguide, the number of allowed propagating frequencies can be reduced to a few.

FIG. 32E illustrates a schematic top view of an arrangement of defect structures 165, for example, the defect structures of a photonic crystal structure region. The defect structures 167 may be arranged in a so-called square lattice arrangement in lines 169 and rows 171. For example, the defect structures 167 may be formed elliptically or round, i.e., comprising a constant radius and/or may comprise a distance a between two adjacent defect structures 167 along at least one direction x and/or z.

FIG. 32F illustrates a schematic top view of an arrangement of the defect structures 167 in a so-called hexagonal lattice which is sometimes also referred to as a triangular lattice. Long a first direction, e.g., indicated as x, the defect structures may comprise a distance aₓ. The different lines 169a-c may comprise an offset 173 to each other resulting in the triangular or hexagonal shape. The offset 173 may at least partially influence the angle α of an output waveguide connected to the interconnecting waveguide as described with respect to FIG. 32A. Thereby a distance a_{z} between two defect structures 167 along a second direction z perpendicular to the first direction x may be increased when compared to the distance aₓ. An example value of a period and a radius for a photonic crystal operating in the wavelength range 5-6 μm in the hexagonal lattice may be Period (aₓ)=2.5 μm within a tolerance range of ±15%, ±10% or ±5% and radius=1.2 μm within a tolerance range of ±15%, ±10% or ±5%.

FIG. 33 shows a schematic block diagram of a microlab system 330 comprising the photonic wavelength separation structure 310 and a signal source 332, e.g., the source 145, configured to provide the electromagnetic input signal 146. A detector unit comprising, for example, the receiver elements 147a to 147k may be arranged at the photonic wavelength separation structure and may be configured to receive the electromagnetic output signals 158a to 158k or a value derived thereof. The microlab system 330 may be used, for example, as a multi-sensor configured to detect different gases or liquids.

The photonic wavelength separation structure may be connectable with an ambient material such as the ambient material 92. The ambient material 92 may reach a space between the defect structures 154 of the output waveguides 142a to 142k and/or a space between defect structures of the interconnecting waveguide 312 and/or a space traversed by the electromagnetic input signal 146. The ambient material may lead to an absorption of different wavelength ranges based on the type and/or composition of the ambient material 92. For example, a presence of carbon dioxide leads to an absorption in wavelength ranges being different from an absorption of wavelength ranges caused by nitrous gases or other materials. Therefore, an output signal 336 comprising signals of the detector elements 147a to 147k or signals derived thereof may vary based on a presence and/or composition of the ambient material 92. The processor 334 may be configured to determine a characteristic of the ambient material 92 based on the determined amplitude of the portion of the respective output signal 158a to 158k, leading to varying signals of the receiver elements 147a to 147k.

FIG. 34 shows a schematic block diagram of an optical receiver 340 comprising the photonic wavelength separation structure 310. The optical receiver 340 is configured to receive the electromagnetic input signal 146 which may be, for example, an optical communication signal. The optical communication signal 146 may be received, for example, from the optical transmitter 162.

The optical receiver 310 is configured to provide the separated output signals 158a to 158k.

As described above, the photonic wavelength separation structure 310 may comprise a different number of output waveguides 142 and may be configured to provide a different number of output signals 158, i.e. at least two or the like.

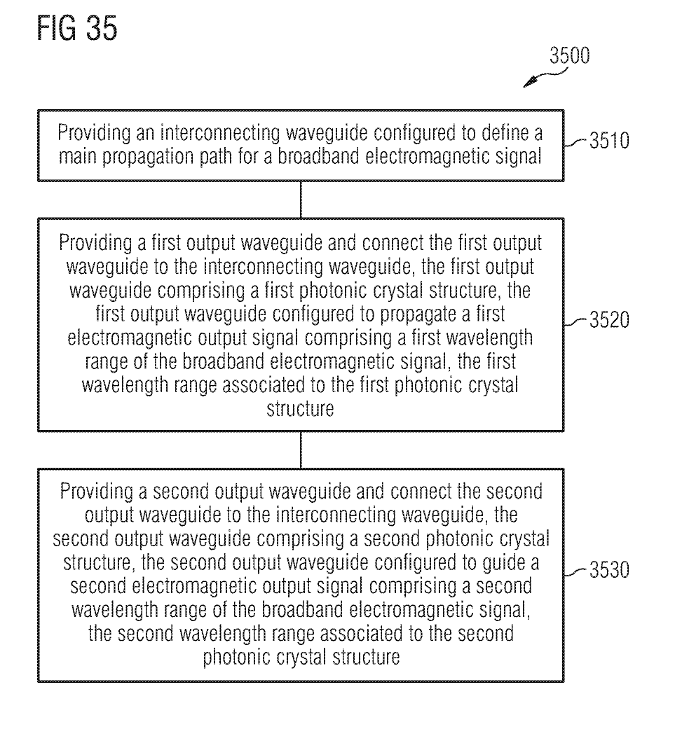

FIG. 35 shows a schematic flowchart of a method 3500 for manufacturing a photonic wavelength separation structure, for example, the photonic wavelength separation structure 310. The method 3500 comprises a step 3510 in which an interconnecting waveguide is provided, the interconnecting waveguide configured to define a main propagation path for a broadband electromagnetic signal. A step 3520 of method 3500 comprises providing a first output waveguide and connecting the first output waveguide to the interconnecting waveguide, the first output waveguide comprising a first photonic crystal structure, the first output waveguide configured to propagate a first wavelength range of the broadband electromagnetic signal, the first wavelength range associated to the first photonic crystal structure.

A step 3530 comprises providing a second output waveguide and connecting the second output waveguide to the interconnecting waveguide, the second output waveguide comprising a second photonic crystal structure, the second output waveguide configured to guide a second electromagnetic output signal comprising a second wavelength range of the broadband electromagnetic signal, the second wavelength range associated to the second photonic crystal structure.

Examples described above may be used for implementing photonic or plasmonic wavelength separation filters (WSF) and may also be referred to as a demultiplexer or optical switches. The examples may be used to receive a broadband light at the input, to separate the different wavelengths and to provide multiple beams of monochromatic light (simplified a single wavelength) at each output. Such devices are highly required, for example, in the telecommunications industry, where it may be required that multiple wavelengths are combined, transmitted through the optical waveguide/fiber as a sole beam and then individual wavelengths may be separated again into monochromatic beams. The splitting of the beam into different wavelengths may be achieved by the WSF and by combining of beams of different wavelengths into a single beam may be achieved by a device reciprocal to the WSF. Alternatively or in addition, a source of electromagnetic radiation may emit broadband light, which may be composed of numerous wavelengths. Many applications may require splitting the radiation into monochromatic beams of a single wavelength. Such wavelength separation may be achieved by the above described examples. Thus, above described examples address the fundamental technical task of decomposition of polychromatic (broadband) light into monochromatic beams of the constituent wavelength.

The WSF filter may be fully compatible with silicon technology and may be fabricated as planar 2D chip or 3D chips. Above described embodiments may comprise output waveguides, resonator structures and the like, enabling for separating more than a tenth of wavelengths. In some applications the wavelength separation filter may be integrated along with a source of polychromatic light and/or detectors (receivers). All those aspects may be realized via a CMOS based Si-compatible technology.

When compared to new concepts, above described embodiments allow for implementing WSF without large physical sizes as it might be required for bulk prisms, a rate waveguide detectors, Mach-Zender interferometers or the like. Above described embodiments may be integrated on a chip. This may include a bulk prism, a diffraction grating, spectral filters or the like. Additionally, a temperature variation shift of the wavelength may be avoided by a rate waveguide rating. Above described embodiments allow for devices, which combine the characteristics of photonic crystals or the surface plasmons with the properties of ring resonators. Advantages are that a wavelength separation filter may be obtained as a Si-based device. The application of ring resonator arrangements may allow for increasing of the intensity of the output signal, when compared to known concepts. In particular, PhC super prisms suffer from a high scattering. The implementation of surface plasmons and photonic crystals allow for a very compact design of the WSF.

Although above described embodiments partially refer to different waves (photonic and plasmonic) to be guided and/or separated, aspects of different waves and/or aspects of different embodiments may be combined mutually. For example, the input waveguide 62 or at least one output waveguide 64, 64a-c respectively, of the photonic waveguide separation structure 70, 70′ or 80 described with respect to FIGS. 7 and 8 may comprise a photonic crystal structure or an input waveguide or output waveguide as described with respect to one of FIGS. 14-17. Alternatively or in addition, the electromagnetic input signal 16, 66 and/or 146 may be obtained by arranging a thermal emitter or may be received by arranging a thermal detector as described with respect to FIGS. 10A and 10B. Alternatively or in addition, plasmonic wave signals may be generated or received by a thermal emitter, a thermal detector respectively. Electromagnetic signals may be generated by an electromagnetic signal. The electromagnetic signal source may comprise, for example, a light emitting diode (LED), a laser-LED, a photonic crystal and/or a thermal emitter. The electromagnetic signal may be coupled to a waveguide to obtain a plasmonic wave. Thus, although described in combination with different principles, aspects of the embodiments described herein may be combined with each other.

In accordance with a first aspect, a plasmonic wavelength separation structure 10; 20; 30 comprises an input waveguide 12 to guide a first plasmonic wave signal 16; an output waveguide 14; 14a-c to guide a second plasmonic wave signal 14; 14a-c; a resonator structure 22; 22a-c to receive a portion of the first plasmonic wave signal 16 from the input waveguide 12 by coupling and to provide the second plasmonic wave signal 18; 18a-c to the output waveguide 18; 18a-c based on the portion of the first plasmonic wave signal 16 by coupling, wherein the resonator structure 22; 22a-c comprises a closed loop pathway; and wherein the input waveguide 12, the resonator structure 22; 22a-c and the output waveguide 18; 18a-c each comprise a plasmonic wave guiding material for guiding the first and the second plasmonic wave signal 16, 18; 18a-c.

In accordance with a second aspect when referring back to the first aspect, a wavelength λ_{P1}-λ_{P3} of the second plasmonic wave signal 18; 18a-c is at least partially influenced by a distance 24 between the input waveguide 12 and the resonator structure 22; 22a-c.

In accordance with a third aspect when referring back to the second aspect, a length of the circulatory pathway is a multiple of the wavelength λ_{P1}. λ_{P3} of the second plasmonic wave signal 18; 18a-c within a tolerance range of less than or equal to 10%.

In accordance with a fourth aspect when referring back to the previous aspects, the resonator structure 22; 22a-c is configured to be connectable with an ambient material 54 and to influence the wavelength λ_{P1}-λ_{P3} of the second plasmonic wave signal 18; 18a-c based on an interaction between the portion of the first plasmonic wave 16 and the ambient material based 54 on a changed resonance frequency of the resonator structure 22; 22a-c.

In accordance with a fifth aspect when referring back to at least one of the previous aspects, the plasmonic wavelength separation structure comprises a plurality of resonator structures 22; 22a-c and a plurality of output waveguides 18a-c, each output waveguide 18a-c associated with an associated resonator structure 22a-c, wherein the input waveguide 12, the plurality of resonator structures 22a-c and the plurality of output waveguides 18a-c form a ring or disc resonator arrangement.

In accordance with a sixth aspect when referring back to at least one of the previous aspects, the resonator structure 22; 22a-c is configured to receive the first plasmonic wave signal 16 based on an electronic coupling between the resonator structure 22; 22a-c and the input waveguide 12 and the resonator structure 22; 22a-c is configured to provide the second plasmonic wave signal 18; 18a-c based on an electronic coupling between the resonator structure 22; 22a-c and the output waveguide 18; 18a-c.

In accordance with a seventh aspect when referring back to at least one of the previous aspects, the plasmonic wavelength separation structure further comprises an electromagnetic signal source 36 configured to emit a first electromagnetic signal 42, wherein the electromagnetic signal source 36 is coupled to the input waveguide 12 and configured to excite the first plasmonic wave signal 16 in the input waveguide 12 based on the first electromagnetic signal 42; a receiver element 38 configured to receive the second plasmonic wave signal 18 from the output waveguide 14; 14a-c and to provide a second electromagnetic signal 44 based on the second plasmonic wave signal 19; wherein a wavelength λ_{E4} of the second electromagnetic signal 44 is based on a wavelength λ_{E1}, λ_{E2}, λ_{E3} of the first electromagnetic signal 42 and at least partially influenced by the resonator structure 22; 22a-c.

In accordance with an eighth aspect when referring back to at least one of the previous aspects, the plasmonic wave guiding material of the input waveguide 12, the output waveguide 14; 14a-c and the resonator structure 22; 22a-c each comprises one of a metal material and a semiconductor material.

In accordance with a ninth aspect when referring back to at least one of the previous aspects, a length of the circulatory pathway is shorter than or equal to 300 μm.

In accordance with a tenth aspect when referring back to at least one of the previous aspects, the input waveguide 12, the output waveguide 14; 14a-c and the resonator structure 22; 22a-c are arranged on a semiconductor substrate.

In accordance with an eleventh aspect when referring back to at least one of the previous aspects, the resonator structure 22; 22a-c is arranged between the input waveguide 12 and the output waveguide 14; 14a-c.

In accordance with a twelfth aspect, a micro lab system 40 comprises a plasmonic wavelength separation structure 10; 20; 30 according to one of the first to eleventh aspects, wherein the resonator structure 22; 22a-c is configured to be connectable with an ambient material 54 and to influence a wavelength λ_{P1}-λ_{P3} of the second plasmonic wave signal 18; 18a-c based on an interaction between the portion of the first plasmonic wave signal and the ambient material 54 based on a changed resonance frequency of the resonator structure 22; 22a-c; a signal source 46 to provide the first plasmonic wave signal 16; a detector 48 to receive the second plasmonic wave signal 18; 18a-c and to detect a wavelength λ_{P1}-λ_{P3} of the second plasmonic wave signal 18; 18a-c or a wavelength derived thereof; and a processor 52 to determine a characteristic of the ambient material 54 based on the wavelength λ_{P1}-λ_{P3} of the second plasmonic wave signal 18; 18a-c or the wavelength derived thereof.

In accordance with a thirteenth aspect, an optical receiver 50 comprises a plasmonic wavelength separation structure 10; 20; 30 according to one of the first to eleventh aspects; an electromagnetic signal source 36 configured to emit a first electromagnetic signal 42 based on a received optical communication signal 56, wherein the electromagnetic signal source 36 is coupled to the input waveguide 12 and configured to excite the first plasmonic wave signal 16 in the input waveguide 12 based on the first electromagnetic signal 42; and a receiver element 38a-c configured to receive the second plasmonic wave signal 18; 18a-c from the output waveguide 14; 14a-c and to provide a second electromagnetic signal 44a-c based on the second plasmonic wave signal 18; 18a-c.

In accordance with a fourteenth aspect, a photonic wavelength separation structure 70, 80 comprises an input waveguide 62, 94 to guide a first electromagnetic signal 66; an output waveguide 64; 64a-c; 96 to guide a second electromagnetic signal 68; 68a-c; a resonator structure 72; 72a-c to receive a portion of the first electromagnetic signal 66 from the input waveguide 62, 94 by coupling and to provide the second electromagnetic signal 68; 68a-c to the output waveguide 64; 64a-c; 96 based on the portion of the first electromagnetic signal by coupling, wherein the resonator structure 72; 72a-c comprises a closed loop pathway; and wherein the input waveguide 62, 94, the resonator structure 72; 72a-c and the output waveguide 64; 64a-c; 96 each comprise a semiconductor material for guiding the first and the second electromagnetic signal 66, 68; 68a-c.

In accordance with a fifteenth aspect when referring back to the fourteenth aspect, a wavelength λ_{E1}-λ_{E3} of the second electromagnetic signal 68; 68a-c is at least partially influenced by a distance 74 between the input waveguide 62, 94 and the resonator structure 72; 72a-c.

In accordance with a sixteenth aspect when referring back to the fifteenth aspect, a length of the circulatory pathway is a multiple of the wavelength λ_{E1}-λ_{E3} of the second electromagnetic signal 68; 68a-c within a tolerance range of less than or equal to 10%.

In accordance with a seventeenth aspect when referring back to at least one of the fourteenth to sixteenth aspects, the resonator structure 72; 72a-c is configured to be connectable with an ambient material 92 and to influence the wavelength λ_{E1}-λ_{E3} of the second electromagnetic signal 68; 68a-c based on an interaction between the portion of the first electromagnetic signal and the ambient material 92 based on a changed resonance frequency of the resonator structure 72; 72a-c.

In accordance with an eighteenth aspect when referring back to at least one of the fourteenth to seventeenth aspects, the photonic wavelength separation structure comprises a plurality of resonator structures 72a-c and a plurality of output waveguides 14a-c, each output waveguide 64a-c associated with an associated resonator structure, wherein the input waveguide 62, 94, the plurality of resonator structures 72a-c and the plurality of output waveguides 64a-c form a ring resonator arrangement.

In accordance with a nineteenth aspect when referring back to at least one of the fourteenth to eighteenth aspects, the resonator structure is configured to receive the portion of the first electromagnetic signal based on an electromagnetic coupling between the resonator structure 72; 72a-c and the input waveguide 62, 94 and the resonator structure is configured to provide the second electromagnetic signal 68; 68a-c based on an electromagnetic coupling between the resonator structure 72; 72a-c and the output waveguide 64; 64a-c; 96.

In accordance with a twentieth aspect when referring back to at least one of the fourteenth to nineteenth aspects, the photonic wavelength separation structure further comprises an electromagnetic signal source 86 configured to emit the first electromagnetic signal 66, wherein the electromagnetic signal source 86 is coupled to the input waveguide 62; and a receiver element 88 configured to receive the second electromagnetic signal from the output waveguide 64; 64a-c.

In accordance with a twenty-first aspect when referring back to the twentieth aspect, the electromagnetic signal source 86 comprises a thermal emitter 104 configured for emitting a first thermal radiation 102 and the input waveguide 94 comprises a trench structure 98 configured for coupling the first thermal radiation 102 into the input waveguide 94 to obtain the first electromagnetic signal 66.

In accordance with a twenty-second aspect when referring back to the twenty-first aspect, the thermal emitter 104 comprises a doped silicon material to generate heat, wherein the doped silicon material comprises a doping concentration of at least 5%.

In accordance with a twenty-third aspect when referring back to at least one of the twentieth to twenty-second aspects, the receiver element 88 comprises a thermal detector 112 configured for detecting a second thermal radiation 108 and the output waveguide 96 comprises a trench structure 106 configured for decoupling the second electromagnetic signal 68 from the output waveguide 96 to obtain the second thermal radiation 108.

In accordance with a twenty-fourth aspect when referring back to at least one of the fourteenth to twenty-third aspects, a length of the circulatory pathway is shorter than or equal to 300 μm.

In accordance with a twenty-fifth aspect when referring back to at least one of the fourteenth to twenty-fourth aspects, the input waveguide, the output waveguide or the resonator structure is formed as a photonic crystal structure.

In accordance with a twenty-sixth aspect when referring back to at least one of the fourteenth to twenty-fourth aspects, the input waveguide 62; 94, the output waveguide 64; 64a-c; 96 or the resonator structure 72; 72a-c is formed by a multitude of pillar structures.

In accordance with a twenty-seventh aspect, a micro lab system 110 comprises a photonic wavelength separation structure 70; 80 according to one of the fourteenth to twenty-sixth aspects, wherein the resonator structure 72; 72a-c is configured to be connectable with an ambient material 92 and to influence the wavelength λ_{E1}-λ_{E3} of the second electromagnetic signal based on an interaction between the portion of the first electromagnetic and the ambient material 92 based on a changed resonance frequency of the resonator structure 72; 72a-c; a signal source 86 to provide the first electromagnetic signal 66; a detector 114 to receive the second electromagnetic signal and to detect a wavelength λ_{E1}. λ_{E3} of the second electromagnetic signal 68; 68a-c or a wavelength derived thereof; and a processor 116 to determine a characteristic of the ambient material 92 based on the wavelength λ_{E1}-λ_{E3} of the second electromagnetic signal or the wavelength derived thereof.

In accordance with a twenty-eighth aspect, an optical receiver 120 comprises a photonic wavelength separation structure 70; 80 according to one of the fourteenth to twenty-sixth aspects; wherein the input waveguide 62, 94 is connected to an input 118 of the optical receiver 120, the input configured 120 to receive an optical communication signal 122 and to provide the first electromagnetic signal 66 based on the optical communication signal 122.

In accordance with a twenty-ninth aspect, a method 600 for manufacturing a plasmonic wavelength separation structure comprises providing 610 an input waveguide to guide a first plasmonic wave signal; providing 620 an output waveguide to guide a second plasmonic wave signal; providing 630 a closed loop pathway forming a resonator structure such that a portion of the first plasmonic wave signal of the input waveguide is receivable by the resonator structure by coupling and such that the second plasmonic wave signal is receivable by the output waveguide from the resonator structure by coupling; and wherein the input waveguide, the resonator structure and the output waveguide each is provided by arranging a plasmonic wave guiding material configured for guiding the first and the second plasmonic wave signal.

In accordance with a thirtieth aspect, a method 1300 for manufacturing a photonic wavelength separation structure comprises providing 1310 an input waveguide to guide a first electromagnetic signal; providing 1320 an output waveguide to guide a second electromagnetic signal; providing 1330 a closed loop pathway forming a resonator structure such that a portion of the first electromagnetic signal of the input waveguide is receivable by the resonator structure by coupling and such that the second electromagnetic signal is receivable by the output waveguide from the resonator structure by coupling; and wherein the input waveguide, the resonator structure and the output waveguide each is provided by arranging a semiconductor material configured for guiding the first and the second electromagnetic signal.

In accordance with a thirty-first aspect, a photonic wavelength separation structure 140; 150; 160 comprises a first output waveguide 142a to guide a first electromagnetic output signal 158a comprising a first wavelength λ_{E1} associated to the first output waveguide 142a; a second output waveguide 142b to guide a second electromagnetic output signal 158b comprising a second wavelength λ_{E2} associated to the second output waveguide 142b; a third output waveguide 142c to guide a third electromagnetic output signal comprising 158c a third wavelength λ_{E3} associated to the third output waveguide 142c; and a circulatory pathway 144 to receive an electromagnetic input signal 146 comprising the first, the second and the third wavelength λ_{E1}-λ_{E3}; wherein the first output waveguide 142a, the second output waveguide 142b and the third output waveguide 142c are formed as a photonic crystal structure and interconnected to each other by the circulatory pathway 144 and configured to receive a portion of the electromagnetic input signal 146, the portion comprising the associated wavelength λ_{E1}-λ_{E3}.

In accordance with a thirty-second aspect when referring back to the thirty-first aspect, a length of the circulatory pathway 144 is a multiple of a length of the first wavelength λ_{E1}, the second wavelength λ_{E2} and the third wavelength λ_{E3} within a tolerance range of less than or equal to 10%.

In accordance with a thirty-third aspect when referring back to at least one of the thirty-first and thirty-second aspects, the photonic wavelength separation structure comprises an electromagnetic signal source 145 configured to emit the electromagnetic input signal 146; an input waveguide 156 connected to the electromagnetic signal source 145 and to the circulatory pathway 144 and configured to guide the electromagnetic input signal 146 to the circulatory pathway 144.

In accordance with a thirty-fourth aspect when referring back to at least one of the thirty-first and thirty-second aspects, the photonic wavelength separation structure comprises an electromagnetic signal source 164 configured to emit the electromagnetic input signal 146, wherein the electromagnetic signal source 164 is surrounded by the circulatory pathway 144 such that the electromagnetic input signal 146 is receivable by the circulatory pathway 144.

In accordance with a thirty-fifth aspect when referring back to at least one of the thirty-first to thirty-fourth aspects, the photonic wavelength separation structure comprises a first receiver element 147a configured to receive the first electromagnetic output signal 158a from the first output waveguide 142a; a second receiver element 147b configured to receive the second electromagnetic output signal 158b from the second output waveguide 142b; and a third receiver element 147c configured to receive the third electromagnetic output signal from the third output waveguide 142c.

In accordance with a thirty-sixth aspect when referring back to at least one of the thirty-first to thirty-fifth aspects, the first, second and third output waveguide 142a-c comprises a curvilinear pathway along an axial extension of the output waveguide 142a-c.

In accordance with a thirty-seventh aspect when referring back to at least one of the thirty-first to thirty-sixth aspects, the first, second and third output waveguide 142a-c is formed as a photonic crystal structure comprising a multitude of defect structures 154a-c; 168; 174 arranged at a substrate 166 or in the substrate 166.

In accordance with a thirty-eighth aspect when referring back to the thirty-seventh aspect, the substrate 166 comprises a semiconductor material.

In accordance with a thirty-ninth aspect when referring back to at least one of the thirty-seventh and thirty-eighth aspects, a portion of the defect structures 154a is formed as pillar structures 168 at the substrate 166 or as recess structures 174 in the substrate 166.

In accordance with a fortieth aspect when referring back to the thirty-ninth aspect, the portion of the defect structures 154a-c is formed as pillar structures 168 at the substrate 166 and the pillar structures 168 comprise a semiconductor material.

In accordance with a forty-first aspect when referring back to at least one of the thirty-seventh to fortieth aspects, the multitude of defect structures 154a-c is arranged in a multitude of concentric circles, wherein adjacent circles are rotated a with respect to each other such that a curvilinear pathway of the first, second and third output waveguide 142a-c is based on a rotation of the adjacent circles.

In accordance with a forty-second aspect when referring back to at least one of the thirty-seventh to forty-first aspects, an extension of each of the multitude of defect structures 154a-c; 168; 174 of an output waveguide 142a-f along a direction along which the output waveguide 142a-f extends essentially corresponds to the wavelength λ_{E1}-λ_{E7} of associated waveguide divided by four.

In accordance with a forty-third aspect when referring back to at least one of the thirty-first to forty-second aspects, the photonic wavelength separation structure comprises an extension along a first lateral direction x, a second lateral direction y perpendicular to the first lateral direction x and along a thickness direction z perpendicular to the first x and second y lateral direction, wherein an axial direction of the first, second and third output waveguide 142a-c essentially extends along the first lateral direction x or the second lateral direction y and wherein an extension of the photonic wavelength separation structure along the thickness direction 2 is less than or equal to 2000 nm.

In accordance with a forty-fourth aspect when referring back to at least one of the thirty-first to forty-third aspects, at least one of the first output waveguide 142a, the second output waveguide 142b or the third output waveguide 142c comprises a resonance structure 159.

In accordance with a forty-fifth aspect, an optical receiver 170 comprises a photonic wavelength separation structure 140; 150; 160 according to one of the thirty-first to forty-third aspects, wherein the electromagnetic input signal 146 is an optical communication signal received from an optical transmitter 162.

In accordance with a forty-sixth aspect, a method 1800 for manufacturing a photonic wavelength separation structure comprises providing 1810 a first output waveguide at a substrate, the first output waveguide configured to guide a first electromagnetic output signal comprising a first wavelength associated to the first output waveguide; providing 1820 a second output waveguide at the substrate, the second output waveguide configured to guide a second electromagnetic output signal comprising a second wavelength associated to the second output waveguide; providing 1830 a third output waveguide at the substrate, the third output waveguide configured to guide a third electromagnetic output signal comprising a third wavelength associated to the third output waveguide; and providing 1840 a circulatory pathway at the recess such that the first output waveguide, the second output waveguide and the third output waveguide are interconnected to each other by the circulatory pathway and such that a portion of the electromagnetic input signal is receivable by the first output waveguide, the second output waveguide and the third output waveguide from the circulatory pathway.

In accordance with a forty-seventh aspect when referring back to the forty-sixth aspect, providing the first, second or third output waveguide comprises providing a substrate material; and performing an anisotropic etching process to generate a plurality of pillar structures as a remaining portion of the etching process, wherein a first portion of the pillar structures comprise a first lateral extension, wherein a second portion of the pillar structures comprise a second lateral extension, wherein a third portion of the pillar structures comprise a third lateral extension, and wherein a fourth portion of the pillar structures comprise a fourth lateral extension; or performing an anisotropic etching process to generate a plurality of recesses into the substrate material, wherein a first portion of the recesses comprise a first lateral extension, wherein a second portion of the recesses comprise a second lateral extension, wherein a third portion of the recesses comprise a third lateral extension, and wherein a fourth portion of the recesses comprise a fourth lateral extension; wherein the first portion of the pillar structures or of the recesses forms the first output waveguide, wherein the second portion of the pillar structures or of the recesses forms the second output waveguide, wherein the third portion of the pillar structures or of the recesses forms the third output waveguide and wherein the fourth portion of the pillar structures or of the recesses is generated between the output waveguides.

In accordance with a forty-eighth aspect, a photonic wavelength separation structure 141; 143; 149 comprises: a waveguide structure comprising a first semiconductor waveguide 61a-61l having a first doping characteristic and a second semiconductor waveguide 61a-61l having a second doping characteristic; wherein the first and second semiconductor waveguides 61a-61l have different refractive indices η₁-η₃ based on the first doping characteristic and the second doping characteristic being different from the first doping characteristic; wherein the different doping characteristics of the first and second semiconductor waveguide 61a-61l are based on at least one of different semiconductor materials for the first and second semiconductor waveguide 61a-61l; different doping materials for doping the semiconductor material of the first and second semiconductor waveguide 61a-61l; and different doping concentrations of the doping material for the first and second semiconductor waveguide 61a-61l.

In accordance with a forty-ninth aspect when referring back to the forty-eighth aspect, the first doping characteristic and the second doping characteristic are based on the different doping concentrations, such that an effective doping concentration of the first semiconductor waveguide 61a-61l is different from an effective doping concentration of the second semiconductor waveguide 61a-61l.

In accordance with a fiftieth aspect when referring back to at least one of the forty-eighth to fiftieth aspects, the photonic wavelength separation structure comprises a plurality of semiconductor waveguides 61a-61l arranged adjacent to each other along a disposal direction 67, each waveguide 61a-61l comprising a different doping characteristic.

In accordance with a fifty-first aspect when referring back to the fiftieth aspect, the different doping characteristics are based on the different doping concentration, such that an effective doping concentration the plurality of semiconductor waveguides 61a-61l is different among the plurality of semiconductor waveguides 61a-61l, wherein the doping concentration varies monotonically among along the disposal direction 67.

In accordance with a fifty-second aspect when referring back to at least one of the forty-eighth to fifty-first aspects, the second semiconductor waveguide 61a-61l is configured to guide an electromagnetic signal λ₀-λ₁₃ from a first side 87a-87c of the second semiconductor waveguide 61a-61l to a second side 91a-91c of the second semiconductor waveguide 61a-61l, the photonic wavelength separation structure further comprising a wavelength selection element 85; 93; 97 arranged so as to interact with the second semiconductor waveguide 61a-61l, wherein the wavelength selection element 85; 93; 97 is configured to change an amplitude of a wavelength portion of the electromagnetic signal λ_{E0}-λ_{E13} at the second side 91a-91c to obtain a modulated wavelength portion.

In accordance with a fifty-third aspect when referring back to the fifty-second aspect, the wavelength selection element comprises a resonator structure 85 adjacent to the waveguide 61a-61l; wherein the resonator structure 85 is configured to receive the wavelength portion by coupling and to change the amplitude by coupling, wherein the resonator structure is configured to change the amplitude based on one of an increase of the amplitude based on a positive interference and an decrease of the amplitude based on a destructive interference.

In accordance with a fifty-fourth aspect when referring back to the fifty-third aspect, the resonator structure 85 comprises one of a ring resonator structure, a disc resonator structure and a photonic crystal structure.

In accordance with a fifty-fifth aspect when referring back to at least one of the fifty-third to fifty-fourth aspects, the resonator structure 85 is configured to be connectable with an ambient material 92 and to influence the wavelength of the wavelength portion based on an interaction between the resonator structure 85 and the ambient material 92 based on a changed resonance frequency of the resonator structure 85.

In accordance with a fifty-sixth aspect when referring back to at least one of the fifty-third to fifty-fifth aspects, a length of an outer circulatory pathway of the resonator structure 85 is shorter than or equal to 300 μm.

In accordance with a fifty-seventh aspect when referring back to at least one of the fifty-second to fifty-sixth aspects, the wavelength selection element comprises a grating resonator 93 arranged at the semiconductor waveguide 61a-61l or integrated in the semiconductor waveguide 61a-61l, wherein the grating resonator 93 is configured for reflecting the wavelength portion λ_{E3} in the waveguide 61c such that the amplitude of the wavelength portion is reduced at the second side 91c when compared to the first side 87a.

In accordance with a fifty-eighth aspect when referring back to at least one of the fifty-second to fifty-seventh aspects, the wavelength selection element comprises a wavelength filter 97 configured for filtering the wavelength portion.

In accordance with a fifty-ninth aspect when referring back to the fifty-eighth aspect, the wavelength filter 97 is configured to obtain a change of a refractive index η₁-η₃ between the second semiconductor waveguide 61a-61l and the wavelength filter 97 based on at least one of different materials for the second semiconductor waveguide 61a-61l and the wavelength filter 97; different doping materials for doping the semiconductor material of the second semiconductor waveguide 61a-61l and the wavelength filter 97; different doping concentrations of the doping material for the second semiconductor waveguide 61a-61l and the wavelength filter 97; and a structure of the wavelength filter 97 being different from a structure of the second semiconductor waveguide 61a-61l.

In accordance with a sixtieth aspect when referring back to the fifty-ninth aspect, the wavelength filter 97 is configured to obtain the different refractive indices η₁-η₃ based on the different materials, wherein the wavelength filter 97 comprises one of a silicon dioxide material, a silicon nitride material or a fluid.

In accordance with a sixty-first aspect when referring back to at least one of the fifty-eighth to sixtieth aspects, the wavelength filter 97 is configured to operate as one of a high-pass filter, a band-pass filter and a band-elimination filter.

In accordance with a sixty-second aspect when referring back to at least one of the fifty-eighth to sixty-first aspects, the wavelength filter 97 is integrated into a course of the second semiconductor waveguide 61c.

In accordance with a sixty-third aspect when referring back to at least one of the forty-eighth to sixty-second aspects, the first semiconductor waveguide 61a-61l is formed as an elevation on a substrate 65, an extension 71 of the elevation along a direction parallel to a surface normal 73 of the substrate 65 being at least 100 nm and at most 1 μm.

In accordance with a sixty-fourth aspect when referring back to at least one of the forty-eighth to sixty-third aspects, the first semiconductor waveguide 61a-61l is formed as an elevation on a substrate, the elevation comprising a first extension and a second extension, the first extension arranged perpendicular to a surface normal 73 of the substrate 65 and parallel to an axial extension of the waveguide 61a-61l, the second extension 75 arranged perpendicular to the surface normal 73 and perpendicular to the first extension, wherein the first extension is at least 5 μm and at most 10 cm, and wherein the second extension 75 is at least 50 nm and at most 20 μm.

In accordance with a sixty-fifth aspect, a micro lab system 110 comprises a photonic wavelength separation structure according to one of the fifty-second to sixty-fourth aspects, wherein the resonator structure 85 is configured to be connectable with an ambient material 92 and to influence the wavelength of the wavelength portion based on an interaction between the ambient material 92 and the resonator structure 85 based on a changed resonance frequency of the resonator structure 85; a signal source 59 to provide a electromagnetic signal 63, λ₀-λ₁₄ to the second semiconductor waveguide 61a-61l; a detector 109 to receive the electromagnetic signal λ₀-λ₁₄ comprising the modified wavelength portion and to detect a wavelength λ_{E1}-λ_{E13} of the wavelength portion or a wavelength derived thereof; and a processor 111 to determine a characteristic of the ambient material 92 based on the wavelength λ_{E1}-λ_{E13} of the wavelength portion or the wavelength derived thereof.

In accordance with a sixty-sixth aspect, an optical receiver 120 comprises a photonic wavelength separation structure according to one of the forty-seventh to sixty-fourth aspects; wherein the first and second semiconductor waveguides 61a-61l are connected to an input 118 of the optical receiver at an input side 87a-87c of the semiconductor waveguides 61a-61l, the input 118 configured to receive an optical communication signal 63 and to provide at least portions of the optical communication signal 63 to the semiconductor waveguides 61a-61l.

In accordance with a sixty-seventh aspect, a method 2400 for manufacturing a photonic wavelength separation structure comprises providing 2410 a waveguide structure 141; 143; 149 comprising a first semiconductor waveguide 61a-61l having a first doping characteristic and providing a second semiconductor waveguide 61a-61l having a second doping characteristic; wherein the first and second semiconductor waveguides 61a-61l are provided so as to have different refractive indices η₁-η₃ based on the first doping characteristic and the second doping characteristic being different from the first doping characteristic; wherein the different doping characteristics of the first and second semiconductor waveguide 61a-61l are based on at least one of providing different semiconductor materials for the first and second semiconductor waveguide 61a-61l; providing different doping materials for doping the semiconductor material of the first and second semiconductor waveguide 61a-61l; and providing different doping concentrations of the doping material for the first and second semiconductor waveguide 61a-61l.

In accordance with a sixty-eight aspect, a photonic wavelength separation structure 310 comprises an interconnecting waveguide 312 configured to define a main propagation path for a broadband electromagnetic signal 146; a first output waveguide 142a-142k connected to the interconnecting waveguide 312, comprising a first photonic crystal structure, the first output waveguide 142a-142k configured to propagate a first electromagnetic output signal 158a-158k comprising a first wavelength range λ_{E1}-A_{E11} of the broadband electromagnetic signal 146, the first wavelength range λ_{E1}-λ_{E11} associated to the first photonic crystal structure; and a second output waveguide 142a-142k connected to the interconnecting waveguide 312, comprising a second photonic crystal structure, the second output waveguide 142a-142k configured to propagate a second electromagnetic output signal 158a-158k comprising a second wavelength range λ_{E1}-λ_{E11} of the broadband electromagnetic signal 146, the second wavelength range λ_{E1}-λ_{E11} associated to the second photonic crystal structure.

In accordance with a sixty-ninth aspect when referring back to the sixty-eighth aspect, the first and second photonic crystal structures differ from each other in at least one of a diameter Rᵢ of defect structures 154 of the first and second photonic crystal structure; and a distance aᵢ between the defect structures 154 of the first and second photonic crystal structure.

In accordance with a seventieth aspect when referring back to at least one of the sixty-eighth to sixty-ninth aspects, the photonic wavelength separation structure comprises a first photonic crystal structure regions 318a-318k surrounding at least a portion of the first output waveguide 142a-142k and comprising a second photonic structure region surrounding at least a portion of the second output waveguide 142a-142k, wherein the first photonic crystal structure region comprises defect structures 154 of a first type, and wherein the second photonic crystal structure region comprises defect structures 154 of a second type, being different from the first type; and wherein the first photonic crystal structure region 318a-318k is adapted to damp portions of the second wavelength range λ_{E1}-λ_{E11} and wherein the second photonic crystal structure region 318a-318k is adapted to damp portions of the first wavelength range λ_{E1}-λ_{E11}.

In accordance with a seventy-first aspect when referring back to at least one of the sixty-eighth to seventieth aspects, the first output waveguide 142a-142k is connected to the interconnecting waveguide 312 at a first contacting region 314a of the interconnecting waveguide 312, and the second output waveguide 142a-142k is connected to the interconnecting waveguide 312 at a second contacting region 314b of the interconnecting waveguide 312.

In accordance with a seventy-second aspect when referring back to the seventy-first aspect, the photonic wavelength separation structure further comprises a third output waveguide 142a-142k to guide a third electromagnetic output signal 158a-158k comprising a third wavelength range λ_{E1}-λ_{E11} of the broadband electromagnetic signal 146, wherein the third wavelength range λ_{E1}-λ_{E11} is associated to a photonic crystal structure of the third output waveguide 142a-142k, wherein the third output waveguide 142a-142k is connected to the interconnecting waveguide 312 at the first contacting region 314a.

In accordance with a seventy-third aspect when referring back to at least one of the sixty-eighth to seventy-second aspects, the photonic wavelength separation structure comprises a first receiver element 147a-147k configured to receive the first electromagnetic output signal 158a-158k from the first output waveguide 142a-142k; and a second receiver element 147a-147k configured to receive the second electromagnetic output signal 158a-158k from the second output waveguide 142a-142k.

In accordance with a seventy-fourth aspect when referring back to at least one of the sixty-eighth to seventy-third aspects, the photonic crystal structures of the first and second output waveguide 142a-142k comprise a multitude of defect structures 154 arranged at a substrate 166 or in the substrate 166, the first output waveguide 142a-142k comprises an angle α between a pathway along an axial extension of the first output waveguide 142a-142k and the interconnecting waveguide 312, wherein the angle α essentially corresponds to a an angle α of two adjacent surface regions 322a, 322b of a defect structure 154_{ic} of the photonic crystal structure of the interconnecting waveguide 312 or corresponds to an offset 173 of two adjacent defect structures, wherein the two surface regions 322a, 322b are arranged parallel to a surface normal of the substrate 166.

In accordance with a seventy-fifth aspect when referring back to the seventy-fourth aspect, the substrate 166 comprises a semiconductor material.

In accordance with a seventy-sixth aspect when referring back to at least one of the seventy-fourth to seventy-fifth aspects, a portion of the defect structures is formed as pillar structures at the substrate 166 or as recess structures in the substrate 166.

In accordance with a seventy-seventh aspect when referring back to at least one of the seventy-fourth to seventy-sixth aspects, an extension of each of the multitude of defect structures 154 of the first output waveguide 142a-142k along a direction along which the first output waveguide 142a-142k extends essentially corresponds to the wavelength range λ_{E1}-λ_{E11} of the first output waveguide 142a-142k divided by four.

In accordance with a seventy-eighth aspect when referring back to at least one of the sixty-eighth to seventy-seventh aspects the photonic wavelength separation structure comprises an extension along a first lateral direction x, a second lateral direction y perpendicular to the first lateral direction x and along a thickness direction z perpendicular to the first x and second y lateral direction, wherein an axial direction of the first, second and third output waveguide 142a-142k essentially extends along the first lateral direction x or the second lateral direction y and wherein an extension of the photonic wavelength separation structure along the thickness direction 2 is less than or equal to 2000 nm.

In accordance with a seventy-ninth aspect when referring back to at least one of the sixty-eighth to seventy-eighth aspects at least one of the first output waveguide 142a-142k and the second output waveguide 142a-142k comprises a resonance structure 159.

In accordance with an eightieth aspect when referring back to the seventy-ninth aspect, the first output waveguide 142a-142k or the second output waveguide 142a-142k comprises a plurality of defect structures 154 so as to form the waveguide 142a-142k, wherein the resonance structure 159 comprises an absence of a defect structure 154 along a pathway of the output waveguide 142a-142k.

In accordance with an eighty-first aspect, a micro lab system 330 comprises a photonic wavelength separation structure according to one of the sixty-eight to eightieths aspects, wherein the photonic wavelength separation structure is configured to be connectable with an ambient material 92 and to influence an amplitude of a portion of the wavelength λ_{E1}-λ_{E11} of the first or second electromagnetic output signal 158a-158k based on an interaction between the ambient material 92 and at least one of the electromagnetic input signal, the first and second electromagnetic output signal 158a-158k; a signal source 332 to provide the broadband electromagnetic signal 146; a detector unit to receive the first and second electromagnetic output signal 158a-158k and to detect the amplitude of the portion of the first and second electromagnetic output signal 158a-158k or a value derived thereof; and a processor 334 to determine a characteristic of the ambient material 92 based on the determined amplitude or based on the value derived thereof.

In accordance with an eighty-second aspect, an optical receiver 340 comprises a photonic wavelength separation structure according to one of the sixty-eighth to eightieth aspects, wherein the broadband electromagnetic signal 146 is an optical communication signal received from an optical transmitter.

In accordance with an eighty-third aspect, a method 3500 for manufacturing a photonic wavelength separation structure comprises providing 3510 an interconnecting waveguide 312 configured to define a main propagation path for a broadband electromagnetic signal 146; providing 3520 a first output waveguide 142a-142k and connect the first output waveguide 142a-142k to the interconnecting waveguide 312, the first output waveguide 142a-142k comprising a first photonic crystal structure, the first output waveguide 142a-142k configured to propagate a first wavelength range λ_{E1}-λ_{E11} of the broadband electromagnetic signal 146, the first wavelength range λ_{E1}-λ_{E11} associated to the first photonic crystal structure; and providing 3530 a second output waveguide 142a-142k and connect the second output waveguide 142a-142k to the interconnecting waveguide 312, the second output waveguide 142a-142k comprising a second photonic crystal structure, the second output waveguide 142a-142k configured to guide a second electromagnetic output signal 158a-158k comprising a second wavelength range λ_{E1}-λ_{E11} of the broadband electromagnetic signal 146, the second wavelength range λ_{E1}-λ_{E11} associated to the second photonic crystal structure.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The above described embodiments are merely illustrative. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

What is claimed is:

1. A photonic wavelength separation structure comprising:
a waveguide structure comprising a plurality of semiconductor waveguides including a first semiconductor waveguide having a first doping characteristic and a second semiconductor waveguide having a second doping characteristic, the waveguide structure being a single integral member composed of one of silicon (Si), germanium (Ge), gallium arsenide (GaAs), or lithium barium (LiBa),
wherein the first and the second semiconductor waveguides have different refractive indices based on the first doping characteristic and the second doping characteristic which is different from the first doping characteristic,
wherein the first semiconductor waveguide is configured to receive an electromagnetic signal and to guide a first wavelength portion of the electromagnetic signal while damping wavelengths of the electromagnetic signal outside of the first wavelength portion,
wherein the second semiconductor waveguide is configured to receive the electromagnetic signal and to guide a second wavelength portion of the electromagnetic signal while damping wavelengths of the electromagnetic signal outside of the second wavelength portion, and
wherein the first wavelength portion and the second wavelength portion share a common shortest wavelength portion, where the first wavelength portion comprises a first upper wavelength, and the second wavelength portion comprises a second upper wavelength greater than the first upper wavelength.

2. The photonic wavelength separation structure according to claim 1, wherein the first doping characteristic and the second doping characteristic are based on the different doping concentrations, such that an effective doping concentration of the first semiconductor waveguide is different from an effective doping concentration of the second semiconductor waveguide.

3. The photonic wavelength separation structure according to claim 1, wherein the plurality of semiconductor waveguides are arranged adjacent to each other along a disposal direction, each waveguide of the plurality of semiconductor waveguides comprising a different doping characteristic and configured to guide a different wavelength portion of the electromagnetic signal.

4. The photonic wavelength separation structure according to claim 3, wherein the different doping characteristic of each waveguide of the plurality of semiconductor waveguides is based on a different doping concentration, such that an effective doping concentration the plurality of semiconductor waveguides is different among the plurality of semiconductor waveguides, wherein the different doping concentrations vary monotonically among the plurality of semiconductor waveguides along the disposal direction.

5. The photonic wavelength separation structure according to claim 1, wherein the second semiconductor waveguide is configured to guide the electromagnetic signal from a first side of the second semiconductor waveguide to a second side of the second semiconductor waveguide,
the photonic wavelength separation structure further comprises a wavelength selection element arranged so as to interact with the second semiconductor waveguide, wherein the wavelength selection element is configured to change an amplitude of the second wavelength portion of the electromagnetic signal at the second side to obtain a modulated wavelength portion.

6. The photonic wavelength separation structure according to claim 5, wherein the wavelength selection element comprises a resonator structure adjacent to the second semiconductor waveguide,
wherein the resonator structure is configured to receive the second wavelength portion by coupling and to change the amplitude by coupling, wherein the resonator structure is configured to change the amplitude based on one of an increase of the amplitude based on a constructive interference or a decrease of the amplitude based on a destructive interference.

7. The photonic wavelength separation structure according to claim 6, wherein the resonator structure is configured to be connectable with an ambient material and to influence the wavelength of the second wavelength portion based on an interaction between the resonator structure and the ambient material based on a changed resonance frequency of the resonator structure.

8. The photonic wavelength separation structure according to claim 1, wherein the first semiconductor waveguide is formed as an elevation on a substrate, an extension of the elevation along a direction parallel to a surface normal of the substrate being at least 100 nm and at most 1 μm.

9. The photonic wavelength separation structure according to claim 1, wherein the second wavelength portion includes the first wavelength portion.

10. The photonic wavelength separation structure according to claim 1, wherein the first semiconductor waveguide has a first doping concentration that varies in a first doping concentration range, and the semiconductor waveguide has a second doping concentration that varies in a second doping concentration range.

11. The photonic wavelength separation structure according to claim 10, wherein the second doping concentration range is larger than the first doping concentration range.

12. The photonic wavelength separation structure according to claim 10, wherein the first doping concentration and the second doping concentration vary in a direction perpendicular to an axial extension of the first and the second semiconductor waveguides, respectively.

13. The photonic wavelength separation structure according to claim 10, wherein the photonic wavelength separation structure is a waveguide array.

14. The photonic wavelength separation structure according to claim 1, wherein a doping concentration is varied according to a continuous doping gradient that extends along the waveguide structure in a direction orthogonal to a transmission direction.

15. The photonic wavelength separation structure according to claim 1, wherein the plurality of semiconductor waveguides are adjacently disposed with respect to each other in a series of columns.

16. A photonic wavelength separation structure comprising:
a waveguide structure comprising a plurality of semiconductor waveguides including a first semiconductor waveguide having a first doping characteristic and a second semiconductor waveguide having a second doping characteristic, the plurality of semiconductor waveguides being composed of one of silicon (Si), germanium (Ge), gallium arsenide (GaAs), or lithium barium (LiBa),
wherein the waveguide structure includes a plurality of insulating structures, wherein the plurality of insulating structures and the plurality of semiconductor waveguides alternate on a one-by-one basis such that each of the plurality of semiconductor waveguides is contiguous to at least one of the plurality of insulating structures,
wherein the first and the second semiconductor waveguides have different refractive indices based on the first doping characteristic and the second doping characteristic which is different from the first doping characteristic, wherein the first semiconductor waveguide is configured to receive an electromagnetic signal and to guide a first wavelength portion of the electromagnetic signal while damping wavelengths of the electromagnetic signal outside of the first wavelength portion,
wherein the second semiconductor waveguide is configured to receive the electromagnetic signal and to guide a second wavelength portion of the electromagnetic signal while damping wavelengths of the electromagnetic signal outside of the second wavelength portion, and
wherein the first wavelength portion and the second wavelength portion share a common shortest wavelength portion, where the first wavelength portion comprises a first upper wavelength, and the second wavelength portion comprises a second upper wavelength greater than the first upper wavelength.

17. The photonic wavelength separation structure according to claim 16, wherein the plurality of insulating structures are composed of one of Si₃N₄, SiOₓ, or silicon, wherein x in an integer, and wherein a refractive index of the plurality of insulating structures is lower than refractive indexes of the plurality of semiconductor waveguides.

18. The photonic wavelength separation structure according to claim 16, wherein a refractive index of the plurality of insulating structures is lower than refractive indexes of the plurality of semiconductor waveguides.

19. The photonic wavelength separation structure according to claim 16, wherein the plurality of insulating structures and the plurality of semiconductor waveguides are arranged as parallel columns that extend in a transmission direction.
